(19) United States
(12) Patent Application Publication
(10) Pub. No.: US 2021/0265764 A1
(43) Pub. Date: Aug. 26, 2021

(54) ELECTRICAL CONNECTOR WITH CAM CONTROLLED LOCKING DEVICE

(71) Applicant: HACHADORIAN DESIGN & CALCULATION GMBH, Frankfurt am Main (DE)

(72) Inventor: Gary Hachadorian, Frankfurt am Main (DE)

(21) Appl. No.: 17/048,676

(22) PCT Filed: Apr. 23, 2019
(86) PCT No.: PCT/EP2019/060393

§ 371 Date: Oct. 19, 2020

Related U.S. Application Data
(60) Provisional application No. 62/659,813, filed on Apr. 19, 2018.

(51) Int. Cl. H01R 13/447; H01R 13/52; E05F 1/12

(52) U.S. Cl. CPC H01R 13/447; H01R 2201/26; E05F 1/1253; H01R 13/5213

(57) ABSTRACT

Electrical connectors with a spring-biased protective cover in order to protect the electrical contacts of the connector from environmental influence. The device comprises a housing and a rotatable cover which can be moved from a closed position to an open position about a rotational axis, and a cam-controlled locking mechanism, which acts upon the cover in the closed position such that a force is exerted upon the cover in order to prevent an unwanted movement of the cover from the closed position when the cam-controlled locking mechanism is engaged.

The present invention generally relates to electrical connectors with a spring-biased protective cover in order to protect the electrical contacts of the connector from environmental influence. A device according to the invention comprises a housing and a rotatable cover which can be moved from a closed position to an open position about a rotational axis, and a cam-controlled locking mechanism, which acts upon the cover in the closed position such that a force is exerted upon the cover in order to prevent an unwanted movement of the cover from the closed position when the cam-controlled locking mechanism is engaged.

### PRIOR ART

In order to protect electrical sockets, spring-biased protective covers are often used to cover the interior volume of the socket and thereby protect the electrical contacts from corrosion, damage or contamination when the socket is not in use and no plug is inserted. Particularly on vehicles, for the electrical connection between towing vehicles and trailers, the aforementioned socket structure is used to protect the electrical contacts of the connection from road debris, moisture, snow or ice buildup, salts, oils or other contaminants because the electrical connection must often be placed on an unprotected area of the vehicle or in the case of cars, the connection must be placed close the road surface. An elastic seal is often attached to the spring-biased cover to increase its sealing effect and thereby improve the protection of the electrical contacts.

For example, DE 38 09 289 A1 describes an electrical socket for the connection of lighting functions on a trailer to the controls and power supplies on a towing car. The protective cover is equipped with a seal, and a helical leg spring provides a near linear rotational torque on the cover. That is, as the protective cover is rotated away from the closed position on the housing, the helical leg spring is wound up further, therefore the closing force on the protective cover is higher in the cover-open position than in the cover-closed position. In the cover-closed position the helical leg spring is pre-loaded so that until the closing force on the cover which is a result of this pre-load is exceeded by an opening force, the cover will remain in the closed position.

In this example, the interface of the leg spring is positioned at the centroid of the socket opening in order to facilitate an even distribution of the closing force over the surface of the seal.

It should be noted that because the closing force on the cover is higher in the cover-open position than in the cover-closed position, the pre-load on the cover in the cover-closed position is limited not by the force of the spring in the closed position, but rather it is limited by the spring force in the cover-open position due to ease of handling in overcoming the ever-increasing torque on the cover as it is opened, as well as the danger posed to the user by a suddenly released cover.

Conversely, DE 20 2012 100 856 U1 shows a non-linear cover spring used to bias a rotatable protective cover for an electrical socket towards the cover-closed position. By means of an eccentric positioning of an axial compression or extension spring, the moment arm between the spring force and the rotational axis of the protective cover can be increased or decreased as a function of the angle between the protective cover and the socket housing. Typically, the resulting closing force on the cover is higher in the cover-closed position due to the moment arm between the spring force and the rotational axis of the cover being greatest in this location. As the cover opens, the moment arm between the spring force and the rotational axis of the cover decreases as a function of the opening angle of the cover.

In one embodiment, the vector of the spring force crosses over or intersects with the rotational axis of the protective cover such that the cover remains in a static, although unstable condition when it is released in the cover-open position. As the cover remains open when released, the user is not required to hold the cover open with one hand while inserting the plug into the socket, thus enabling a one-handed operation of the socket. Additionally, if the user fails to close the cover after use, vibrations or bumps such as moving the vehicle or closing its doors will automatically close the protective cover.

WO 2012/019625 A1 shows a locking device for the protective cover of an electrical connector, wherein a spring loaded element is biased against the rotatable cover, and the cover is equipped with a receptacle for the spring-biased element such that the spring-biased element is pressed into the receptacle in the cover-closed position and thereby an increased closing force is exerted upon the protective cover of the socket. The locking mechanism is in contact with the protective cover of the socket throughout its movement, resulting in a frictional force wherein this frictional resistance to movement is overcome either by the user opening the cover or by the rotational spring which provides a bias load to the cover towards its closed position.

As this frictional force is always applied to the movement of the cover, it should be clear that this type of locking device is not compatible with the aforementioned spring from DE 20 2012 100 856 U1 as the frictional result of the interaction between the spring loaded element and the cover would interfere with the instability of the protective cover in the cover-open position.

In an alternate execution of WO 2012/019625 A1, the locking system can be disengaged from the cover, and in the case of an inserted plug, applied to an inserted plug as a holding force instead of being applied to the cover when the socket and plug are in the connected condition. This allows for an emergency release function to be applied to the plug in that when a pulling force is applied to the cable of the plug, the locking lever of the device is forced open and a disengagement of the connection is achieved before damage to the plug or socket can occur.

Thus, it is an object of this invention to provide locking devices for covers of electrical connectors that overcome the drawbacks of the prior art.

### DESCRIPTION OF THE INVENTION

In an embodiment, the invention relates to an electrical connector comprising a stationary socket housing, a rotatable locking part and/or cover, and a cam-controlled locking mechanism, wherein
the cam-controlled locking mechanism comprises a cam surface, a driving follower and a locking spring, and
the locking spring exerts a force, over the driving follower, over the cam surface, which in turn acts as a rotational moment on the rotatable part and/or cover, during a part of, or over all of, the movement of the rotatable locking part and/or cover between a closed position and an open position.

The present invention typically increases the closing force on the protective cover of an electrical connector when it is in its closed position and disengages from the protective cover when it is in its open position if the protective cover is equipped with a two-position functionality. That is, if the protective cover of the electrical connector stays open when released by the user, or is otherwise equipped with a functionality that differs from an automatic closing of the cover, then the locking device according to the present invention disengages from the protective cover so that the automatic closing or other functionality of the cover is not impeded or degraded by the locking system according to the described invention. The locking device may also be used to provide an opening force in the cover-open position and thereby act against a spring bias on the cover to keep the cover in its open position.

Further, the locking device according to the present invention greatly increases the closing force on the protective cover, whereby as the closing force on the cover provided by the invention is not a result of a function of the linear cover spring, the ease of handling is not degraded, nor is the risk of injury to the user increased by the higher closing force on the sealing cover.

As opposed to other locking device types, the present invention possesses the advantage that the above mentioned second embodiment of DE 20 2012 100 856 U1 where a metastable state allows for a stay-open-and-close-automatically function can be combined with the locking device of the present invention. Through a decoupling of the locking device from the rotatable protective cover in the cover-open position, additional cover functions such as an automatic closing of the rotatable cover are not impeded by the locking device.

Moreover, the incompatibility of the way the frictional force is applied to the movement of the cover in WO 2012/019625 A1 with the spring from DE 20 2012 100 856 U1 is also solved by the present invention. This illustrates another advantage of the present invention in that the disengagement of the cam surface from the driving follower in the cover-open position does not interfere with additional cover functionalities as is the case with spring-biased locking devices known from the state of the art. The pre-loading of the spring loaded element of WO 2012/019625 A1, which in comparison to the current invention, is similar to the driving follower, whereby the driving follower of the current invention is not limited by a maximum limit of a frictional force as the locking function of the cam-controlled locking mechanism can be disengaged at a preset opening angle of the cover according to the execution of the cam surface.

In embodiments of the present invention the device comprises a housing and a rotatable cover which can be moved from a closed position to an open position about a rotational axis, and a cam-controlled locking mechanism, which acts upon the cover in the closed position such that a force is exerted upon the cover in order to prevent an unwanted movement of the cover from the closed position when the cam-controlled locking mechanism is engaged. The cam-controlled locking mechanism comprises a cam surface and a driving follower which is loaded by a locking spring towards the cam surface such that the force of the locking spring is transferred to cover as either a closing force, an opening force, or a force of greater, equal or less magnitude than the force of the locking spring. The cam-controlled locking mechanism may also be disengaged from the cover by means of a rotatable locking lever, or by means of a disengagement of the cam-controlled locking mechanism through a separation of the cam surface from the driving follower. The force conversion of the cam-controlled locking mechanism and/or separation of the cam surface from the driving follower or disengagement of the locking lever from the cover may be either manually controlled or be a function of the rotational position of the cover with respect to the housing.

One aspect successfully addressed by the present invention is the creation of a locking system which allows for the unimpeded function of additional cover functionalities while providing a very high closing force in the cover-closed position. The locking function should be either applied directly to a protective cover whereby it can be disengaged as a function of the opening angle of a protective cover in relation to a fixed socket housing which has been mounted to a vehicle or trailer. Whereby the applications for the invention are not limited to automotive applications or electrical connectors. Alternatively, the locking function can be applied or disengaged from the cover or plug by means of the movement of a locking lever.

Another solved aspect is that the invention should also be economical in comparison to the products known from the state of the art in that the required geometry of the device can be integrated into the geometry of pre-existing parts which are required for the function of the device as well as employ fewer springs and other locking elements in comparison to other similar cover-locking systems. Symmetries of mirrored parts are not required in the present invention and open mechanisms which can be readily cleaned provide an improved level of resistance to jams and malfunctions caused by particulate matter.

A problem caused by many automatic locking systems is that the locking system itself may prevent the cover from closing completely as the closing force of the biased spring which provides the closing force or moment on the protective cover is also responsible for opening a locking device such as a spring-loaded pawl or other snapping feature which acts on the cover in the cover-closed position. As previously described, standard helical leg springs have a lower closing force in the cover-closed position than in the cover-open position, and therefore in an aged or otherwise degraded condition such as the interference of dirt or ice, the spring force of the protective cover is not adequate to open the locking device of the cover, and the resulting condition results in the cover being propped open by the locking system which is supposed to keep the protective cover closed.

In an embodiment the line of action of the normal-force between the cam surface and the driving follower crosses over the rotational axis of the rotatable part and/or cover during the movement of the cam-controlled locking mechanism, such that the cam-controlled locking mechanism acts to close the rotatable part and/or cover over one portion of its movement, and to open the rotatable part and/or cover over another portion of its movement. A particularly distinct advantage of the present invention is, that by the line of action of the normal force between the cam surface the driven follower crossing from one side of the cam rotational axis to the other, the locking mechanism may act to close the cover over one range of the cover moment, and act to open the cover in another range of the cover movement. Instead of impeding the closing of the cover by requiring the closing force of the spring to open a locking device at the end of its movement into the cover-closed position, the cam-controlled locking mechanism begins to pull the cover into the cover-closed position once a defined opening angle of the cover has been reached. This is achieved by directing the pressure angle of the cam-controlled locking mechanism from one side of the rotational cover axis to the other side such that at a pre-determined position of the cover, the cam-controlled locking mechanism acts in conjunction with as opposed to against the cover spring, to bring the cover into its closed position. That is, as the force provided by the locking spring is diverted in a direction from one side of the rotational cover axis to the other by the cam surface, an inflection point is reached and the moment on the cover acts in the opposite direction.

When opening or closing the cover, the user will feel the angular position at which the inflection of the opening or closing moment occurs, this angular position can be quite far from the cover-closed position, and as the pressure angle of the cam surface directs the force of the locking spring over the rotational cover axis, the user will be able to feel that the cam-controlled locking mechanism has engaged, which will have a much more high-quality and robust feel than a snapping mechanism which occurs close to or in the cover-closed position.

In a particularly useful embodiment of the invention, the pressure angle and/or moment arm about the rotational axis of the cam, of the normal-force between the cam surface and the driving follower is higher in the locked position than in other positions of the movement of the cam-controlled locking mechanism. This locking force can be further improved or increased by designing the locking system such that the movement axis of the driving follower does not intersect with the rotational axis of the cam, this eccentricity can alter the characteristics of the cam in one direction, that is, the torque applied by the cam-controlled locking device can be calibrated to the requirements of the system in order to maximize use of the available space and reduce the total amount of materials required to build a product.

In other embodiments, the separate rotatable locking part acts upon the cover over a point or edge, said geometry being integrated with the cover or the separate rotatable locking part. The embodiment of the cam surface can be modified such that the fall of the cam, that is, the portion of the cam surface between the high dwell, and the cover-closed low dwell, can be designed very steep or non-existent as a sharp or rounded edge in order to increase the pressure angle in the cover-closed condition. That is, the portion of the cam surface at which the locking spring is at its highest compression and the portion of the cam surface in the cover or rotatable locking device occur closer together with a smaller or non-existent transition between them.

In an alternate embodiment of the invention, the cam-controlled locking device does not act directly upon the protective cover, rather on a rotatable locking part which is separate from the cover and can be disengaged or engaged independently of the position of the cover and can furthermore be engaged or disengaged regardless of whether or not the execution of the invention includes a cover at all.

The rotatable locking parts can be divided in to two sub-categories:
A locking lever, whereby the locking lever has the ability to apply a force to either the rotatable cover or to another connector in the case of an open cover and a inserted connector.
A clevis is a rotatable locking part which can only interlock or disengage with other connector side and not a protective cover. This version is used when the clevis is not mounted on the connector side which contains the cover, or if the connection system does not include a protective cover at all.

A similar functionality like the emergency release function of WO 2012/019625 A1 is achievable with the present invention when in use with a rotatable locking part, however unlike the locking system in WO 2012/019625 A1, the present invention allows for an open design which can be easily cleaned and is not susceptible to the ingress of dirt or other particulate matter which may jam or otherwise interfere with the operation of the locking device.

In this embodiment, the closing force of the cam-controlled locking mechanism acts over a rotatable locking part, separate from the rotatable part and/or cover, in order to disengage the closing force of the cam from the cover and/or in order to cause the closing force of the cam-controlled locking mechanism to act on a temporarily engaged connector which is mated with the connector which is equipped with the cam-controlled locking mechanism.

If the cam-controlled locking mechanism acts upon a locking lever instead of directly on the cover, here too can the cam surface be defined such that the angular position of the locking lever at which the force of the locking spring is directed from one side of the rotational lever axis to the other and the torque provided by the cam-controlled locking mechanism acts from opening to closing the locking lever will be felt by the user as a robust and unusual mechanism that presents a much higher quality than a simple snapping mechanism or locking pawl.

Furthermore, the use of a locking lever which applies a force to the back of a plug in order to hold it in place, allows for the use of the invention as an emergency disengagement device. As a pulling force is applied to either the cable of the plug or the plug housing, the locking lever is forced open, which in turn releases the plug from the connected condition, before damage to any of the components can occur. This is useful to prevent damage in case, for instance, a vehicle is mechanically decoupled from a trailer, but remains electrically coupled and the vehicle drives away from the trailer.

In an alternate embodiment, the cover and/or the rotatable locking part are loaded by a cover spring. Spring biased covers are known from the prior art, however a spring bias could be applied to a rotatable locking part such as a locking lever or clevis such that this rotatable part inherently moves to either the engaged or disengaged condition, either in conjunction with, or in opposition to the locking direction of the cam-controlled locking device.

The biasing element in the aforementioned embodiment could be executed as a tension spring, a compression spring, a helical leg spring, a buckling spring, a flat spring, or an elastomer spring.

In some embodiments, the cam surface is integrated or fixed to the rotatable part and/or cover which saves assembly costs and reduces the amount of material required.

In such an embodiment of the present invention which provides a great deal of space in order to optimize the characteristics of the cam-controlled locking mechanism, the cam surface is integrated or fixed to the cover and the driving follower and locking spring are installed in the housing. Typically, the profile of the cam surface is defined radially from the rotational cover axis, and the translation of the driving follower is orthogonal to the rotational cover axis, however other definition of the cam surface are possible such as a cam surface which is defined parallel to the rotational cover axis with a translation of the driving follower that is also defined parallel to the rotational cover axis.

The driven element, either the cover or the locking lever, can be positioned with an eccentricity to the rotational center of the cam surface such the pressure angle has a weighted effect on either the opening or closing rotational direction because the moment arm of the directed force from the locking spring is greater on one side, and accordingly in one rotational direction.

In other embodiments the cam surface is integrated or fixed to the stationary socket housing. This is particularly useful when the driving follower and locking spring are mounted in the protective cover.

In such an alternate embodiment, the cam surface is integrated with or fixed to the housing, and the driving follower and locking spring are installed in the cover. In a very compact execution of the invention, the rise of the cam surface is not in a radial direction orthogonal to the rotational cover axis or rotational lever axis, rather is executed with a constant radius with a rise which is parallel or mostly parallel to the rotational axis of the driven element, that is the cover or locking lever. If the driving follower and locking spring are installed in the cover instead of the housing, this provides for a very compact space requirement of the cam-controlled locking mechanism as the device is installed in a volume which is already occupied by the movement of the cover. That is, in the case of a vehicle, no other components may be placed in this volume, otherwise the cover would be blocked from opening.

The driving follower must of course be moved back from the fully extended position on the low dwell of the cam surface as the cover moves toward the cover-closed position by the spring force provided by the cover spring, however this force occurs at a much greater opening angle of the cover, and therefore the closing force of the cover spring is much higher due to its increased deformation in relation to its deformation in the cover-closed position. The high dwell can be positioned such that the locking spring is fully compressed when the cover spring is also at a high compression with an accordingly high closing force, and therefore a non-closure of the cover due to the locking system itself can be excluded with certainty.

In an alternate embodiment of the invention, the force of the cam-controlled locking mechanism acts to open the rotatable part and/or cover against a cover spring which is biased to close the rotatable part and/or cover, thereby keeping the rotatable part and/or cover in a stable or instable open position. In this case, the opening moment provided by the cam-controlled locking mechanism on the cover could be used to balance the torque of a biased cover spring such that the user would need to push the cover down over the inflection point of the cam-controlled locking mechanism, so that the cover would remain open, even when equipped with a standard spring, such as for instance a helical leg spring or other linear spring as a biasing element.

Due to a standard biased spring of a protective cover having typically a lower spring force in the cover-closed position than the cover-open position, and the spring force being limited by a maximum acceptable value for a spring force in the cover-open position, the protective covers of electrical connectors according to the state of the art are typically susceptible to being slightly opened by an opening force caused by external currents. That is, as the vehicle is driving, the air currents caused by the movement of the vehicle through the air act on the cover in such a way that the closing force of the biased spring on the protective cover is overcome, and the desired sealing of the internal volume of the electrical connector is exposed to the environment as a result. This effect is exacerbated by driving through water or snow whereby the weight of the current is much heavier than air and therefore the magnitude of the resulting reaction force is correspondingly higher. Additionally, water or snow currents have the undesired effect of filling the internal socket volume with water after the cover has been opened. Once the protective cover closes again, the water is trapped inside the internal volume of the socket, which leads to an intensified corrosion of the electrical contacts.

The difference in the opening and closing forces of a cover spring according to the state of the art could be reduced by means of a larger spring with a lower spring rate, such as a torsional leg spring with more coils, but there is typically not enough space available for this optimization.

The increased cost of the larger spring is also a deterrent to distributing the deformation of the elastic element, such as a spring, over a higher volume of material, such as the increased number of coils in a torsional spring, or an increased outer diameter of a compression spring.

In a particularly useful execution of the present invention, the closing force of the cam-controlled locking mechanism is higher in the rotatable part and/or cover closed position and/or in the plug inserted position than in other positions of the cam-controlled locking mechanism. Then the closing force on the cover is highest in the cover-closed condition. As opposed to standard biased covers which have a lower closing force in the cover-closed condition than in the cover-open condition, according to the design of the cam-controlled locking device, the closing force on the cover increases as the angle between the cover and the housing decreases due to the increasing pressure angle and the resulting rotation force on the cover in the opening direction required to push the driving follower back and compress the locking spring. The result is a closing force on the cover that increases as the cover approaches the cover-closed position instead of decreasing increases as the cover approaches the cover-closed position.

The cam surface can be synchronized to any desired function of the opening angle between the housing and the cover, the inflection point of the cam surface from a cover-opening to a cover-closing effect, the angle at which the highest force is required to compress the locking spring, and the angle at which the driving follower separates from the cam surface and no longer acts upon the cover can all be defined by the shape of the cam surface. The cam surface may also be equipped with more than one high dwell, that is more than one inflection point or more than one locking position of the cover or locking lever. This function may be particularly useful in case the cover is required hold the plug or another part in place at an angular position between the fully open and fully closed positions.

In further embodiments, the movement of the driving follower is limited by a blocking surface, such that the driving follower does not act on the cam surface over a range of its movement, and the force of the spring is not transferred to the cam surface. The separation of the driving follower from the cam surface is achieved by the use of a blocking surface which limits the movement of the driving follower and prevents the locking spring from loading the driving follower or in turn the cam surface.

In an embodiment, the driving follower may be in the form of a cylindrical or tapered roller, a ball, a wedge, a flat follower, a blade, or a stamped and formed profile. Depending on the shape, form and type of the driving follower, one or more blocking surfaces may be used.

In an alternative execution, the driving follower may be integrated with the spring as a single part.

The single part may be made of a flexible material such as metal, plastic or elastomer, preferably of glass-reinforced plastic, a hard elastomer or metal. It may also be a stamped and formed part or an integrated part of any other type. In this variant, the original non-deformed shape of the driving follower and locking spring part could limit the movement of the driving follower, and prevent the driving follower from acting on the cam surface in the low dwell of the cam surface, that is, the cover-open position. In this case the blocking surface may not be required.

### BRIEF DESCRIPTION OF THE DRAWINGS

While the invention is amenable to various modifications and alternative forms, specifics thereof are shown by way of example in the drawings and described in detail herein. It should be understood, however, that the intention is not to limit the invention to the particular embodiments described.

FIGS. 1a, 1b and 1c show an embodiment in different side views.

FIGS. 2a and 2b show the embodiment of FIGS. 1a, 1b and 1c in different cross-sectional views.

FIG. 3 shows the cam-controlled locking mechanism in cross-sectional views.

FIGS. 4a through 4f show cross-sectional views of the cam-controlled locking mechanism in different states of opening the cover.

FIGS. 5a through 5c show a tilted view of the invention in the cover-open position.

FIGS. 6a through 6c show a tilted view of the invention in the cover-closed position.

FIGS. 7a through 7c show an alternate embodiment.

FIG. 8 shows the assembly from FIGS. 7a through 7c in a cross-sectional view.

FIG. 9 shows a top view of the embodiment of FIG. 8 in the cover-open condition.

FIG. 10 shows yet another embodiment.

FIG. 11 shows a cross-sectional view of the assembly from FIG. 10.

FIGS. 12a through 12e show the functional steps of the locking lever.

FIGS. 13a and 13b show a cross-sectional view of the emergency disconnection function.

### DETAILED DESCRIPTION OF PREFERRED EMBODIMENTS

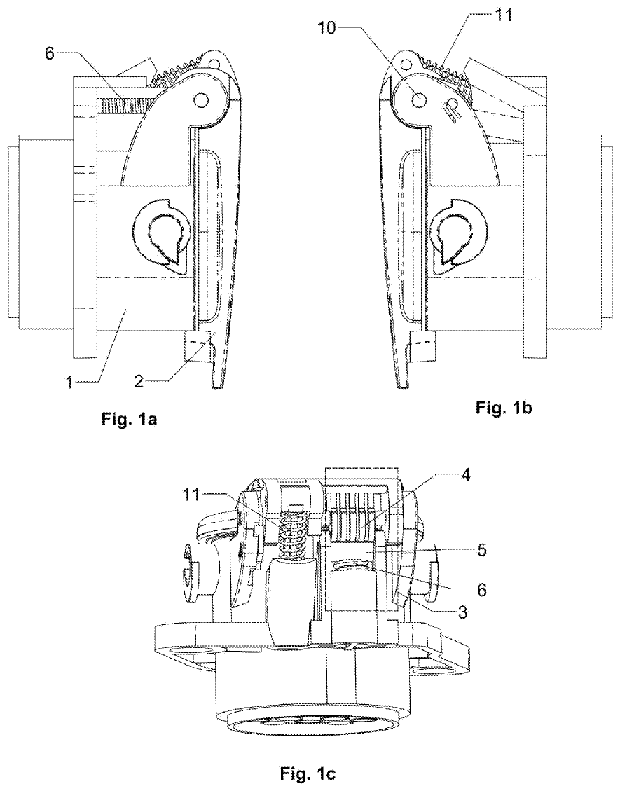

The invention is particularly useful in combination with a non-linear spring with a static, yet instable cover-open condition as known from the state of the art and previously described when used for the application of an electrical socket with a protective cover for the electrical contacts contained within. FIGS. 1a, 1b and 1c show such an embodiment, whereby the cam surface (4) is integrated as one part with the cover (2) and the cam-controlled locking mechanism (3) and cover spring (11) are positioned next to each other behind the rotational cover axis (10) in a particularly compact execution of the invention. FIGS. 1a and 1b show an electrical socket for semitrailer connections from the sides with the cover in its closed position, whereby FIG. 1c shows the invention from the top to illustrate the location of the cam-controlled locking mechanism (3) in relation to the rest of the assembly.

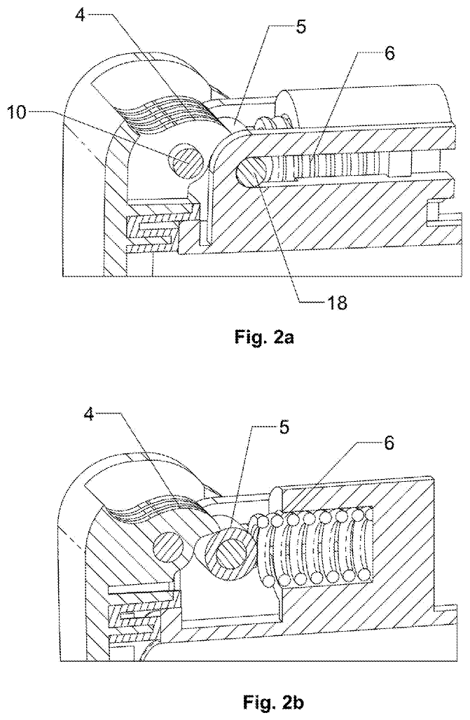

FIG. 2a shows the assembly from FIGS. 1a-1c in cross-section. The cut is through the geometry of the blocking surface (15) as well as the bearing geometry of the driving follower (5). The rotational cover axis (10) is shown as a cylindrical pin, however this may be any other type of geometry such as an integrated tab with the cover (2) or housing (1), a rivet or a spiral spring pin. As depicted, the cover is in the closed position, and the driving follower (5) has been pushed toward the cam surface (4) by the locking spring (6) whereby the movement of the driving follower (5) has either been stopped by the blocking surface (15) or by the cam surface (4) depending on the desired execution. The movement of the driving follower (5) may be limited by the cam surface (4) and in turn by the limited rotation of the cover (2) in its closed position as the cover seal (17) is deformed or compressed against the housing (1), however in some cases this would provide a closing force on the cover (2) which is higher than desired and which would degrade the handling and haptic of the system. To counteract this effect, the driving follower (5), the follower pin (18) or any other geometry which is connected to the driving follower (5) may limit the movement of the driving follower (5) in the cover-closed position.

FIG. 2b shows a cross-section of the same assembly whereby the cross-section passes through the cam surface (4) in order to show the function of the cam-controlled locking mechanism (3) in the cover-closed position. The locking spring (6) is at its greatest possible extension, however it is still in a compressed condition in order to provide a constant pre-loading to the driving follower (5). It would however be possible to eliminate this pre-loading and by loading the driving follower (5) from the side, that is at an angle which is not generally parallel with the allowable movement direction of the driving follower (5), to create a locking effect by the use of a frictional force resulting from the bearing geometry of the driving follower (5), or if applicable, the follower pin (18). The cam surface (4) shows a sharp corner in order to direct the force of the locking spring (6) over the driving follower (5) and in turn the cam surface (4), which is optionally integrated as one part with the cover (2), in order to produce a moment about the rotational cover axis (10) in the cover-closing direction. In this particular execution, the fall (19) of the cam surface (4) is too steep to stop the movement of the driving follower (5) without causing a jamming effect on the movement of the cover, thus demonstrating the need for the blocking surface (15), however by means of a less steep fall (19), that is a transition from the cover-closed high dwell (23) to the cover-closed low dwell (22) over a greater range of movement of the cover (2), the need for the blocking surface (15) in the cover-closed position could be eliminated.

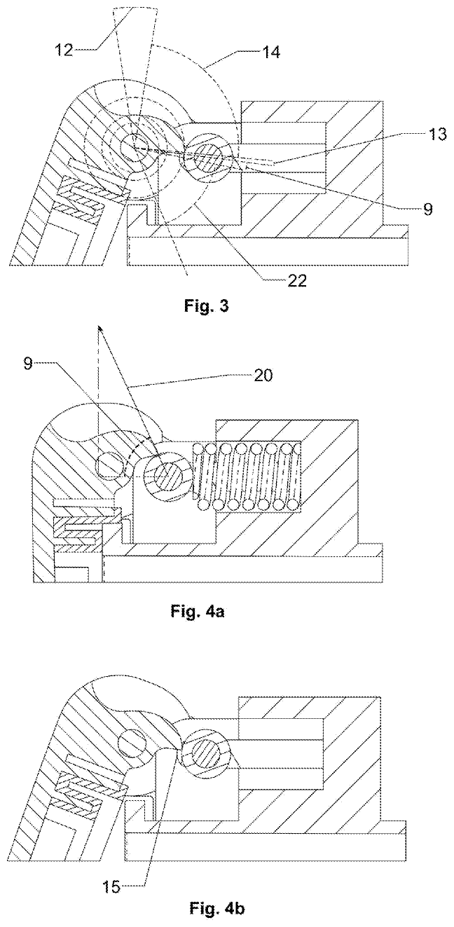

FIG. 3 shows the cam-controlled locking mechanism (3) in cross-section whereby the cover (2) is opened to the inflection point of the rotational moment from a closing action to an opening action. That is, the transmission force (20) between the cam surface (4) and the driving follower (5) is directed through the rotational cover axis (10) such that in this position there is no moment arm between the rotational cover axis (10) and the transmission force (20) thereby the cam-controlled locking mechanism (3) does not act to rotate the cover (2). In this position, rotating the cover (2) in the clockwise direction would cause the cam-controlled locking mechanism (3) to act in a cover-opening direction, and rotating the cover (2) in the counter-clockwise direction would cause the cam-controlled locking mechanism (3) to act in a cover-closing direction. The locking spring (6) is not shown.

The parts of the cam surface (4) have been marked in order to show their function. The cover-open low dwell (12) of the cover-open position and the cover-closed low dwell (22) of the cover-closed position are of different radii, however this is not necessarily required for the function of the cam-controlled locking mechanism (3). The high dwell (13) and the fall (19) are noticeably small in comparison to the rise (14), this has the advantage of allowing a greater portion of the available angular distribution to be used for the rise (14) so that the closing force provided by the cover spring (11) may be reduced as if must compress the locking spring (6) during the automatic closing of the cover (2) and a greater angular distribution of the rise (14) results in a smaller pressure angle (9) and in turn a lower required force to close the cover (2) and compress the locking spring (6). As necessary, the distribution of the portions of the cam surface (4) can be altered or eliminated, such as a cam surface (4) with more than one high dwell (13) so that the cover (2) would lock in more than one angular position, or the elimination of the high dwell (13) so that the inflection point would be constructed as a sharp edge between the rise (14) and the fall (19).

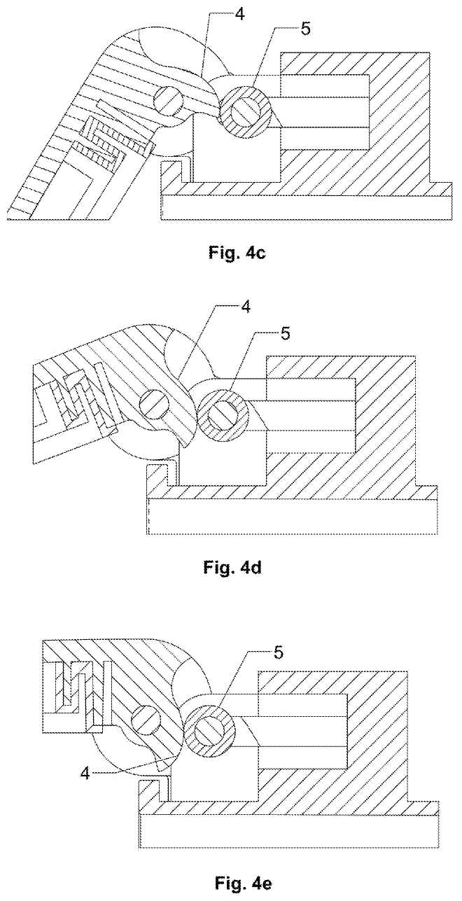

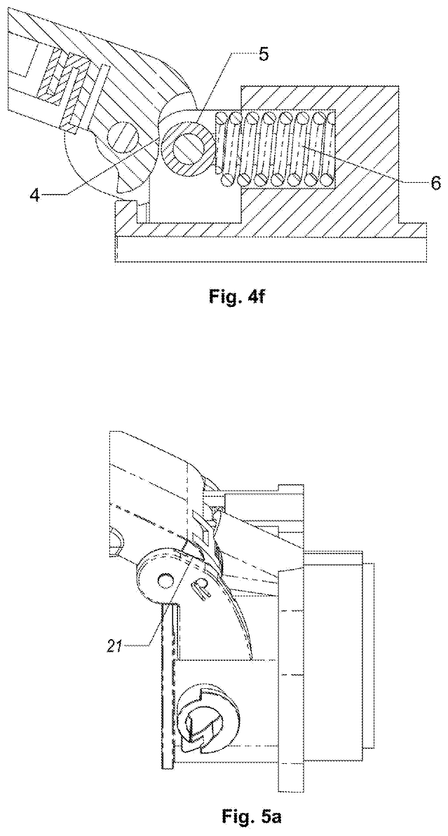

FIGS. 4a through 4f show the cam-controlled locking mechanism (3) in cross-section during the process of opening the cover. Whereby the locking spring (6) is not shown in its intermediate stages in FIGS. 4b through 4e, it is understood that the driving follower (5) is under a constant preload in the direction of the cam surface (4).

FIG. 4a shows the cover in the closed position. The transmission force (20) is shown broken into horizontal and vertical force components, whereby the horizontal force, which is parallel to the compression direction of the locking spring (6), is noticeable smaller than the transmission force (20), which acts to create a torque upon the cover (2). This clearly demonstrates the force multiplying effect of the cam-controlled locking mechanism (3), which in this case produces a transmission force (20) of approximately 2.4 times the spring force of the locking spring (6). Note that the force of the locking spring (6) does not pass directly through the rotational cover axis (10), this shows an eccentricity in the system to increase the closing moment of the cam-controlled locking mechanism (3) in the cover-closed position and this eccentricity can also be used to decrease the amount of force required to compress the locking spring (6) as the cover (2) closes.

In FIG. 4b the cover has been opened approximately 20°, and the cover (2) is opened to the inflection point of the rotational moment from a closing action to an opening action. This occurs at the high dwell (13) which in this case is very small and provides a somewhat unstable condition so that the user will feel a switching action in the handling of the cover. The high dwell (13), could however also be executed over a greater angular portion of the cam surface (4) so that there would be a greater portion of the cover (2) rotation between the angle at which the cam-controlled locking mechanism (3) acts to either open or close the cover (2).

In FIG. 4c, the cover has been opened further. The driving follower (5) presses against the rise (14) and the compression of the pressure angle (9) begins to reduce. Normally, the cover spring (11) would still be strong enough to overpower the cam-controlled locking mechanism (3) so that the cover (2) closes itself regardless of the angle at which it is released, however it would also be possible to design the invention such that the moving part, either the cover (2) or the locking lever (7) remains open after the driving follower (5) is in contact with the rise (14). FIGS. 4d and 4e show the cam-controlled locking mechanism (3) as the cover is opened further, the driving follower (5) is however still in contact with the rise (14) of the cam surface (4) in these opening angles of the cover (2).

In FIG. 4f, the cover has been opened to its blocking position at cover block (21), whereby a block of the opening angle of the cover (2) is not required for the operation of the cam-controlled locking mechanism (3). The follower pin (18) has come to rest against the blocking surface (15), and a gap is now present between the driving follower (5) and the cam surface (4). By means of this gap, the cam-controlled locking mechanism (3) no longer acts upon the cover (2), or in some cases the locking lever (7), no frictional force is caused in the movement of functional parts, and additional functions of the device such as an immediate or delayed automatic closing of the cover (2) are not impeded or degraded. Whereby in this case, the follower pin (18) has come to rest against the blocking surface (15), it is understood that any geometry integrated with or connected to the driving follower (5) could be used to limit its movement and optionally disengage the driving follower (5) from the cam surface (4).

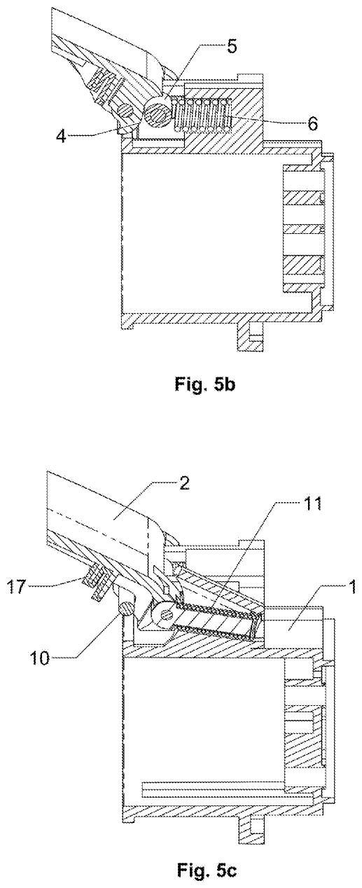

FIGS. 5a through 5c show a tilted view of the invention in the cover-open position. FIG. 5b shows the same assembly as FIG. 5a with a cross-section through the cam-controlled locking mechanism (3) clearly showing the gap between the driving follower (5) and the cam surface (4). FIG. 5c shows the same assembly as FIG. 5a with a cross-section through a non-linear cover spring.

As known from the prior art, this type of spring causes an instable cover-opened condition to allow a self-closing function of the cover (2). By comparing FIGS. 5b and 5c, the observer can see that the disengagement of the cam-controlled locking mechanism (3) is timed to coincide with the instable cover-opened position of the cover (2) and therefore no impediment or degradation of any functionalities can occur.

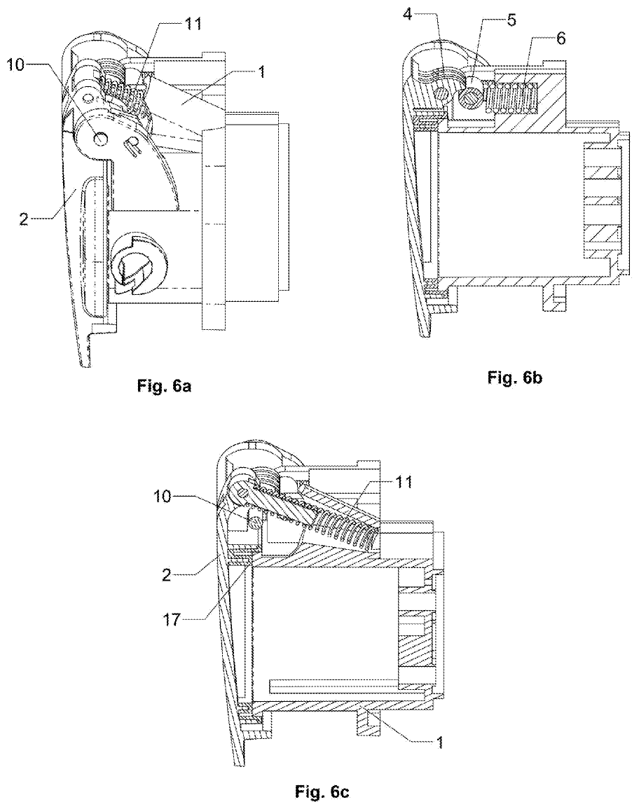

Similar to FIGS. 5a through 5c, FIGS. 6a through 6c show a tilted view of the invention in the cover-closed position. FIG. 6b shows the same assembly as FIG. 6a with a cross-section through the cam-controlled locking mechanism (3) showing the driving follower (5) and the cam surface (4) in the locked position whereby in this position a high closing moment acts on the cover (2). FIG. 6c shows the same assembly as FIG. 6a with a cross-section through a non-linear cover spring which acts independently of the cam-controlled locking mechanism (3) to create a closing moment on the cover (2), it should be noted that the timing of the two independent devices is also synchronized in the cover-closed position of the cover (2).

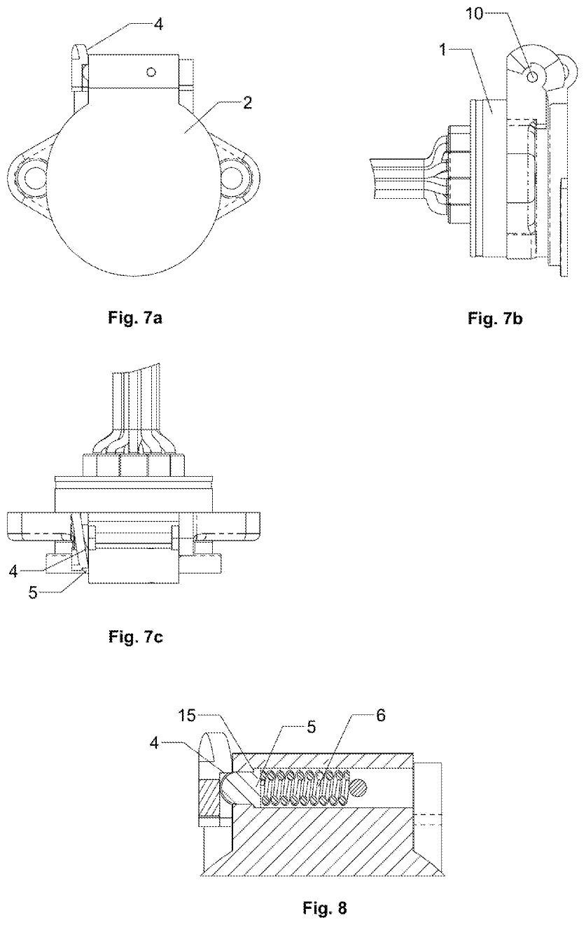

FIGS. 7a through 7c show an alternate configuration of the present invention whereby the cam surface (4) is integrated with or otherwise fixed to the housing (1), and the driving follower (5) and locking spring (6) are mounted in the cover (2). The cam surface (4) is defined by a constant radius about the rotational cover axis (10), or in the case of a locking lever (7) about the rotational lever axis (16), and the difference in the cover-closed low dwell (22), the cover-open low dwell (12) and the one or more high dwell (13) is defined in the direction parallel to the rotational cover axis (10) or rotational lever axis (16).

FIG. 8 shows the assembly from FIGS. 7a through 7c with a cross-section through the cam-controlled locking mechanism (3). It can be noted that the pressure angle (9) between the driving follower (5) and the cam surface (4) is high in the closed position, which results in a high closing moment being loaded on the cover (2).

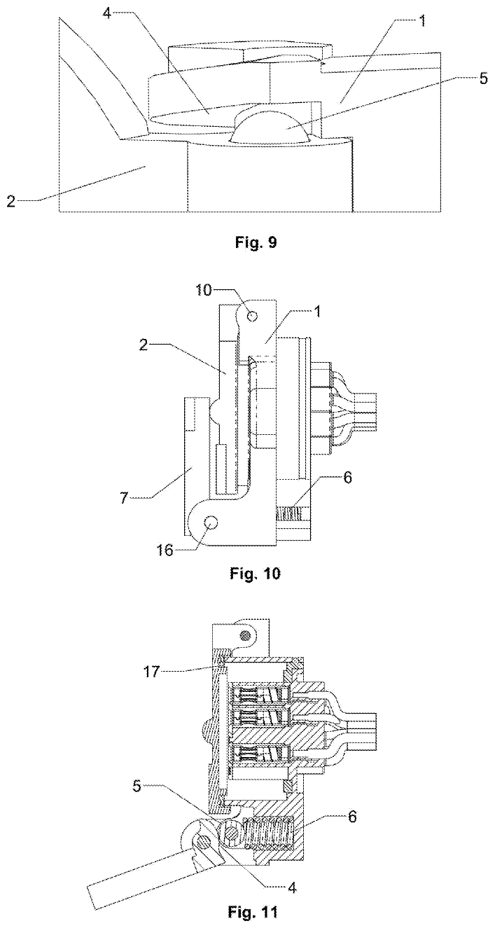

FIG. 9 shows the invention according to the same execution as FIG. 8, in the cover-open condition, as seen from above. This view demonstrates that also in alternative variants, in the cover-open condition, a gap can be caused between the driving follower (5) and the cam surface (4) such that the cam-controlled locking mechanism (3) has been disengaged from any functionalities of the cover (2).

FIG. 10 shows an alternate execution of the invention whereby the cam-controlled locking mechanism (3) acts on a locking lever (7) rather than directly on the cover (2). This variant has the advantage of being able to act on both the closed cover (2) to increase the closing force and thereby the resistance to opening due to currents of media, or acting as a locking device with an emergency decoupling function for an inserted plug (8). Note that the point of contact between the locking lever (7) and the cover (2) is centered on the sealing surface of the cover (2) in order to allow for an even distribution of the force on the cover seal (17).

FIG. 11 shows the assembly from FIG. 10 in cross-section with the locking lever (7) in the open position and the cover (2) in the closed position. The cover (2) is shown with no spring bias, however it could be controlled by any type of control system or spring bias known to the state of the art.

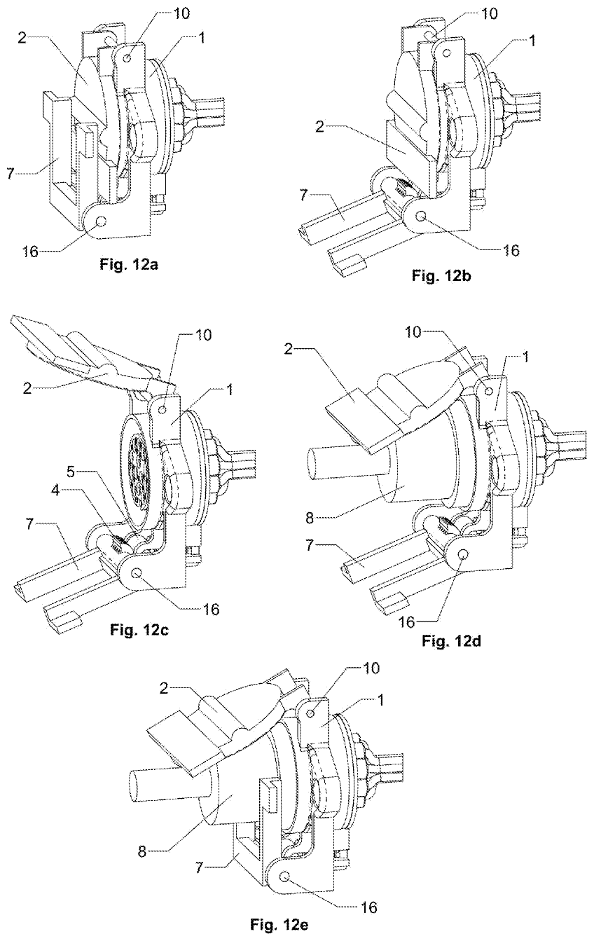

FIGS. 12a through 12e show the functional steps of the locking lever (7) and how it can either act upon the closed cover (2) or on an inserted plug (8). FIG. 12a shows the assembly with the cover (2) closed, and the locking lever (7) acting upon the cover (2) in order to increase the closing force upon it. In FIG. 12b, the user has opened the locking lever (7) and the cam-controlled locking mechanism (3) has switched from acting to keep the locking lever (7) in its closed position to acting to keep the locking lever (7) in its open position so that the user does not need to hold the locking lever (7) in this position. In FIG. 12c, the user has opened the cover (2). Depending on the type of mechanism employed, the cover (2) could either stay open or need to be held open against a force of some type such as a spring force or gravity. FIG. 12d shows a schematic plug after it has been inserted. The cover (2) has been released or has closed automatically depending on the type of cover-closing device. In FIG. 12e, the user has closed the locking lever (7) on the back of the plug (8), and the cam-controlled locking mechanism (3) acts over the locking lever (7) to load the back of the plug (8) or to otherwise prevent the plug (8) from being removed without first opening the locking lever (7).

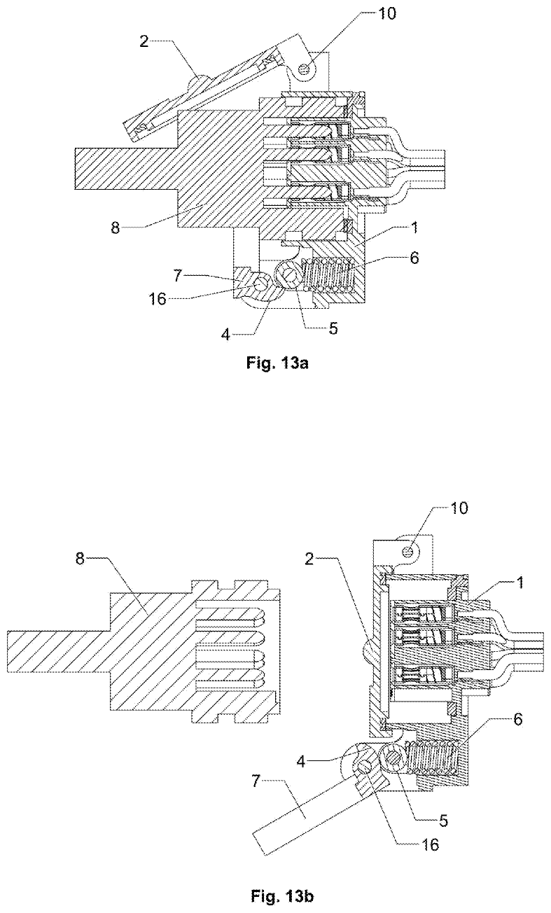

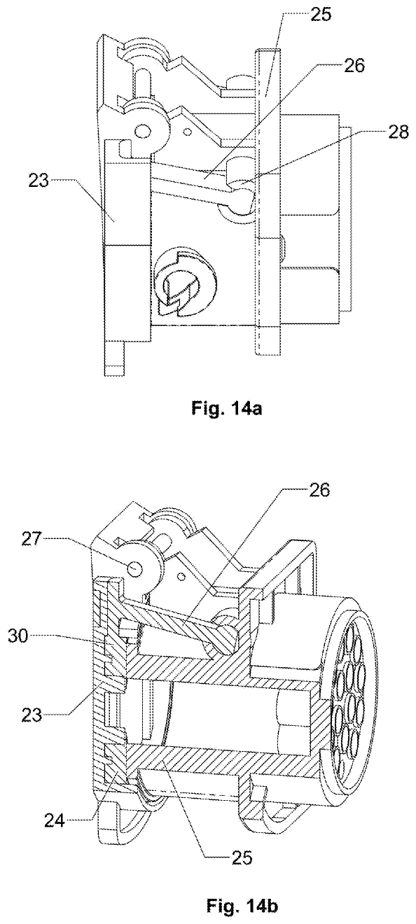

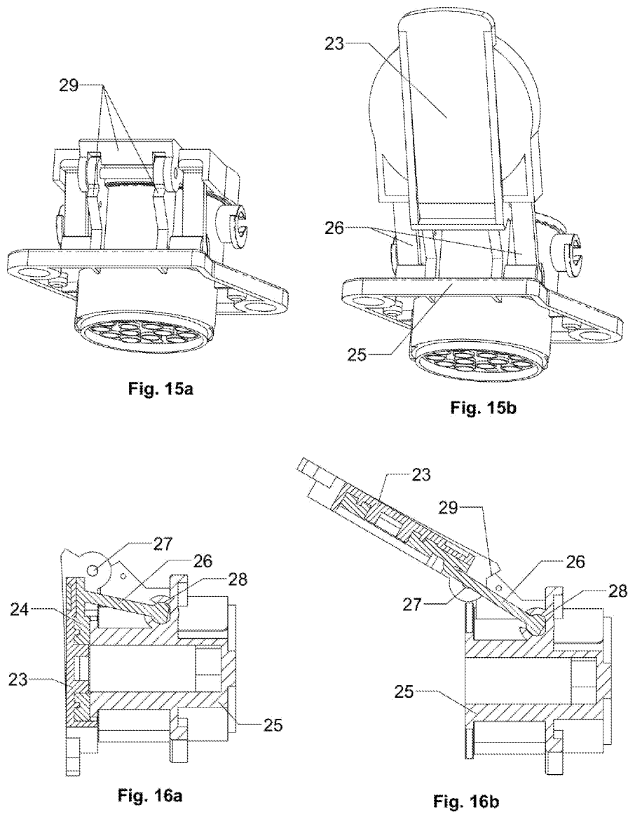

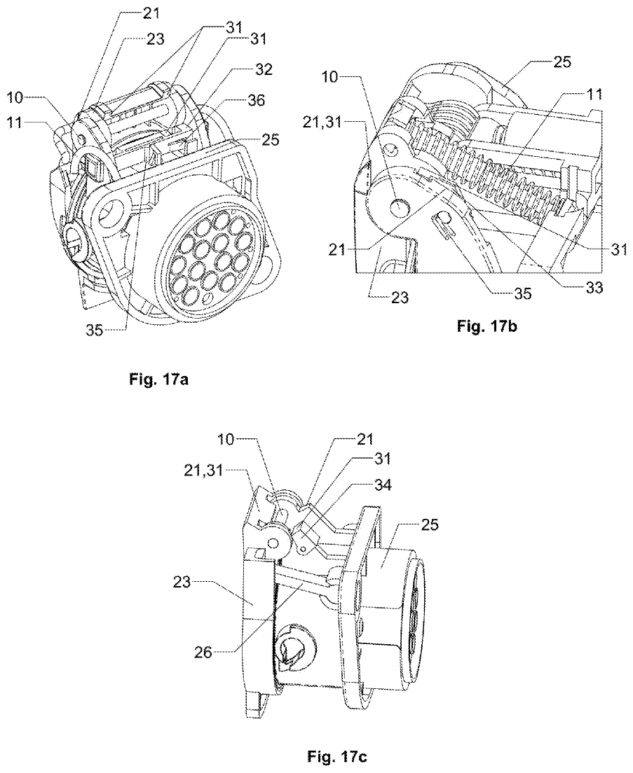

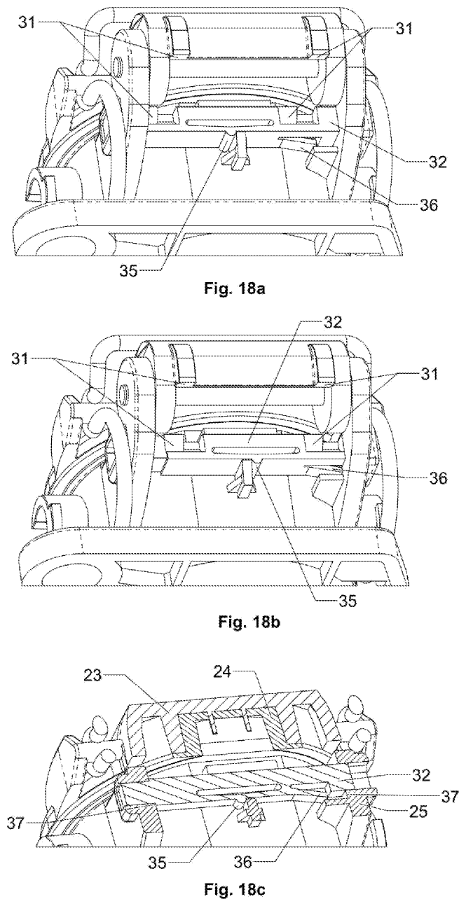

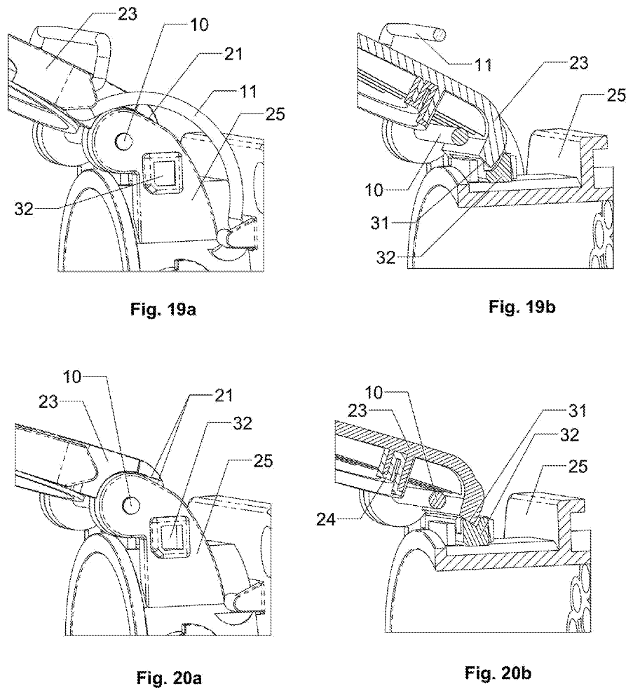

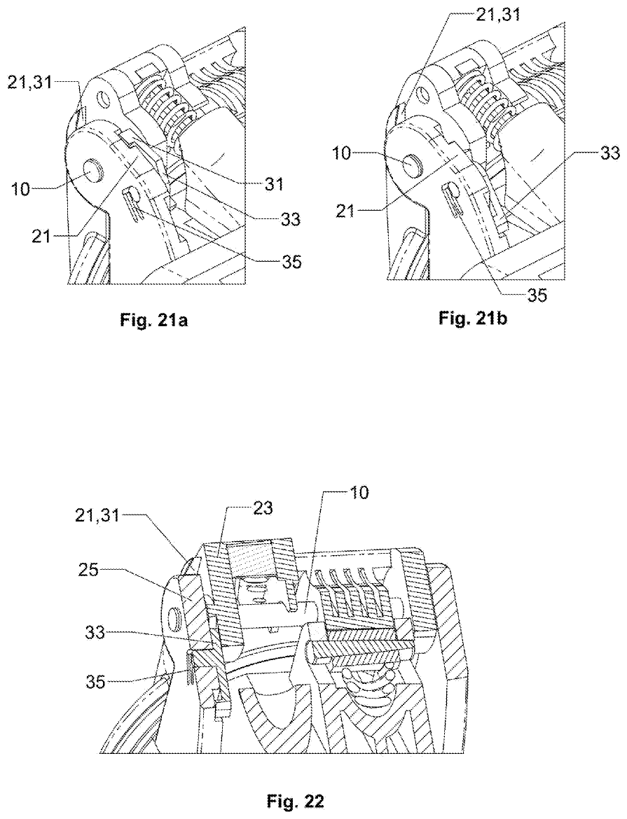

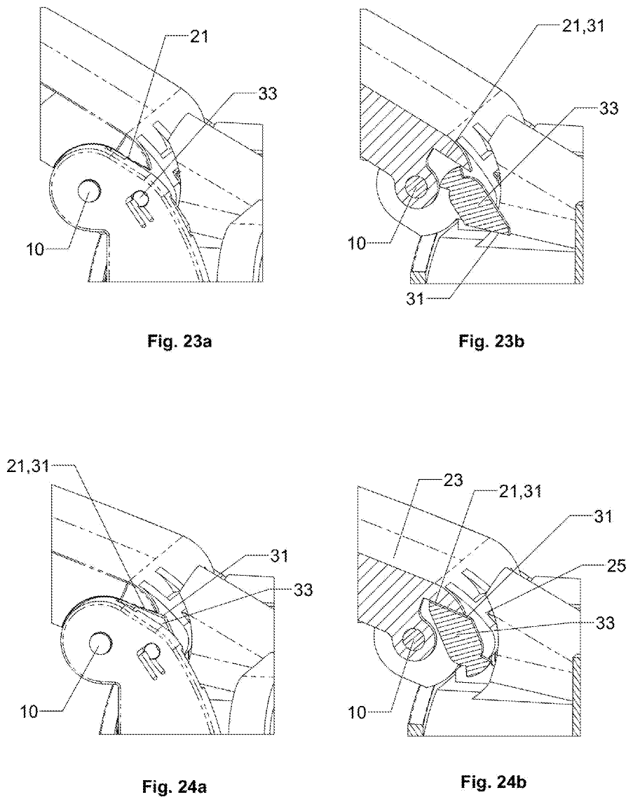

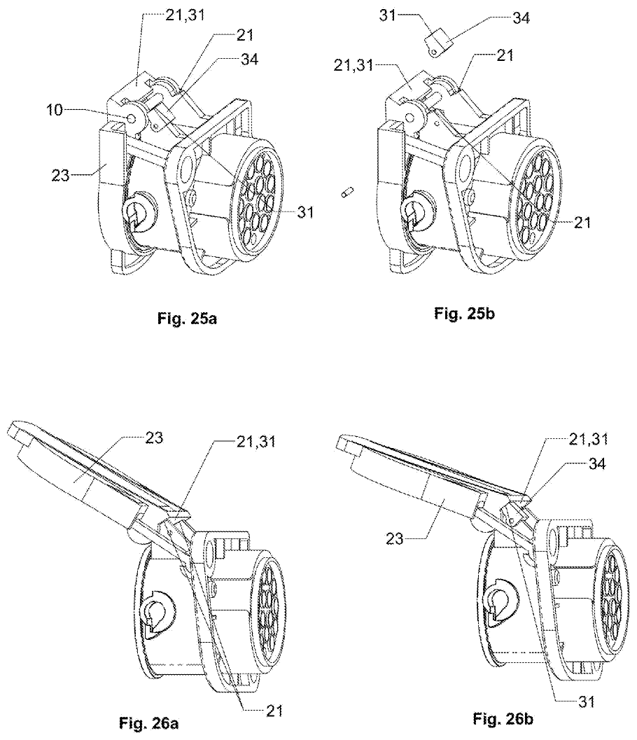

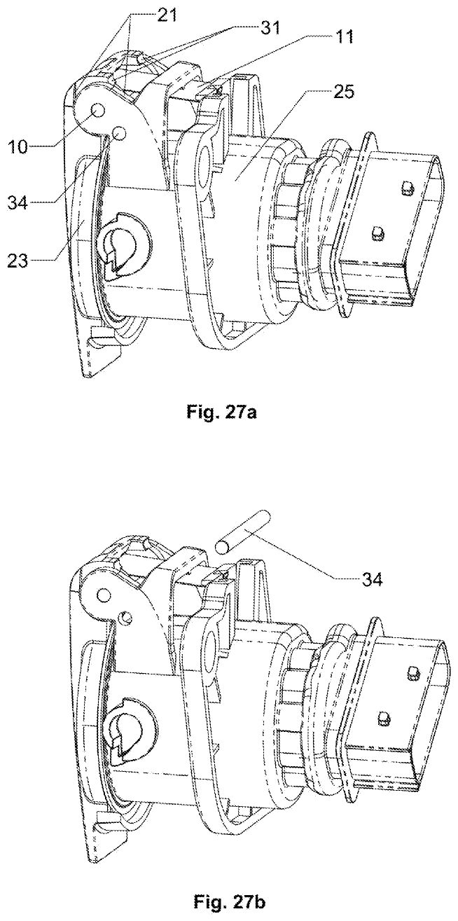

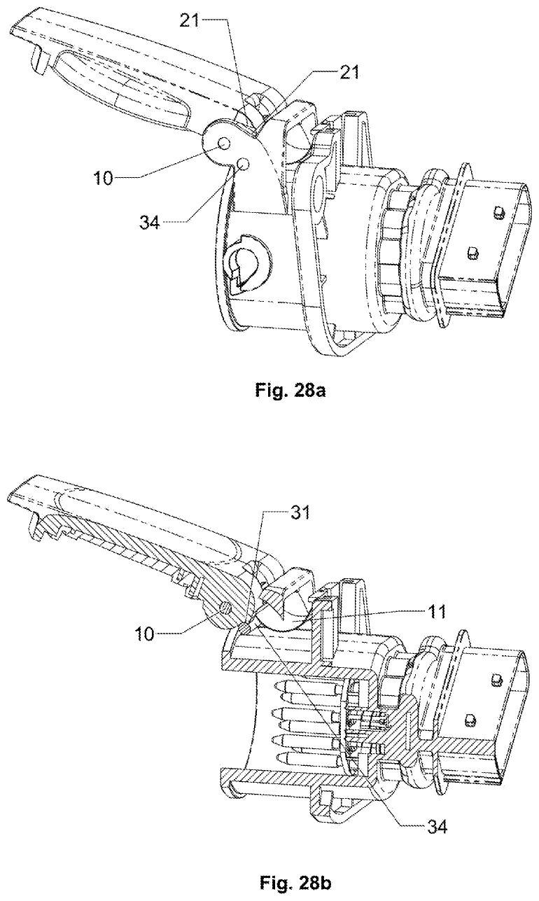

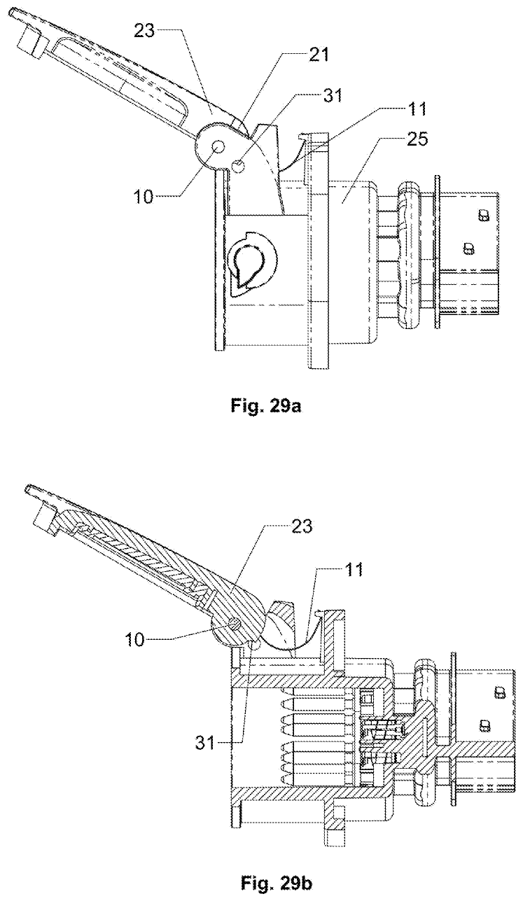

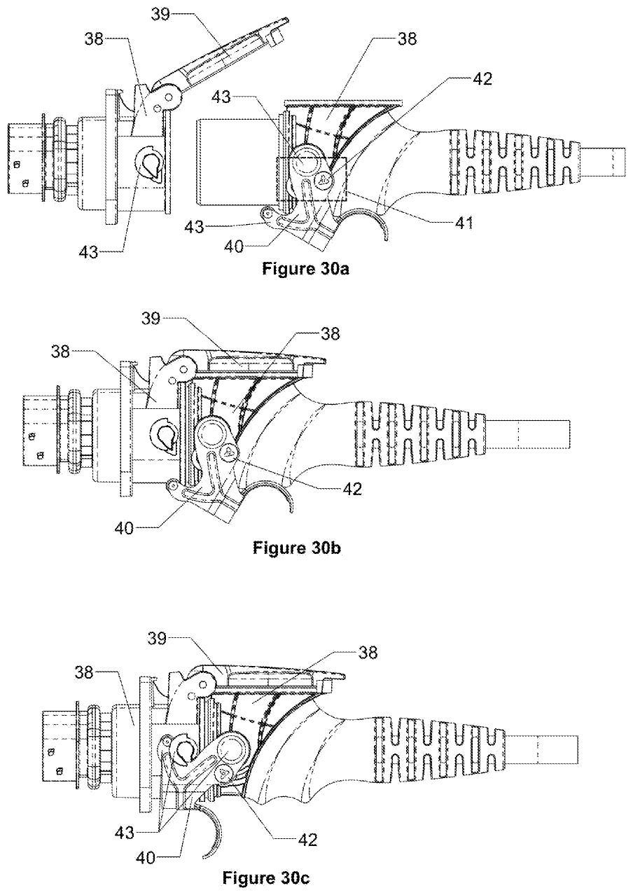

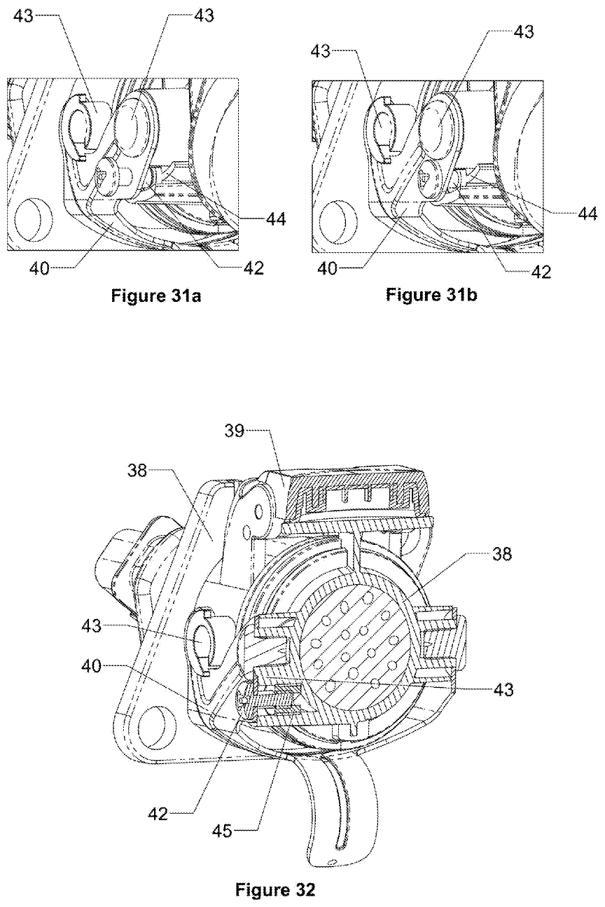

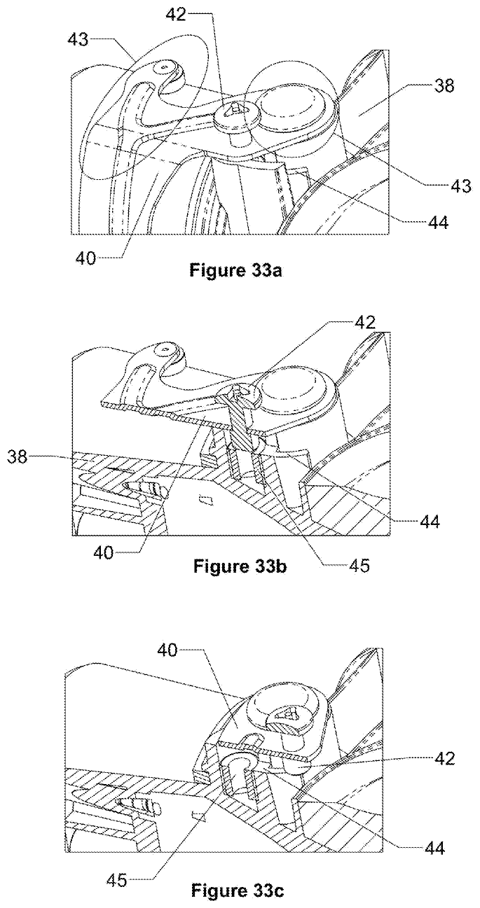

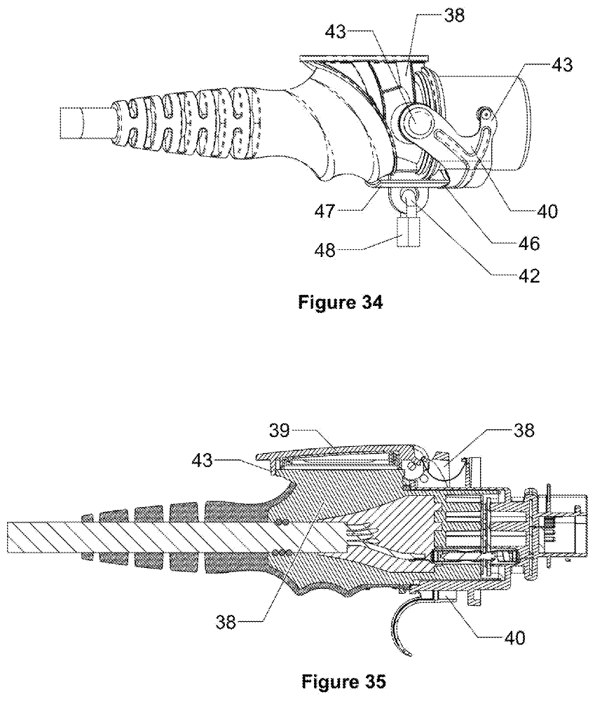

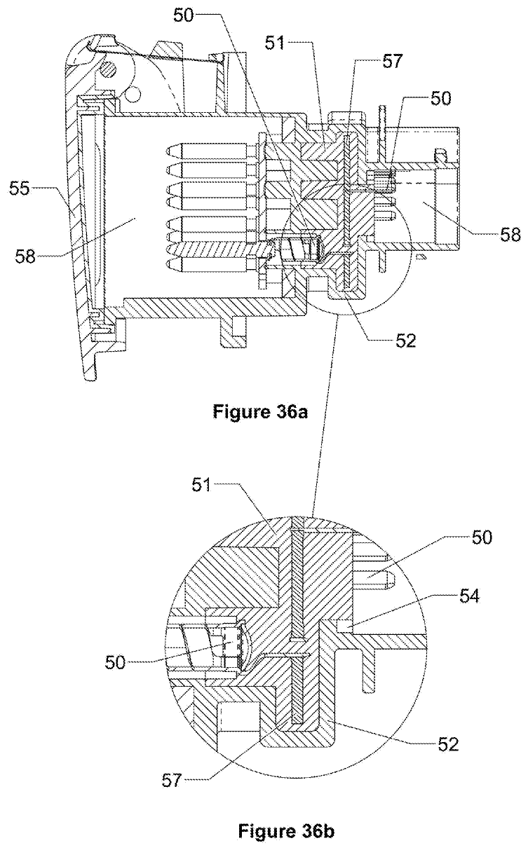

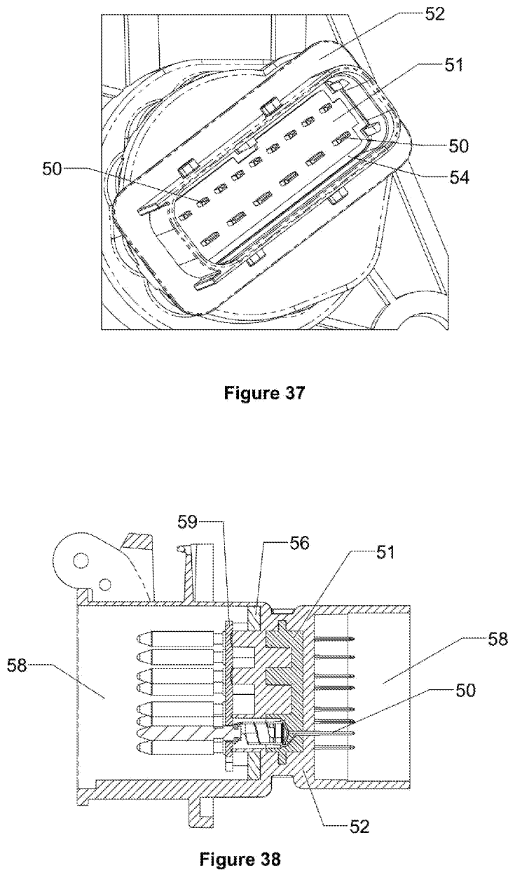

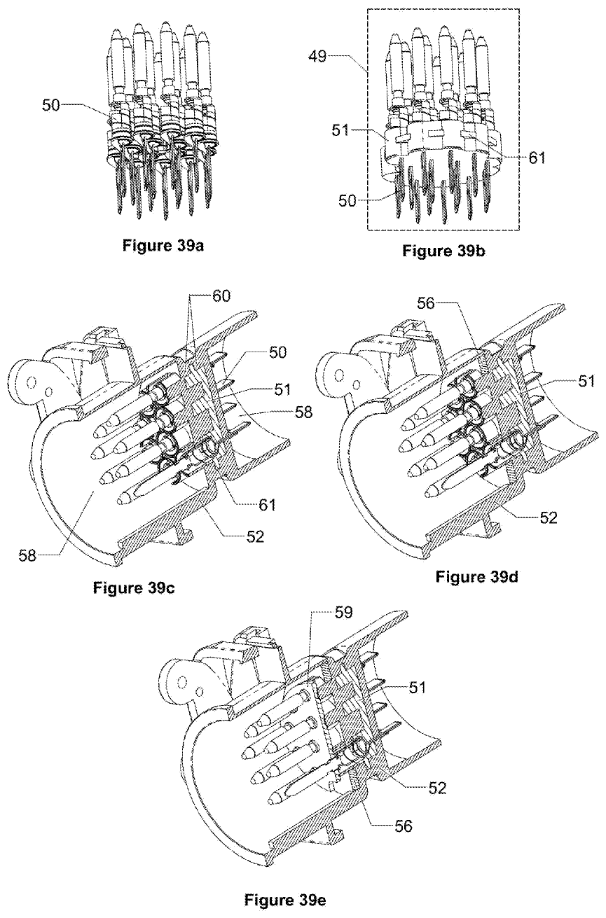

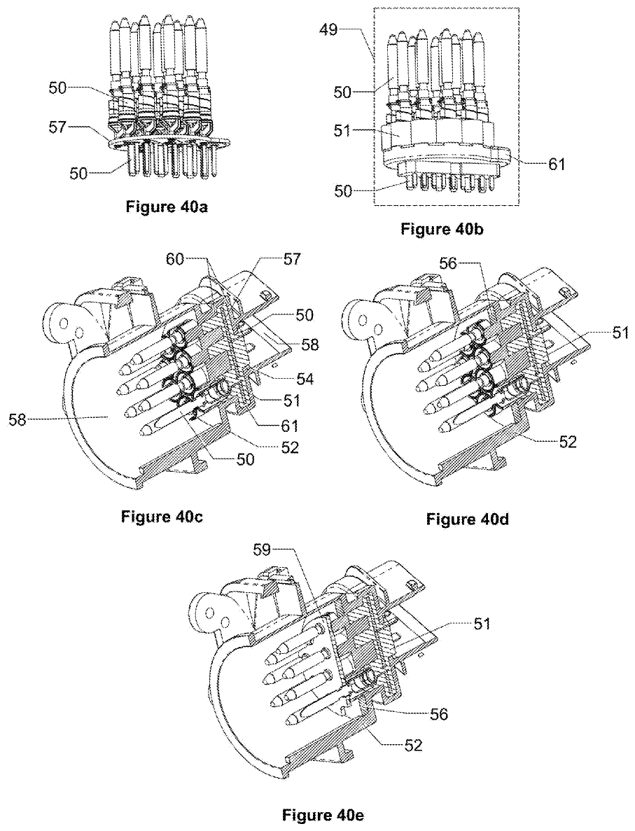

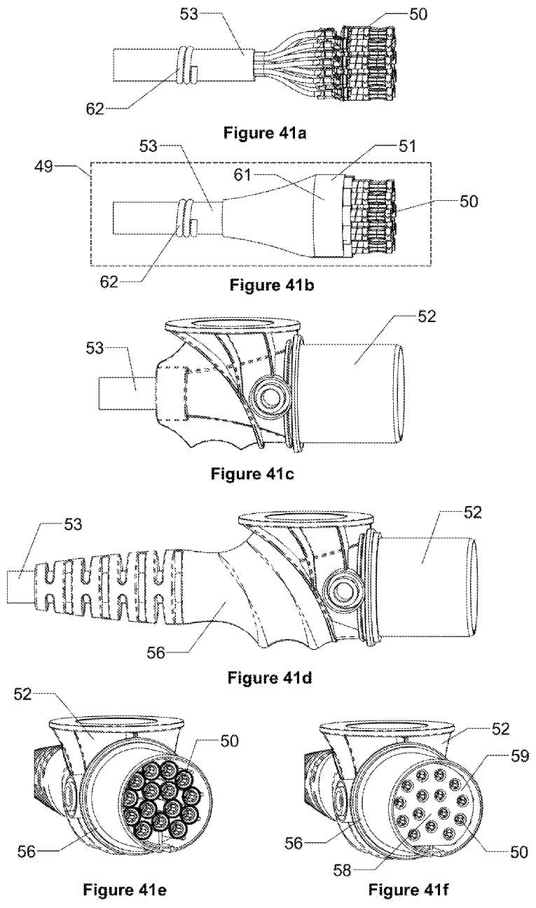

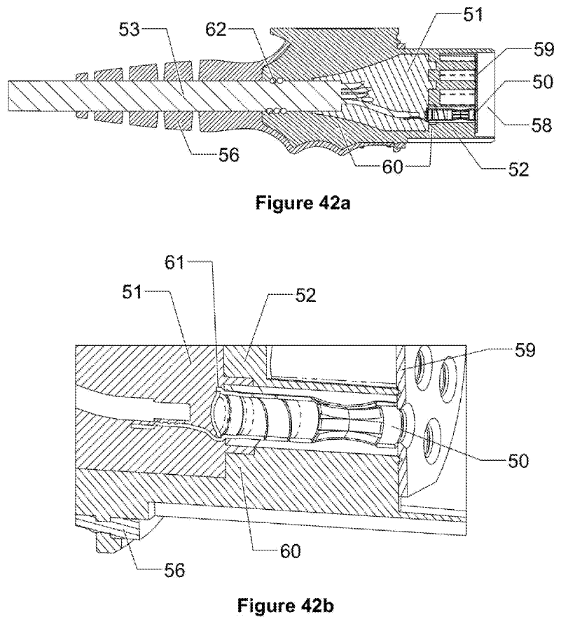

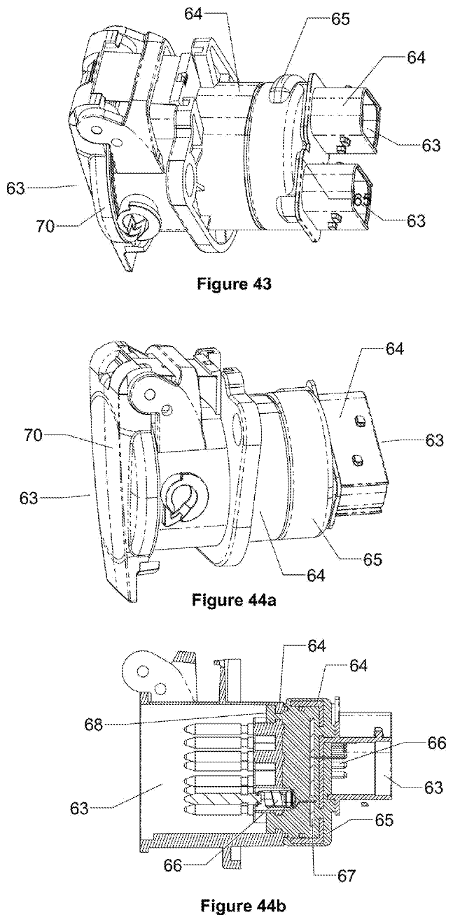

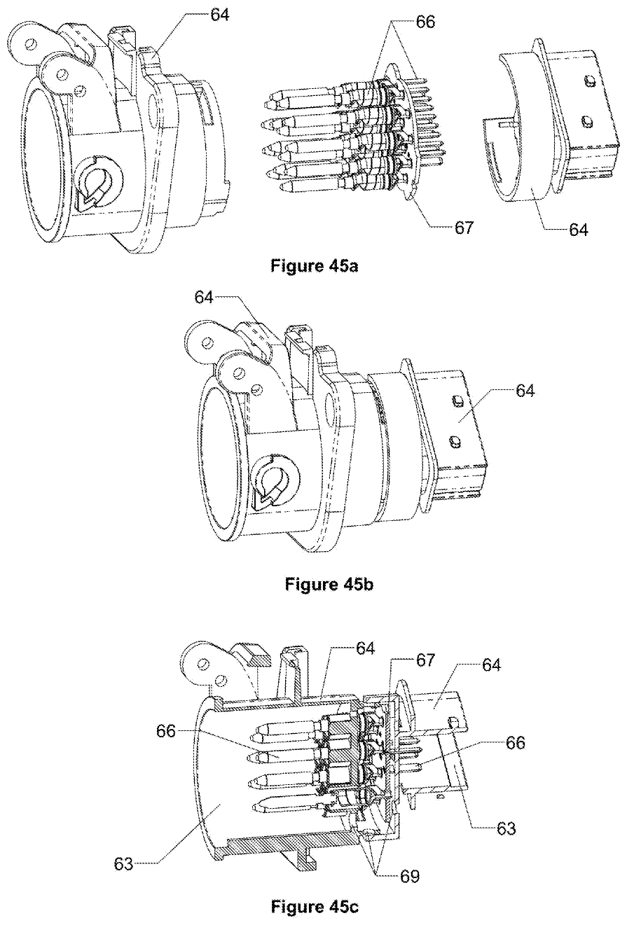

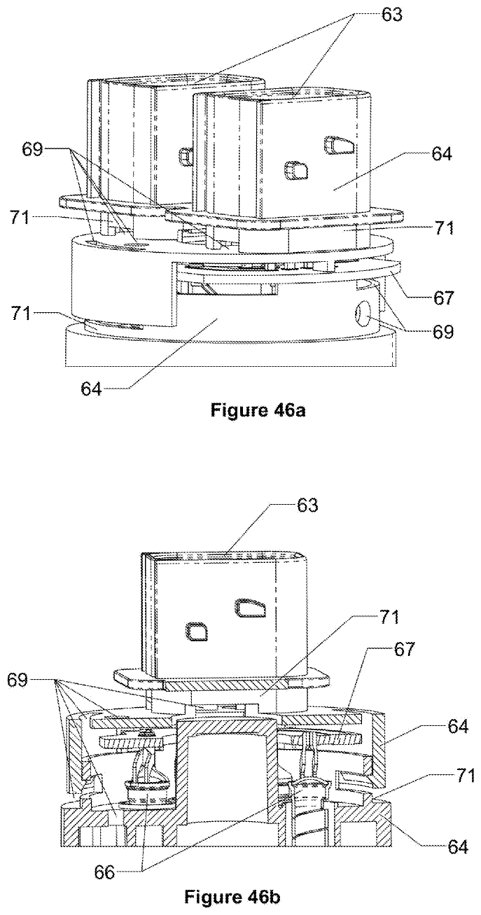

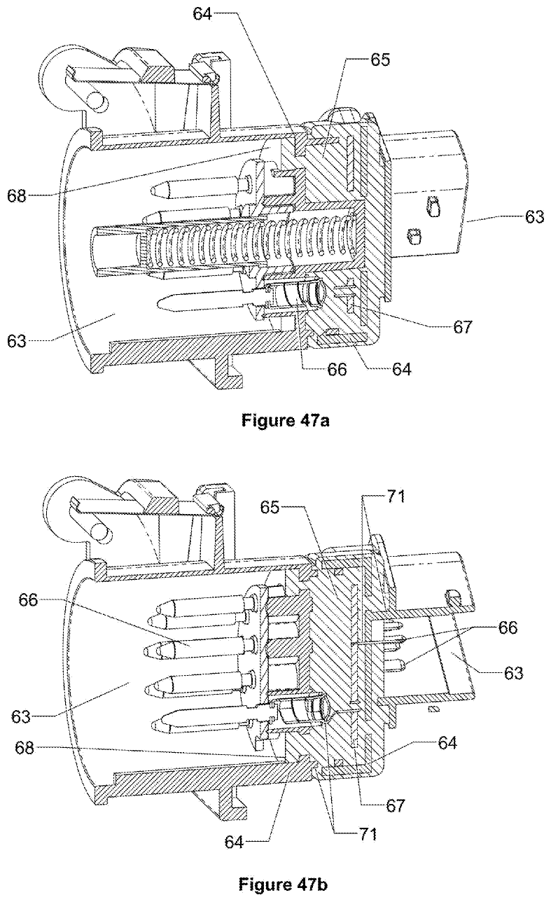

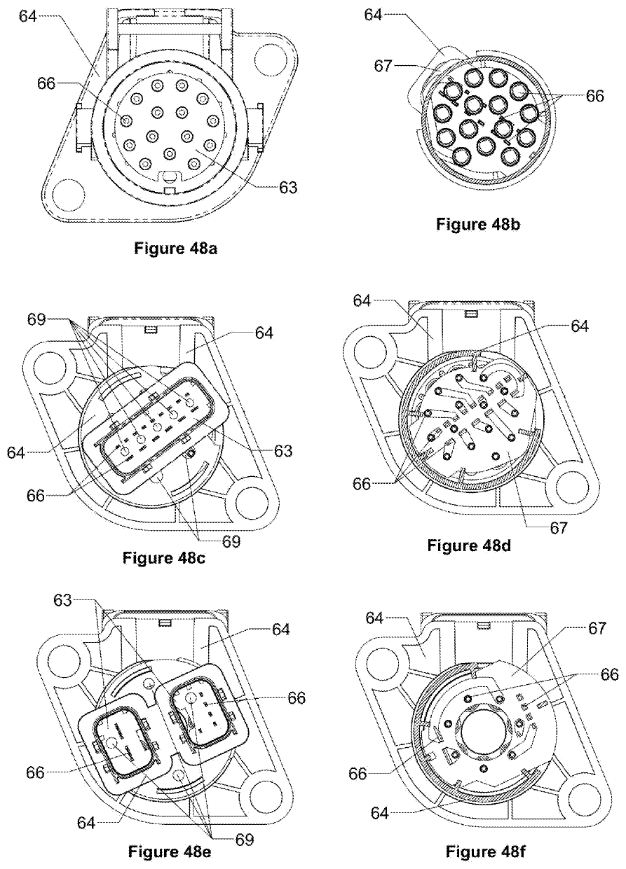

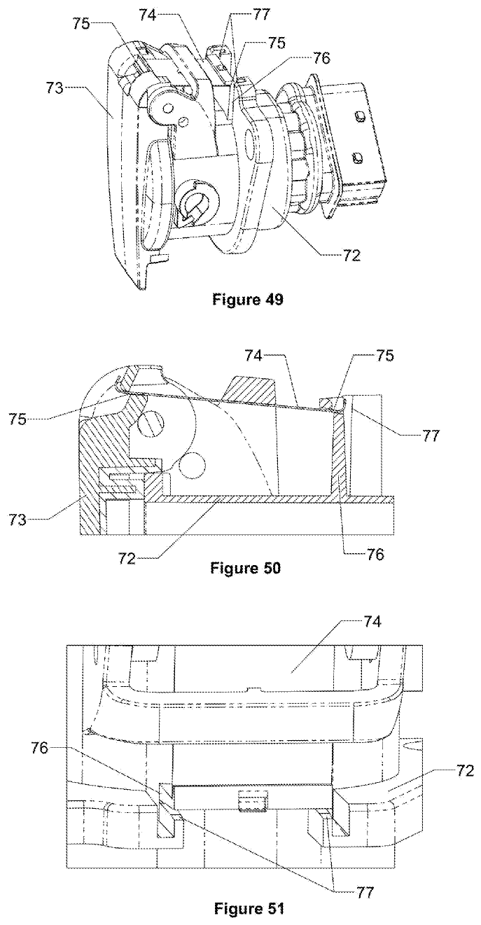

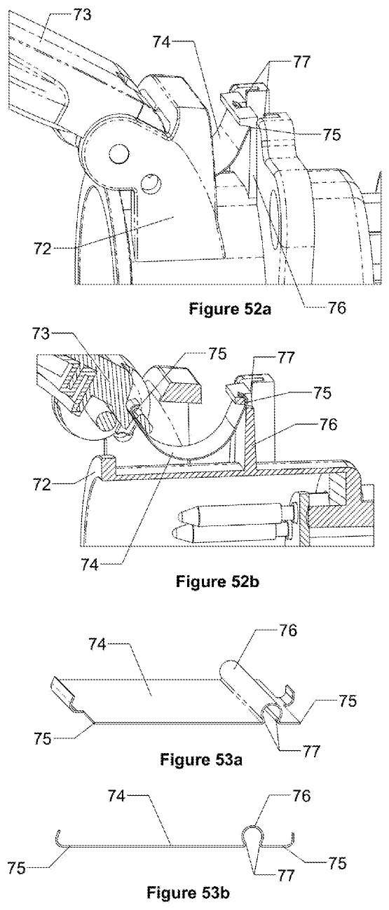

FIGS. 13a and 13b show the emergency disconnection function in cross-section. In FIG. 13a, the schematic plug (8) is inserted in the housing (1) of the socket connector and held in place by the cam-controlled locking mechanism (3) over the locking lever (7). FIG. 13b shows the result of pulling on the plug (8), in that the locking lever (7) has been forced open, the cam-controlled locking mechanism (3) has been back driven and, if applicable, the cover (2) has been closed by its spring-bias or other closing device. This shows a distinct advantage of the invention in that none of the parts have been damaged or are otherwise in need or replacement or resetting after a forced disconnection.

Another aspect of the present invention relates to rotational sealed covers for the protection of electrical contacts which can be pivoted about an axis to either a closed or open position, whereby the protective cover is biased toward the cover-closed position. An elastic sealing element is attached to either a fixed housing or to the rotational cover and this sealing element in incorporated or integrated with one or more elastic elements which act as springs or biasing elements for the closing of the rotational cover.

### PRIOR ART

Elastic seals are typically used to seal interfaces between parts, for instance in order to seal the rotational cover of an automotive electrical connector to a housing that is fixed to a vehicle in the cover-closed condition. For example, EP 1 544 955 A2 shows such a cover for automotive connecters which is biased by a steel helical leg spring towards the cover-closed position. This cover is equipped with an elastomer seal which deforms against a rim around the opening to the interior portion of the socket housing and forms a seal in order to protect an array of electrical contacts for environmental influences such as contamination and corrosion when the cover is closed.

Furthermore, elastic seals for rotatable covers are known from drinking containers, food storage containers and other household items such as pitchers.

The steel spring is installed about a cover pin and is generally hidden from view by additional plastic parts. The undercarriage of a car or truck is very prone to corrosion due do salts, moisture, physical damage to coatings and surface treatments, as well as oils and wide temperature fluctuations. Therefore, it is general practice to hide steel springs from view on a car, so that the customer will not readily see this unavoidable corrosion, which results in more parts being required in the end product as well as higher material and assembly costs.

U.S. Pat. No. 8,485,604 B2 shows a torsional elastomer spring for car seats, whereby the elastic material is enclosed by internal and external sleeves which contain non-turnable profiles such as tabs or a square-cut. In this case, the range of motion of the elastic material is limited, and the torsional assembly is used for dampening purposes at a desired seat setting rather than for providing a force over a large range of motion.

GB 954 379 A shows another application of elastomer springs in which an object is insulated from its surroundings by a set of elastic tension springs. As vibrations cause accelerations on the suspended mass, forces result which are compensated by the stretching of elastic members connecting the suspended mass to the carrying parts.

Another application of elastomer tension springs is USD 0 280 224 which shows a design for a resistance strap for an exercise machine. In this case, the stretching of a rubber strap takes the place of weights on an exercise machine, and in effect acts just like a standard tension spring to provide a higher force according to the deformation of the rubber part from its original shape.

### DESCRIPTION OF THE INVENTION

The invention generally relates to electrical connectors with a spring-biased protective cover in order to protect the electrical contacts of the connector from environmental influence. The object of the present invention is primarily a cost-saving measure to eliminate parts in mass-produced products. Further objects are to provide electrical connectors which may save space, provide additional functions to rotational protective covers, or improve the sealing function of a protective cover by increasing the closing force on the cover above what is typically achievable using standard springs.

The purpose of the proposed invention is to combine the functionality of an elastic cover seal for a rotational protective cover with the functionality of a biasing element which returns the protective cover to its closed position in order to reduce the total number of parts in a given assembly and thereby decrease the material and assembly costs of the product.

In an embodiment, the invention relates to an electrical connector with an integrated elastic part comprising a cover seal and one or more elastic elements for the sealing of the joint between a socket housing and a rotatable protective cover of the electrical connector when the rotatable protective cover is in the closed condition, wherein
the integrated elastic part is constructed out of an elastomer or rubber-like material and is integrated as a single part with the cover seal, which is attached to either the protective cover or the socket housing of the electrical connector, and
the integrated elastic element acts as a closing bias on the rotatable protective cover in at least one position of its movement.

The spring element of an electrical automotive socket with a biased rotational cover is often a weak point with respect to corrosion. The housing, protective cover, cover pin and structural parts can all usually be made of plastic, which cannot corrode under normal circumstances. The electrical contacts are protected from the elements by the sealed internal volume of the electrical connector; however, the cover spring is typically a helical torsion leg spring which is made of steel. Because the corrosive conditions are so extreme on the undercarriage of a car or truck, even stainless steel is susceptible to corrosion under the conditions such as road debris, moisture, snow or ice buildup, particle impact, salts, oils or the presence of other contaminants. Because the present invention eliminates the need for a steel biasing element, fewer different materials are required to be used for a given design and therefore an assembly can be made to be more resistant to a wider range of conditions or chemical exposures.

In some embodiments the integrated elastic part features multiple elastic elements.

In other embodiments the integrated elastic part is on-molded to either the rotatable protective cover or to the socket housing.

In a particularly useful embodiment, the line of action of the elastic element coincides with or overlaps the rotational axis of the cover pin or other rotational fixed geometry of the rotatable protective cover as the rotatable protective cover is being moved from the closed position to the open position such that an instable open position of the rotatable protective cover is created when the rotatable protective cover rests against a cover block. That is, the line of action of the tension in the elastic elements intersects with the rotational axis of the protective cover such that the moment arm is eliminated and the torque on the protective cover is reduced to zero.

This causes a stable or instable open condition on the protective cover when it rests upon a blocking geometry with another component of the assembly.

Alternatively, the line of action of the elastic element crosses over the rotational axis of the cover pin or other rotational fixed geometry of the rotatable protective cover as the rotatable protective cover is being moved from the closed position to the open position such that a stable open position of the rotatable protective cover is created when the rotatable protective cover rests against a cover block. In this case, the line of action of the tension in the elastic elements may cross over the rotational axis of the protective cover in order to balance out the weight of the cover which acts as a rotational moment in the cover-closing direction, whereby the tension force in the elastic elements would then be applied in the opposite direction, that is in the cover-opening direction. Depending on the location of the blocking surfaces, the invention could also be designed so that the cover-opening moment provided by the tension in the elastic elements is high enough to provide for a stable open condition of the protective cover if that is the goal of the particular execution of the invention.

In further embodiments, the line of action of the elastic element does not cross the rotational axis of the cover pin or other rotational fixed geometry of the rotatable protective cover as the rotatable protective cover is being moved from the closed position to the open position such that the rotatable protective cover closes immediately when released. Depending on the usage conditions, a protective cover that stays open may be undesirable due to the increased risk of contamination or extreme conditions such as marine applications, arctic environments or manufacturing or agricultural usages where the existence of airborne corrosive chemicals is expected. If the blocking location between the rotatable protective cover and the housing is constructed so that the maximum opening angle of the cover is reached before the line of action of the tension in the elastic elements crosses over the rotational axis of the protective cover, then the protective cover will close immediately upon release.

Consequently, all of the parts required for the assembly and fixation of a steel spring element can be eliminated by the integration of the cover seal and one or more elastic elements because the cover seal must be installed on the assembly in any case according to the state of the art. That is, if the cover seal is installed, then the integrated elastic element is at least partially installed as well. The cover seal and elastic elements can also be on-molded to either the protective cover, the housing, or both in the case of a static on-molded connection of both ends of the one or more elastic elements. That is, both the protective cover and the housing can be placed into a common injection tool, the cover seal and elastic elements can be molded onto both parts, and only in the assembled condition would the elastic elements be under tension.

Because the tension force resulting from the deformation of an elastic elastomer part is a function of the hardness of the elastic material, different biasing forces can be selected by altering the material hardness of the rubber or other rubber-like material; a range of hardnesses from 10 Shore A to 95 Shore A provides a multitude of different biasing forces. Changing the material hardness of the integrated cover seal and one or more elastic elements does not require a change to the injection tool, so for example different customers can receive different closing forces on the protective cover of their products without incurring additional tooling costs.

Because of the wide range of elastic materials available, the closing force on the cover can be set much higher than that of a steel spring. Additionally, material properties which are normally fixed for a given metal, such as the elastic modulus, which is practically the same for all steels regardless of the tensile strength, alloying or hardness selected, can be selected at will for an elastomer elastic element.

Preferably, the hardness of the integrated cover seal and elastic element is between 25 Shore A and 85 Shore A, more preferably between 40 Shore A and 75 Shore A. Materials in this range of harness are however not capable of transmitting a bending moment. That is, if one end of the elastic element were fixed, and the other end of a beam-like elastic element were bent downward, the bearing surfaces of the fixed end would not be loaded with a significant force because the geometry would have very little resistance to bending. This is important in the case of a nonlinear cover spring such as those known from the prior art in DE 20 2012 100 856 U1. In order to achieve a static yet instable cover-open condition, the springs or other elastic elements must not carry a bending moment, otherwise this bending moment would close the cover in the case of one of the ends of the springs or other elastic elements being fixed in place, as is the case at the interface between the seal portion and elastic element portion of the integrated cover seal and the one or more elastic elements.

In a particularly useful embodiment of the invention, one end of the integrated elastic element is attached to either the socket housing or the rotatable protective cover, that is, an integrated elastic part is utilized in conjunction with a sealing portion of the elastic part on either the socket housing or the cover, and although one end of the integrated cover seal and one or more elastic elements must be statically bonded out of necessity, the other end of the elastic element is attached to the other assembly part, that is the socket housing or cover which is not using the integrated elastic part as an assembled or bonded seal. An overmold of one or more sides of the integrated cover seal and one or more elastic elements is not required, that is, both sides of the combined part could be assembled.

The attachment of the end of the elastic element may be pinned, on-molded, trapped in a sleeve, press-fit, glued, welded by ultrasound or heat, screwed in place, hooked, or attached by any other fixed, rotatable or otherwise moveable means to the other assembly part, either the socket housing or protective cover, which is not using the integrated elastic part as an assembled or bonded seal.

It may be particularly advantageous if at least one end of the integrated elastic element is attached to either the socket housing or the rotatable protective cover such that this end of the elastic element is moveable in relation to the part on which it is mounted. Then the attached end of the elastic element is free to rotate, slide or otherwise move after being attached to either the protective cover or the housing because of the reduction in the transference of bending moments through the elastic element.

The integrated cover seal and one or more elastic elements may also be produced in more than one step, that is, in more than one overmold in order to produce an integrated part with more than one set of material properties such as a different hardness for the cover seal than for that of the elastic elements. Chemical, mechanical, heat or radiation treatments can also be used to alter the material properties of all or a portion of the integrated part.

### BRIEF DESCRIPTION OF THE DRAWINGS

While the invention is amenable to various modifications and alternative forms, specifics thereof are shown by way of example in the drawings and described in detail herein. It should be understood, however, that the intention is not to limit the invention to the particular embodiments described.

FIG. 14a shows an embodiment in a tilted side view.

FIG. 14b shows the embodiment of FIG. 14a in cross-sectional view.

FIGS. 15a and 15b show an embodiment tilted and from above in closed and open state.

FIGS. 16a and 16b show cross-sectional side views of an embodiment in closed and open state.

### DETAILED DESCRIPTION OF PREFERRED EMBODIMENTS

FIG. 14a shows the present invention tilted and from the side to show the location and one possible fixation of the elastic element (26). The protective cover (23) is shown in the closed position. Note that the elastic element (26) is positioned at a distance from the cover pin (27) such that a closing force acts over a moment arm to the cover pin (27), thus creating a torque upon the protective cover (23) which acts as a spring-like bias on the protective cover (23) in order to rotate it in the closing direction.

The end of the elastic element (26) has been hooked into a rotational bearing sleeve (28) such that a pre-tension exists in the stretched elastic element (26) and the end of the elastic element (26) is free to rotate with respect to the socket housing (25). This connection between the one or more elastic elements (27) and the housing (26) can also be achieved by any other static or moveable means.

FIG. 14b shows the same assembly as FIG. 14a with a cross-section through the elastic element (26). The interface between the cover seal (24) and the socket housing (25) is under a preloading force due to the torque applied to the protective cover (23) by the stretching of the elastic elements prior to their installation. It can be seen that the cover seal (24) and the elastic element (26) are executed as a single integrated elastic part (30) which has been overmolded onto the protective cover (23). In an alternative variant, the integrated elastic part (30) could be on-molded to the socket housing (25) and the elastic elements (27) attached to the protective cover (23) after being stretched to produce a pre-load on the protective cover (23) in the assembled, cover-closed condition.

FIGS. 15a and 15b show the present invention tilted and from above whereby FIG. 15a is in the cover-closed condition, and FIG. 15b is in the cover-open condition.

FIGS. 16a and 16b show the present invention from the side with a cross-section through the elastic element (26) whereby FIG. 16a is in the cover-closed condition, and FIG. 16b is in the cover-open condition. Notice that the elastic element (26) is longer in the cover-open condition indicating that the tension force has increased. This increase in deformation may be percentually higher than that of a standard steel spring, however due to the much lower elastic modulus of elastomer materials in comparison to metals, the resulting increase in mechanical stress and the resulting increase in tension force is much lower, that is the percentual increase in tension is much lower than that of a standard spring, meaning that the tension force in the cover-open condition is closer to the tension force in the cover closed position than that of a steel spring. This characteristic is advantageous because an increased closing force on the protective cover (23) in the cover-open position would lead to an increased risk of injury to the user.

In the cover-open condition, the eccentric connection point of the elastic element (26) to the protective cover (23) pulls the middle axis of the elastic element (26) over the cover pin (27) or other fixed rotational geometry. Thereby, the resulting moment arm is reduced to zero or almost zero and in turn no torque is applied to the protective cover (23) causing, in combination with a cover block (29), which limits the movement of the protective cover (23) to this position, a static yet instable condition of the opened protective cover (23), like what is achieved in similar systems known from the prior art. This characteristic is, however, not a necessity for the function of the present invention, and the attachment of the elastic element (26) and the opening angle of the protective cover (23) could be such that the spring tension is pulled to the other side of the cover pin (27) so that the protective cover (23) remains open in a stable condition or that the spring tension remains on one side of the cover pin (27) so the protective cover (23) closes immediately upon release.

Another aspect of the present invention relates to rotational sealed covers, used for the protection of electrical contacts inside of a connector housing, which can be pivoted about an axis to either a closed or open position, whereby the protective cover is biased toward the cover-closed position. Some types of cover exhibit additional functions such as non-linear closing-force profiles as a function of the opening angle of the cover, the presented invention consists of an installable or movable selector for the modification of cover functionalities.

### PRIOR ART

DE 20 2012 100 856 U1 shows a non-linear cover spring used to bias a rotatable protective cover for an electrical socket towards the cover-closed position. By means of an eccentric positioning of an axial compression or extension spring, the moment arm between the spring force and the rotational axis of the protective cover can be increased or decreased as a function of the angle between the protective cover and the socket housing. Typically, the resulting closing force on the cover is higher in the cover-closed position due to the moment arm between the spring force and the rotational axis of the cover being greatest in this location. As the cover opens, the moment arm between the spring force and the rotational axis of the cover decreases as a function of the opening angle of the cover. If this type of cover is not fully opened, it would return to the closed position automatically without showing any special delaying functionality. In the case of highly corrosive environments such as a farm, or extremely harsh environments such as arctic conditions or mines, the owners of said equipment might prefer the cover to close immediately in order to protect the electrical contacts in the interior volume of the connector at the expense of ease of use.

In DE 10 2011 051 107 B3, an eccentrically positioned flat spring provides a biasing force in the cover-closing direction. In order to move the cover of the electrical connector out of its closed position, the flat spring must first buckle, then a bending of the flat spring takes place as the cover opens and the distance between the bearing point on the housing and the bearing point on the cover get closer together. If the cover is opened far enough, the line of action of the spring lies upon the rotational axis of the cover causing an instable open condition, or the line of action of the spring crosses over the rotational axis of the cover creating a stable open condition of the cover. As with the previous example, if the cover were to be released before the inflection point over the rotational axis of the cover is reached, the cover would close immediately to its closed and locked position. Also in this case, some customers may see the improved sealing of said connectors due to the automatic locking function of cover as being degraded by the cover staying open during the connection cycle longer, or in case the user might leave the cover in the instable open position for a long period of time.

U.S. Pat. No. 4,036,396 A details a cover for junction boxes with a bent slot as a receptacle for a fixed cover pin upon which the cover can rotate. In the cover-open position, the cover can be pulled from one end of the bent slot to the other, this changes the loading conditions of the cover in such a way, that the cover is pulled towards a flat butting surface against the housing instead of being loaded in rotation alone and the cover remains therefore in an opened position until the positioning of the cover is moved so that the rotational axis of the cover is back in the other position of the bent slot and the butting surfaces of the cover and housing can no longer contact each other. As with the previous examples, the decision to leave the cover open or closed when it is not being held open is in the hands of the user. In case the owner of the device wants the cover to close immediately, the owner must rely on the user not to bring the cover into its locking position. In the case of an irresponsible or disobedient user, the wishes of the owner of the device may not be carried out.

In general, the state of the art for biased protective covers of electrical connectors or junction boxes fall into three general categories: Protective covers which close immediately upon release, protective covers which stay open in a static yet instable condition upon release, and protective covers which stay open in a stable condition upon release.

Hence, the object of the present invention has been to provide a more versatile device with improved functionality.

### DESCRIPTION OF THE INVENTION

The invention generally relates to, but is not limited to, electrical connectors with a spring-biased protective cover in order to protect the electrical contacts of the connector from environmental influence. The described invention limits the opening angles of protective covers in order to select certain cover functionalities according to the needs or wishes of the user, purchaser or owner of the device.

The purpose of the currently presented invention is to select or limit the functionality of a self-closing rotatable protective cover for electrical connectors, either by the user or owner of the device, and in such a way that the selection can be either temporary or permanent depending on the wishes of the appropriate decision maker. As previously stated, there are three types of functionalities in the state of the art regarding biased protective covers of electrical connectors or junction boxes. The goal of the currently presented invention is allow the decision as to which type of cover functionality is to be used, to be made at lower levels in the supply chain, or to be made by the owner or user, instead of by distributors or original equipment manufacturers. This allows the same product to be supplied to multiple customers with different demands regarding functionality of the cover, which ultimately increases quantities of the same product and lowers production costs for the common product.

According to an embodiment, the invention relates to an electrical connector with a socket housing and a rotatable protective cover wherein the position of a sliding function selector, a rotary function selector or an installable function selector alters the blocking angle of the protective cover in an open position, and in combination with a compression or tension cover spring having two constrained ends, which by means of its geometry and constraint conditions, can only transmit a tension or compressive force along a line of action passing through both constrained ends of the cover spring, the cover spring however not being able to transmit bending moments, the functionality of the protective cover is altered, such that depending on the positon of the movable or installable function selector, when the opening force on the protective cover is removed and the protective cover is in its open blocking position, the protective cover either a.) closes immediately if the cover spring line of action has not yet reached the rotational cover axis as the protective cover was rotated to its maximum opening angle, b.) remains in a stable open condition if the cover spring line of action has crossed over the rotational cover axis as the protective cover was rotated to its maximum opening angle, c.) remains open in an instable open condition such that a vibration or small external force causes the protective cover to close immediately, if the cover spring line of action is coincident with, or has exceeded, the rotational cover axis as the protective cover was rotated to its maximum opening angle. This allows the same end product to be able to perform all three types of spring functionalities, which in turn increases product quantities and lowers production and tooling costs.

In an additional embodiment of the invention, the compression cover spring is a flat-spring which due to its shape and constraint conditions, must first buckle in order to allow the rotatable protective cover to rotate out of a cover-closed position. The selector device can be used in conjunction with a flat buckling spring, as is known from the state of the art, which provides a very high locking force in the cover-closed position, and whereby the closing force can be reduced to zero depending on the opening angle and the structure of the parts. By limiting or allowing a further range of motion of the cover, cover functionalities such as delays or static conditions can be included or excluded in the specifications of a product in combination with the locking effect of the buckling spring in the cover-closed position.

The position of the function selector may be secured with a selector snap. Depending on the type of selector being used for the assembly, an especially advantageous execution of the invention is by selecting the position of a moveable blocking part and the position of said selection part being secured by a snapping device. This has the advantage or the selector being an integral part of the assembly and can therefore not become lost or misplaced if the decision maker chooses to change the functionality of the product at a later time.

Additionally, the selector can be recessed or positioned in such a way that it is not readily visible or requires a special tool to be moved from one setting to another. This is advantageous if the decision to change the selection of cover functionalities should be excluded or prohibited to certain personnel.

In an especially robust embodiment of the invention, a sliding function selector moves in translation, the sliding function selector being installed in either the protective cover the socket housing, or a separate part, features one or more transient blocking surfaces which either align or misalign with transient blocking surfaces and/or cover blocks on the protective cover or socket housing depending on the position of the sliding function selector. A sliding element positioned between the cover and the housing or placed in another location which can impede the movement of the cover is installed in a non-losable condition, however it can be moved over two or more positions such that a pair of blocking surfaces between the cover or housing and the sliding element are either aligned or misaligned. That is, the cover can either rotate past the pair of blocking surfaces if the blocking surfaces are not aligned, or the movement of the cover causes the blocking surfaces to collide, which in turn impedes the rotation of the cover, if the blocking surfaces are aligned. This concept can be used to select more than two maximum opening angles of the cover if desired. Whereby a snapping geometry ensures that the position of the selector does not change through bumps or vibrations.

In a particularly compact embodiment of the invention a rotary function selector has a rotational movement with variable blocking surfaces for the rotational function selector, being installed in either the protective cover, the socket housing, or a separate part, and features one or more transient blocking surfaces which either align or misalign with transient blocking surfaces and/or cover blocks on the protective cover or socket housing depending on the position of the rotary function selector. This type of selector can be trapped in its bearing geometry by the assembly of the other parts and is therefore non-losable. By rotating the selector from one position to another, blocking surfaces between the cover or housing and the selector are either aligned or misaligned, which either blocks or allows a further movement of the cover respectively. Snapping geometry ensures that the position of the selector does not change through bumps or vibrations. This type of selector can be executed in a very small space and can be placed in a slot or depression so that it is only accessible with a standard or special tool.

In a more permanent embodiment an installable function selector is a separate part, which by means of its permanent or temporary installation on the protective cover or the socket housing, or a separate part, features one or more transient blocking surfaces, whereby the presence of the installable function selector reduces the allowable opening angle of the rotatable protective cover. The rotational range of the cover is limited by a separate installed part, whereby the installation can be either temporary or permanent. The installed part can either be attached to the outside of the cover or housing in an obvious manner, such as being made of a different colored material so that the installation is readily apparent, or be a small part which blends in to the surrounding geometry in case an unauthorized user my try to detach it. By the use of glue, riveting, one-way snaps or a security screw which requires a special tool, the installed part can be made to be non-removable. A particularly economical execution of this variant is a pin in a bore which causes a blocking of the rotation of the cover. The pin could be removed with a punch if the execution includes a through hole, however if the pin is inserted into a blind hole and the end of the pin does not protrude from the bore of the receptacle, the blocking pin will be non-removable. In an alternative form, the pin can be placed in a through hole, and the decision maker for the function of the cover can either choose to glue or deform the pin in place or not.

In the most permanent execution of the invention the function selector consists of geometry on the protective cover or socket housing, incorporating at least one transient blocking surface for the protective cover or socket housing, which can be broken off in order to remove the transient blocking surface allowing a larger maximum opening angle of the protective cover, thus altering the function of the protective cover. This means integrating the transient blocking surface which limits the rotation of the cover with one of the connector parts, such as the cover or the housing. A pre-determined breaking point on the blocking surface allows the decision maker to either detach the blocking geometry or leave it on the assembly. This blocking geometry may also be placed in a recessed or otherwise inconspicuous location, so the removable geometry is not readily apparent or requires a special tool to be removed.

### BRIEF DESCRIPTION OF THE DRAWINGS

While the invention is amenable to various modifications and alternative forms, specifics thereof are shown by way of example in the drawings and described in detail herein. It should be understood, however, that the intention is not to limit the invention to the particular embodiments described.

FIGS. 17a through 17c show an embodiment in different perspective views.

FIGS. 18a through 18c show the function of a sliding function selector according to the variant shown in FIG. 17a in detail.

FIGS. 19a and 19b show the variant from FIG. 17a from the side and in cross-section view with the cover in the fully open position.

FIGS. 20a and 20b show the assembly from FIG. 19a in the cover-open condition.

FIGS. 21a and 21b show the invention in the variant from FIG. 17b at an angle from behind in engaged and disengaged position.

FIG. 22 shows the assembly from FIG. 21b in cross-section.

FIGS. 23a through 24b and show the interactions of the protective cover and the rotary function selector in engaged and disengaged position.

FIGS. 25a and 25b show the invention according to the variant shown in FIG. 17c from the side.

FIGS. 26a and 26b show the embodiment of the invention according to FIG. 17c.

FIGS. 27a and 27b show a particularly simple embodiment.

FIGS. 28a and 28b show the interactions of the protective cover and the installed function selector.

FIGS. 29a and 29b show the interactions of the protective cover (23) and the installed function selector.

### DETAILED DESCRIPTION OF PREFERRED EMBODIMENTS

FIGS. 17a through 17c show an array of variants to the present invention, whereby all variants shown are equipped with a non-linear cover spring (11) as known from the prior art which can produce a stable or instable static condition when the cover is fully opened to the cover block (21) between the protective cover (23) and the socket housing (25).

In FIG. 17a, the assembly is shown tilted from the rear in order to make the sliding function selector (32) visible. In this case, the sliding function selector (32) is slid into a receptacle in the socket housing (25) until the installation snap (36) is depressed and interlocks with the socket housing (25) in the installed position. The sliding function selector (32) is then movable to a blocking engaged position or a non-blocking disengaged position. A selector snap (35) keeps the sliding function selector (32) in the chosen position and prevents the sliding function selector (32) from moving as a result of bumps or vibrations. When the sliding function selector (32) is in the non-blocking position, the transient blocking surfaces (31) of the function selector (32) and the blocking assembly part, that is either the socket housing (25) or the protective cover (23), are not aligned and therefore do not collide with each other as the protective cover (23) is opened and the range of motion of the protective cover (23) is either not limited or limited by a set of permanent cover blocks (21).

The non-linear cover spring (11) is executed as a single wire, bent around the front side of the protective cover (23) such that a single bent part can load the protective cover (23) from both sides in order to produce a more even load on the cover and in order to prevent bending of the assembly parts or non-compressed regions of the cover seal (24) due to a force being applied to one side of the cover only.

In FIG. 17b, a variant of the invention equipped with a rotary function selector (33) is shown tilted and from the side. The protective cover (23) is in the closed position, and the cover spring (11) is executed as a compression spring about a collapsible shaft which is eccentrically executed such that the moment arm between the rotational cover axis (10) and the line of action of the cover spring (11) reduces as the cover is opened, lower the closing force on the cover as a function of the opening angle between the protective cover (23) and the socket housing (25). The rotary function selector (33) is shown in the engaged position, that is, it is turned so that the transient blocking surface (31) of the rotary function selector (33) is aligned with the transient blocking surface (31) of the protective cover (23), which in this case is also the same geometry of the cover block (21) on the protective cover (23). Therefore, in the shown configuration, the rotation of the protective cover (23) is limited by the rotary function selector (33) such that the cover is not able to achieve its stable or instable open position and would therefore close immediately upon release.

FIG. 17c shows an embodiment in which an installed function selector (36) is assembled to the socket housing (25) in a manner which positions a transient blocking surface (31) in the path of the cover block (21) or transient blocking surface (31) of the socket cover (25), thereby limiting the rotation of the protective cover (23) and reducing its maximum opening angle as long as the installed function selector (36) is assembled with the rest of the product. The installed function selector (36) could of course be installed on the protective cover (23) as well, in which case it would collide with a transient blocking surface (31) or cover block (21) on the socket housing (25).

FIGS. 18a through 18c show the function of a sliding function selector (32) according to the variant shown in FIG. 17a in detail.

In FIG. 18a, the sliding function selector (32) is shown in the disengaged position, meaning that the transient blocking surfaces (31) of the protective cover (25) and the transient blocking surfaces (31) of the sliding function selector (32) are not aligned, and therefore would permit a complete opening of the protective cover (25) to its maximum opening angle. The sliding function selector (32) is held in place by the selector snap (35) which in this case is executed as a deformable tab on the sliding function selector (32) which cannot pass by the geometry of the socket housing unless enough force is applied in the sliding direction to depress the tab of the selector snap (35).

In FIG. 18b, the sliding function selector (32) is shown in the engaged position, meaning that the transient blocking surfaces (31) of the protective cover (25) and the transient blocking surfaces (31) of the sliding function selector (32) are aligned with each other, and therefore would collide during the opening of the protective cover (25) thereby limiting its opening angle. The sliding function selector (32) is held in place by the selector snap (35) which in this case is executed as a deformable tab on the sliding function selector (32) which cannot pass by the geometry of the socket housing unless enough force is applied in the sliding direction to depress the tab of the selector snap (35). Notice that in comparison to FIG. 18a, the selector snap (35) is on the other side of the socket housing geometry.

FIG. 18c shows the same assembly and viewpoint as FIG. 18a, however a cross-section is cut through the sliding function selector (32) in order to show the geometry which limits is movement and use. The sliding function selector (32) is installed into the socket housing from the right side as shown in FIG. 18c. During its insertion, the installation snap (36) is automatically depressed and then released once the installation is complete. A selector block (37) on the end of the sliding function selector (32) which was inserted first prevents the sliding function selector (32) from being pushed all the way out the other side of the socket housing (25) and a selector block (37) on the installation snap (36) prevents the sliding function selector (32) from being removed after assembly. This provides the sliding function selector (32) with a non-losable installation, and the function of the protective cover (23) can be changed at any time by moving the sliding function selector (32) from one position to the other. Note that the ends of the sliding function selector (32) are recessed in both positions, this provides a usage condition which requires a tool in order to move the sliding function selector (32) from one position to the other, however this access window could be made small and inconspicuous such as a pin hole, that would not be readily noticeable or accessible without special tools. In another variant, the ends of the sliding function selector (32) could protrude from the socket housing (25) so that the sliding function selector (32) could be moved by hand without tools.

FIG. 19a shows the variant from FIG. 17a for the side with the cover in the fully open position.

The protective cover (23) has collided with the cover block (21) of the socket housing (25) in order to reach a stable or instable static open condition.

This assembly is shown in FIG. 19b with a cross-section through the transient blocking surface (31) of the protective cover (23). It can be seen that the sliding function selector (32) is shaped with a cut or material reduction which allows the transient blocking surface (31) of the protective cover (23) to rotate without colliding with any geometry.

FIG. 20a shows the assembly from FIG. 19a in the cover-open condition, whereby the sliding function selector (32) is in the engaged position and the rotation of the protective cover (23) has been limited such that it will close automatically upon release. The cover spring (11) is not shown.

This assembly is shown in FIG. 20b with a cross-section through the transient blocking surface (31) of the protective cover (23). Note that the transient blocking surface (31) of the protective cover (23) has collided with the transient blocking surface (31) of the sliding function selector (32), thereby limiting the rotation and maximum opening angle of the protective cover (23).

FIG. 21a shows the invention in the variant from FIG. 17b at an angle from behind with the rotary function selector (33) in the engaged position. It can be seen that the transient blocking surface (31) of the rotary function selector (33) is aligned with the transient blocking surface (31) of the protective cover (23) and would thus limit the movement of the protective cover (23) in this configuration. The rotary function selector (33) is not accessible by hand as it is depressed in a crack between the parts of the assembly and must be turned from one position to the other with a tool. The rotary function selector (33) could also be equipped with a tab that would allow the selection of the functionalities of the protective cover (23) by hand. An integrated selector snap (35) in the form of a deflectable geometry prevents the unwanted turning of the rotary function selector (33) by interacting with a set of two or more depressions in the rotary function selector (33).

FIG. 21b shows the assembly from FIG. 21a with the rotary function selector (33) in the disengaged position. In this case, the transient blocking surface (31) of the rotary function selector (33) is no longer aligned with the transient blocking surface (31) of the protective cover (23), and the protective cover (23) is free to open until the angle at which the cover blocks (21) collide allowing the function of the stable or instable cover-open conditions.

FIG. 22 shows the assembly from FIG. 21b in cross-section to shown that the rotary function selector (33) is in a non-losable condition by means of the assembly of the protective cover (23) with the socket housing (25).

FIGS. 23a and 23b show the interactions of the protective cover (23) and the rotary function selector (33) in the cover-opened, rotary function selector (33) disengaged conditions.

FIGS. 24a and 24b shown the interactions of the protective cover (23) and the rotary function selector (33) in the cover-opened, rotary function selector (33) engaged conditions.

FIGS. 25a and 25b show the invention according to the variant shown in FIG. 17c from the side, whereby FIG. 25b is in the pre-assembled condition. In the displayed variant, the installed function selector (34) is fixated with a pin, however this could be achieved by any temporary or permanent means such as a rivet, glue or a screw.

FIGS. 26a and 26b show the embodiment of the invention according to FIG. 17c, however in FIG. 26a the installed function selector (34) has not been assembled or implemented, and in FIG. 26b is being used. Note the difference in the opening angles of the protective covers (23) depending on whether or not the installed function selector (34) is in use.

FIGS. 27a and 27b show a particularly simple embodiment of the invention in which the installed function selector (34) is a pin. FIG. 27b shows the installed function selector (34) before it has been assembled. By means of a through hole, the installed function selector (34) can be removed at will using a tool. If however the installed function selector (34) is inserted into a blind hole or glued in place, it is no longer removable. Installed function selectors (34) also have the advantage, that in case a customer does not wish to have the ability to select the functionalities of the protective cover (23), they can choose to order the assembly without the installed function selector (34) and thereby would not incur any additional costs.

FIGS. 28a and 28b show the interactions of the protective cover (23) and the installed function selector (34) in the same embodiment from FIGS. 27a and 27b in the cover-opened, installed function selector (34) assembled conditions. Note that the transient blocking surfaces of the protective cover (23) collide with the installed function selector (34).

FIGS. 29a and 29b show the interactions of the protective cover (23) and the installed function selector (34) in the same embodiment from FIGS. 27a and 27b in the cover-opened, installed function selector (34) unused condition. Note that the transient blocking surfaces of the protective cover (23) are not impeded by the installed function selector (34) and protrude into the space which would be occupied by the installed function selector (34) if it had been assembled.

Another aspect of the present invention relates to anti-theft devices for electrical connectors. The electrical connections between a towing vehicle and its trailer are almost always stowed on the outside of the two vehicles, for example exposed under the bumper on a car or behind the cabin of a semi-trailer truck. This allows for the tampering or sabotage of connections, or in the case of extension cables which are connected at both ends with an electrical connector, the theft of the entire connector cable.

### PRIOR ART

U.S. Pat. No. 7,160,137 B1 shows a connector for the electrical connection of electronic equipment. A pair of depressible hooks on the end of a lever-like structure interlock with windows or cuts in the mating component, whereby a blocking system prevents the depression of the lever-like structure if an anti-theft system such as a combination lock or integrated key-operated lock, or fingerprint reading device is engaged.

In U.S. Pat. No. 8,025,526 B1, a locking holster for a charging plug is shown. The holster locks the charging plug in place unless power is being supplied to the plug such that an electronic unit such as a charging station for electric cars must first release the plug, in order for it to be removed from the holster. This prevents tampering or misuse of the connector and cable unless the user of the connector has been verified as an authorized user of the equipment.

As shown in U.S. Pat. No. 8,016,604 B2, a locking device which prevents the depression of a button is also known to the state of the art. In this device, the position of a locking aperture or coded device blocks or releases a depressible thumb button which in turn allows the release of a charging plug from its receptacle. The locking device may also be activated be the ignition of a charging vehicle or other electronic means.

JP 3911142 B2 shows an electrical connector equipped with a locking lever, whereby the locking lever interacts with a snapping geometry on one of the connector sides in order to prevent an unwanted disconnection of the electrical connection.

ISO 12098:2004-02 describes a standardized connection system for semi-trailer trucks which features a rotatable locking lever with a roller, which is pressed over a bearing surface on the opposite connection side. This ensures that the connection does not accidentally separate, and compresses seals in order to provide an improved waterproofing of the connected system.

U.S. Pat. No. 4,036,396 A shows a cover for an electrical junction box whereby the housing and the rotatable cover are equipped with aligned holes in the cover-closed condition, such that a padlock can be passed through the aligned holes and locked in place in order to limit access to the junction box.

### DESCRIPTION OF THE INVENTION

The invention generally relates to electrical connectors with a rotatable locking lever such as those known from the ISO 12098:2004-02 connection system. The present invention prevents the theft of connection cables, tampering, and limits the unlocking of electrical connections by unauthorized personal securely and more economically than the state of the art. Additionally, removal of the anti-theft system renders the connection system useless.

According to an embodiment the invention relates to an electrical connector with a housing, a rotatable cover and/or a moveable locking device, wherein the connector is equipped with an anti-theft device such that the movement of the rotatable cover and/or moveable locking device can be impeded by a movable or removable blocking part which interlocks with the rotatable cover and/or moveable locking device such that a disconnection of an electrical connector pair is not possible when the anti-theft device is engaged.

A further embodiment of the invention features an electrical connector, wherein the moveable locking device is a rotatable clevis, a rotational bayonet ring, a sliding bayonet device, or a threaded locking collar. In some cases, the moveable locking device is an integral part of the connection system, and the removal or damage of this component will either prevent the connection system from being connected, or prevent the looking of said connection system, which would in turn drastically degrade the performance of the connection system which was tampered with.

In a particularly economical execution of the present invention, the movable blocking part is a detachable or non-losable screw having a standard or special driving profile. This screw can be installed in either the moveable locking device or the rotatable protective cover or housing of an electrical connector to lock the movement of the moveable locking device or the rotatable protective cover. When implemented in combination with a connection system whereby the locking system between the two connector halves relies on a hook or undercut on the socket cover keeping the plug in the inserted position, a locking position of the cover in this interlocked position is particularly useful for ensuring that the connection pair is not disengaged. While rotational protective covers for electrical sockets which lock in the closed position are known from the state of the art, for instance U.S. Pat. No. 4,036,396 A, rotational protective covers which provide a means for locking in an open position or partly opened position in order to secure an interlocked condition of a connector pair are not.

Another embodiment of the invention is an electrical connector, wherein a blocking surface maintains a non-engaged position of the movable blocking part as a screw over the entire range of motion of the rotatable cover and/or a moveable locking device in order to prevent a blockage of the movement of the rotatable cover and/or a moveable locking device. The blocking surface is particularly important in order to ensure the unrestricted and unencumbered movement of the locking device when the moveable blocking part is not engaged. Especially in the case of the moving blocking part being a simple geometry such as a security screw or other similar part which is trapped under a range of motion such that it is non-losable, however its position remains undefined in the non-locked condition. The rattling and or unintended movement of the moveable blocking part must not be permitted to prevent or inhibit the movement of the moveable locking device otherwise the function of the system would be prevented, or the ease of handling of the connection system would be greatly degraded because the user would need to ensure the position of the moveable blocking part during the employment of the moveable locking device.

Another advantageous embodiment of the invention consists of an electrical connector, wherein a spring maintains the non-engaged position of the movable blocking part as a screw over the entire range of motion of the rotatable cover and/or a moveable locking device in order to prevent a blockage of the movement of the rotatable cover and/or a moveable locking device. This configuration also prevents the moveable blocking part from preventing the operation of the moveable locking device by applying a biasing force to the moveable blocking part which pushes it away from its engaged position such that it does not collide with the geometry for its fixation in the engaged position, or any other geometry as the moveable locking device is brought from its unlocked to its locked position.

Another embodiment of the invention comprises an electrical connector wherein the movable blocking part is activated by a lock which is integrated in the housing by means of assembly, press-fitting, overmolding or other permanent means. An integrated lock has the advantage that it is non-losable and difficult to remove without destroying the connector. Additionally, the owner of the cable or vehicle can determine who is able to remove the cable, therefore in the case of for instance a cable according to ISO 12098:2004-02 in which both ends of the cable are equipped with a connector, the vehicle side of the connector could be locked, while the trailer side of the connector remains unlocked. This configuration has the advantage that the driver of the truck or user of the device can connect the cable to multiple trailers using an unlocked cable end, but the towing vehicle side of the cable can be locked by the owner to prevent theft or in order to prevent the driver from forgetting the cable on a trailer, which might possible be towed away by another truck or belong to a different entity, company or person.

A particularly economical embodiment of the invention comprises an electrical connector, wherein the movable blocking part is a hasp, the movement of which interlocks with a stationary eyelet, and the movement of the hasp can be impeded by the attachment of a padlock of any type. While padlocks are cumbersome and prone to loss, they have the advantage that in an emergency situation such as lost keys, they can be cut away using standard tools.

A particularly robust execution of the present invention comprises an electrical connector wherein the movable blocking part is positioned between the interlocking geometry of the connector halves and the rotational axis of the rotatable cover and/or a moveable locking device such that a violent removal of the movable blocking part results in a functional degradation, destruction, or non-usability of the rotatable cover and/or a moveable locking device. For instance, in the case of a rotatable clevis such as the locking lever of the ISO 12098:2004-02 system, a security screw or other movable blocking part can be installed on the moveable locking device, in this case the locking lever of the connection system, between the rotational axis of the locking lever and the undercutting geometry of the locking lever in a manner that if the moveable blocking part is cut away, the locking lever will also be cut into more than one piece, rendering it unusable.

In a further embodiment comprises an electrical connector wherein the movable blocking part is a detachable or non-losable nut having a standard or special driving profile which interacts with a threaded or bayonet like stud which is fixed to the housing, protective cover, or moveable locking device. Depending on the geometry and motion of the parts which should be locked with each other in order to ensure that the connected condition is preserved, a special or normal nut may be more advantageous than a screw, whereby the removal of the nut could optionally be limited by a special driving profile of an uncommon or specially constructed tool.

Another embodiment of the present invention is an electrical connector wherein the nut interacts with a countersink or depression in order to prevent the movement of the rotatable cover and/or a moveable locking device, as the countersink or other blocking geometry would prevent the stud on which the nut is secured from being cut off or the special nut from being gripped by pliers or another grasping tool.

A further embodiment comprises an electrical connector the movable blocking part is spring-loaded to an engaged position such that the anti-theft device engages whenever the rotatable cover and/or a moveable locking device is moved to the engaged position, and a disengagement of the anti-theft device is required in order to move the rotatable cover and/or a moveable locking device out of the engaged position. This type of locking device is desirable in case the lock should be engaged every time the connector pair is mated. The lock engages automatically as soon as the movement in translation or rotation of the movable blocking parts is unencumbered, and the retraction of the movable blocking part in order to remove the geometric interlocks which prevent the movement of the movable locking device is only possible with a special tool such as a wire, a hook, a spanner wrench or a key.

### BRIEF DESCRIPTION OF THE DRAWINGS

While the invention is amenable to various modifications and alternative forms, specifics thereof are shown by way of example in the drawings and described in detail herein. It should be understood, however, that the intention is not to limit the invention to the particular embodiments described.

FIGS. 30a through 30c show an embodiment from the side over the connecting process.

FIGS. 31a through 31b show a detail of the anti-theft device in its disengaged and engaged condition.

FIG. 32 shows a cross-section of the anti-theft device in its engaged condition.

FIGS. 33a through 33c show a detail of the anti-theft device in the disengaged condition over the disconnection process of the movable locking device.

FIG. 34 shows an embodiment with an attachment for external lock from the side.

FIG. 35 shows an embodiment with interlocking geometry on the rotatable cover in cross-section from the side.

### DETAILED DESCRIPTION OF PREFERRED EMBODIMENTS

FIGS. 30a through 30c show an embodiment of the invention over the interlocking process of the two connector sides.

In FIG. 30a, the socket side of the connection pair is equipped with a rotatable cover (39) which is either held open by the user, or is opened to a stable or instable static condition according to the prior art. The plug side of the connection is equipped with a moveable locking device (40) which is held open by the user as the plug is being inserted. The anti-theft device (41) is designed as a security screw which is installed in the moveable locking device (40) by means of a thread-free portion of the screw shank under the head of the security screw, and when the moveable locking device (40) is in the closed position, the blocking part (42), that is, the security screw, is able to be screwed into a receptacle in the housing (38) of the plug.

FIG. 30b shows the assembly from FIG. 30a after the plug has been inserted into the socket. The rotatable cover (39) has either been released by the user or it has closed automatically on the plug side of the connection, it is however not yet locked in place by any means. An optional spring bias towards the cover-closed position may hold the cover against the top of the plug, which may or may not be equipped for a receiving geometry of the rotatable cover (39). The moveable locking device (40) is shown in the open condition as the user has not yet closed the interlocking geometry (43).

In FIG. 30c, the moveable locking device (40) has been moved to the closed position, and the two connector halves are now mated, the seals are compressed, and the connector sides will not spontaneously disconnect under normal use. Notice that the interlocking geometry (43) is designed as a cylindrical bearing surface on the socket housing, the portion of the moveable locking device (40) which has passed over this cylindrical bearing surface, and the region of the moveable locking device (40) and plug housing parts which act as the rotational axis and fixation of the moveable locking device (40). The interlocking geometry (43) is defined as all of the geometry which is required for the two connector sides to remain in the mated condition. In this case it is the aforementioned geometries, however if the interlocking mechanism were for instance a rotational bayonet device, then the interlocking geometry (43) would consist of the bayonet ring, the tabs on the opposing connector side, and the bearing surface of the bayonet ring rotation.

The connection steps shown in FIGS. 30a through 31b are analog with other types of locking devices such as rotational bayonet rings, sliding bayonet devices, screw rings or a locking rotatable cover (39) with an interlocking geometry (43) between the rotatable cover (39) and the plug, whereby the rotatable cover (39) itself would be equipped with the anti-theft device (41) in order to prevent its movement which would release the mated connector.

FIGS. 31a and 31b show a detail of the anti-theft device (41) in its disengaged and engaged condition respectively.

In FIG. 31a, the anti-theft device (41) is not engaged. The blocking part (42) is executed as a security screw, that is, a screw which requires a special tool in order to be tightened or loosened. There is a space between the underside of the screw head and the moveable locking device (40), and the threaded shank of the blocking part (42) is not interlocked or inserted into the threaded insert (45). In this configuration, the moveable locking device (40) could be reopened and the connector halves could be unmated.

In FIG. 31b, the anti-theft device (41) is engaged. The blocking part (42) is executed as a security screw, has been tightened against the moveable locking device (40), and the threaded shank of the blocking part (42) is not interlocked or inserted into the threaded insert (45) which is securely bonded to the housing (38) of the plug by overmolding, thermal or ultrasonic embedding, or glue. In this configuration, the moveable locking device (40) cannot be reopened and the connector halves cannot be unmated until the anti-theft device (41) is disengaged and the blocking part (42) is withdrawn from the threaded insert (45) or other receiving geometry. Similarly, other forms of blocking parts (42) such as rotatable plates linked to a key-operated lock which is integrated with or installed into one of the housings (38) interlock with the moveable locking device (40) in such a way that its movement to the closed or open position is blocked or impeded.

FIG. 32 shows a cross-section of the anti-theft device (41) in its engaged condition. Notice that the housing (38) of the plug extends to directly underneath the moveable locking device (40) so that pre-loading of the blocking part (42) executed as a security screw can be transmitted directly to the housing (38) of the plug, in this way, the pre-loading of the screw by use of a special tool causes the torque required for its removal to be too high to be removed by hand or by gripping tools. In an alternative execution, the threaded insert (45) could be equipped with a bottom in the threaded hole in order to allow the buildup of a preloading torque between the blocking part (42) and the threaded insert (45) without loading, but while still geometrically blocking the movement of, the moveable locking device (40). In another alternate execution, the head of the blocking part (42) executed as a security screw of nut can be recessed in the moveable locking device (40) so that it cannot be gripped or cut off without damaging the moveable locking device (40).

FIGS. 33a through 33c shown the function of the blocking surface (44) in order to limit the movement of the blocking part (42) during the movement of the moveable locking device (40).

FIG. 33a shows the moveable locking device (40) in the closed position, the blocking part (42) is shown however in the disengaged condition. Although the opposing connector side is not shown for clarity, the interlocking geometry (43) is circled, it can be deduced that if either of the circled regions designated as interlocking geometry (43) were removed, then the locking of the two connector sides while in their mated condition would not be possible. This is important, because in an especially effective embodiment of the invention, the anti-theft device (41) and/or the blocking part (42) and/or the receptacle for the blocking part is positioned in such a way, that removing or cutting the anti-theft device (41) would separate two or more regions of interlocking geometry (43), and would therefore render the moveable locking device (40) of the connection system unusable.

In FIG. 33b, the anti-theft device (41) is shown from the same view and conditions as FIG. 33a, however a cross-section is cut to show the blocking surface (44) in closer detail. It can be seen that in the disengaged condition of the anti-theft device (41), the blocking part (42) does not protrude into the threaded insert (45) or the housing (38). Therefore, the movement of the moveable locking device (40) is not impeded or prevented by the anti-theft device (41). The blocking part (42) would in some executions require a transitional insertion force or other movement in order to begin its interaction or insertion with the receptacle part. In the case of the embodiment shown in this figure, the blocking part (42) executed as a security screw requires a turning movement in order to begin its insertion with the threaded insert (45). In case the blocking part (42) begins its insertion with the threaded insert (45) or other receiving geometry inadvertently or through vibrations, a pre-loading toque will not be present and the blocking part (42) executed as a security screw could be unscrewed and disengaged per hand. Other solutions to prevent and inadvertent engagement of the blocking part (42) include a slight deformation of the thread geometry, so that the initial engagement of the parts requires a deliberate force, a chamfer in the threaded insert (45) or other receiving part so that partial engagement of the blocking part (42) is corrected by the movement of the moveable locking device (40), a slight misalignment of the center axis of the blocking part (42) and the threaded insert (45) or other receiving part so that a deliberate force or tilting of the parts is required in order to interlock them. Alternatively, a spring could be placed between the blocking part (42) and the moveable locking device (40) such that a bias acts on the blocking part (42) in order to push it into its disengaged position and this spring force would need to be overcome in order to move the blocking part (42) into its engaged position. In an alternate execution, the blocking part (42) is spring biased to its locked position, and a special tool is required to disengage it from its receptacle. In this manner, the anti-theft device (41) could be designed to engage every time the moveable locking device (40) is moved to its locked position unless a blocking action has been taken, such as positioning a selector or sliding or turning a block to the movement of the blocking part (42), in advance to prevent an engagement of the anti-theft device (41).

In FIG. 33c, the anti-theft device (41) is shown from the same view as FIG. 33a, however a cross-section is cut to show the blocking surface (44) in closer detail and the moveable locking device (40) is shown in the open position. Notice that the blocking part (42) has moved with the moveable locking device (40) and the over the entire range of movement of the moveable locking device (40), the blocking surface (44) maintains the disengaged position of the blocking part (42). This is of critical importance, because otherwise the user or operator of the connector would have to maintain the position of the blocking part (42) over them movement of the moveable locking device (40) in order to prevent a blockage of the moveable locking device (40) by the blocking part (42) colliding with its receptacle, that is, the threaded insert (45) or other geometry which limits the movement of the blocking part (42) when the anti-theft device (41) is engaged. In alternative form, the blocking surface (44) could be at an angle in order to allow the blocking part (42) to move freely in the open position of the moveable locking device (40), but the angled blocking surface (44) would slide the blocking part (42) to its disengaged position as the moveable locking device (40) is moved to its closed position.

FIG. 34 shows a further embodiment of the invention, whereby an external lock (48) can be used to secure the anti-theft device (41) and therefore to prevent the unauthorized opening of the moveable locking device (40). In this particular execution, the housing (38) of the plug features an integrated embedded or otherwise non-removable eyelet and the moveable locking device (40) is outfitted with a hasp (47), moveable in relation to the moveable locking device (40) or other parts, which when locked over the eyelet of when aligned with other geometry of the housing (38) or the moveable locking device (40), allows an external lock (48) to be fastened through more than one part. These parts which are fastened by the external lock (48) could be any pair of plurality of moving parts which are required to be moved in order to disengage the connector pair, for instance the housing (38) of one of the connector sides and the moveable locking device (40), or the housing (38) and the rotatable cover (39), or the rotatable cover (39) and the moveable locking device (40). The hinge (46) and/or hasp may be fixed to any of the assembly parts such as the housing (38), the moveable locking device (40) or the rotatable cover (39), the movement of the hinge (46) allowing the unimpeded movement of the moveable locking device (40) by means of moving the hasp (47) in order to prevent a blockage.

FIG. 35 shows an embodiment of the invention from the side, shown in cross-section in order to depict a rotatable cover (39) with an integrated interlocking geometry (43). The moveable locking device (40) is shown in the closed position, however if the moveable locking device (40) were to be disengaged, the interlocking geometry (43) which is integrated with the rotatable cover (39) would still need to be moved in order to remove the plug from the socket. This illustrates the use of the anti-theft device (41) when used directly on the rotatable cover (39). When the movement of the rotatable cover (39) is prohibited or impeded by the blocking part (42), the rotatable cover (39) cannot be lifted or rotated further toward the cover-open position in order to move the interlocking geometry (43) out of the path of the housing (38) of the engaged connector side, and therefore the connector side with the rotatable cover (39) and the connector side without the rotatable cover (39) cannot be unmated until the anti-theft device (41) has been disengaged.

Another aspect of the present invention relates to an electrical connector in which one or more electrical contacts that have been overmolded in a core body made out of an elastic material, wherein the first elastic overmold is placed into a tool and overmolded in a second overmolding process in hard material, thereby creating an assembly with a soft sealing core, and a hard outer single piece housing in order to create an end product which cannot be disassembled and requires fewer parts and less time in assembly that that what is known to the prior art.

### PRIOR ART

U.S. Pat. No. 3,182,278 A shows an electrical connector whereby an array of electrical contacts is encased in a rubber insulation part. This insulation part is installed in a multi-part housing made of hard materials.

In JP 5480278 B2, a set of electrical contacts are overmolded in hard plastic, and then assembled with another hard housing part in order to produce a set of variable geometries which would not normally be manufacturable.

U.S. Pat. No. 3,487,353 A shows an electrical connector for underwater use, whereby the interior volume of an assembled rubber housing is filled with a hard resin in order to fix the electrical contacts in place.

In U.S. Pat. No. 3,945,708 A, a set of electrical contacts are installed in a hard-plastic housing, and then overmolded in a second process whereby the overmolding material is prevented from entering the volume reserved for the electrical contacts by the housing parts. This invention is specific to a hard overmold, however soft low-pressure overmolds of this type are well known to the state of the art.

EP 1 998 411 A2 shows a set of electrical contacts, each enclosed in an elastic sleeve, which are then overmolded in a hard-plastic overmold in order to remain flexible and slightly movable in the end product.

In U.S. Pat. No. 8,136,279 B1, a sealing profile is on-molded to a hard-plastic housing part in order to produce a sealing geometry. This type of seal is well known to the state of the art and is also used in combination with hard-plastic overmolds for the fixation of electrical contacts.

### DESCRIPTION OF THE INVENTION

The invention generally relates to electrical connectors with one or more electrical contacts that have been overmolded in a core body made out of an elastic material, whereby the first elastic overmold is placed into a tool and overmolded in a second overmolding process in hard material, thereby creating an assembly with a soft sealing core, and a hard outer single piece housing in order to create an end product which cannot be disassembled and requires fewer parts and less time in assembly than that what is known to the prior art.

An embodiment of the invention consists of an electrical connector comprising a core body comprising one or more electrical contacts and a first overmold of an elastic material, wherein the core body is fixed in a second overmold of a rigid material. This construction of the housing has many advantages, for instance, the hard second overmolding can contain all of the locking geometry required for the interlocking of the two connector halves, whereby the sealing functions, which are normally executed by means of a collective seal or single seals does not need to be installed into a housing. Also, in the case of electrical equipment with multiple integrated connector interfaces, the high material and mechanical requirements of the different connector interfaces can be executed with a single overmolding of the subassembly which consists of the first elastic overmold, instead of requiring multiple parts for the realization or fixation of the different connector geometries, as is the case for instance with junction boxes in which connector housings are installed in windows in the housing of the enclosure. The second overmold can be shaped according to the geometry of the first overmold, and no installation pathway such as eliminating a bottleneck in the housing geometry to allow for the placement of the internal components is required. Locking geometry and additional connecting parts such as screws, seals, and pins can be eliminated, as well as the assembly cost related to the installation of these connecting parts.

A further embodiment consists of an electrical connector whereby the elastic core body is constructed of an elastomer that has a hardness of less than 95 Shore A measured according to DIN ISO 7619-1:2012-02. Preferably, the hardness of the elastomer is at least 10 Shore A or at lease 20 Shore A. Preferably, the hardness of the elastomer is between 25 Shore A and 85 Shore A, more preferably between 40 Shore A and 75 Shore A. The sealing and fixation of the electrical contacts is best achieved by overmolding the contacts in an elastomer or elastomer-like material. Testing has shown that thermal cycling of electrical contacts can lead to a breakdown of overmolded sealings due to the different coefficients of thermal expansion exhibited by contact metals and the materials used for electrical insulation such as plastic and ceramics. Elastomer-like materials have the ability to alleviate these thermal expansions by elastic deformation instead of a plastic deformation of the sealing geometry, however these materials are too soft to be used for interlocking geometry, and the achievable manufacturing tolerances are much higher than those of hard plastic, and therefore these materials are not suitable for most connections that require an intricate locking or fixation systems. This can be seen the state of the art, in that there are electrical connector housings produced completely out of hard rubber or rubber-like materials, but these connectors usually have no more than three of four contacts because if the housing material is hard enough to allow the usage of the material for locking elements, than it is not soft enough to allow the alignment of the individual contact pairs. Electrical connectors which contain many contacts are generally made of hard plastic such as polybutylene terephthalate (PBT) or polyamide (PA) in order to allow for the fine geometry and high tolerances required for such connectors to be realized, however then a set of soft seals must be installed in order to provide for the sealing requirements of the system. Additionally, a chemical bond may be achieved through the implementation of the invention between the substrate contacts and the first overmolding material, especially if a bonding agent is used. One goal of the present invention is to make use of the best properties of hard plastic and soft rubber or rubberlike materials while eliminating all assembly and additional parts required to use both of these materials in one product according to the state of the art.

It would be geometrically possible to receive the electrical contacts in an injection tool, while placed inside of a plastic housing which would also be placed in the mold, and then inject the softer material between the contacts and housing in order to produce geometry similar to the geometry of the present invention. However, all injection materials shrink after injection during the cooling and hardening process. This shrinkage would cause a gap between the outer surfaces of the soft inner overmolding at the contact surfaces with the hard-plastic part which had been placed in the injection tool around the contacts, causing a breach in the sealing properties between these two parts. Testing shows that without a pressing force during the cooling process, such as an outer overmold on a core part, chemical bonding between the overmolding material and the substrate is either not present or degraded by the mechanical pulling apart of the two surfaces during the bonding process, vulcanization or overmolding process. In the current invention, all of the overmolds are outer-overmolds, that is the overmold is created around a core part. The soft first overmold is about the cable and/or contacts, then the second hard overmold is around the soft first overmold, therefore, during every overmolding step, the shrinkage acts to increase the pressing forces between the substrates and the overmolds, which causes a very high sealing effect to be created against pressure differentials, water jets, and long submersions, even when chemical bondings between the overmolds and substrates are not created. However as stated, the squeezing effect of the two overmolds on top of each other has been shown to promote the chemical bonding of materials through the use if bonding agents or during a vulcanization process, or by using materials which typically bond with each other during the overmolding process without the use of bonding agents.

Another embodiment of the design includes an electrical connector wherein the elastic core body is constructed of a thermoplastic material and has an elastic modulus of less than 3200 MPa measured according to DIN 53457:1987-10. Semi-hard plastics such as polyoxymethylene (POM) and polypropylene (PP) can be used effectively for the first overmold as long as the connector does not have so many contacts that tolerances of the contacts start to interact with each other. Connectors which are equipped with flexible contacts are distinctly suitable for these semi-hard first overmolds. An advantage of thermoplastic first overmolds over elastomer first overmolds is, that a chemical bond can be formed between the first and second overmold such that no moisture can be transported along paths between the first and second overmolds. This is especially important for connectors according to the present invention which are equipped with more than one connection interface because it is often of critical importance to prevent moisture from entering a socket housing if it is meant to be permanent, and the assembly according to the invention is designed to be implemented as a sacrificial connector in the case of high-demand environments in which a failure of exposed contacts considered to be unavoidable and is too be expected.

Another embodiment comprises an electrical connector, wherein the elastic core body is constructed of a low-pressure hot melt material such as polyvinyl chloride (PVC), polyamide (PA) or polyurethane (PU). First overmolds as a low-pressure or hot-melt materials have the advantage that the electrical components which have been exposed to the material during the overmolding process are not subjected to the high temperatures of pressures involved in a standard overmolding procedure. Additionally, a chemical bond may be achieved in this case between the substrate contacts and the first overmolding material, especially if a bonding agent is used.

A further execution of the invention consists of an electrical connector wherein the first overmold encompasses a wire, a set of wires, or a cable. This type of overmold is particularly advantageous because the end of the wires or cable is also sealed in order to prevent capillary action through the cable of between the strands of the individual wires. A bending protection may also be integrated with the first overmold and may completely or partially cover a pull-relief in order to divert tension in the cable away from the conducting strands and to the housing parts, in this case the second overmold made of hard insulating material. Overmolded cables which have been assembled into insulation housings are known from the state of the art, however the present invention eliminates the need for all assembly and the related parts. Also, a connector according to the present invention exhibits no internal closed volumes to trap evaporated water or contamination. In any assembled connector, there must be closed volumes, and even if they are very small, they allow for the sealed housing to ‘breathe’ as evaporated atoms seep into the housing during hot conditions and then these atoms condense into water inside of the housing when the environment cools down.

An embodiment of the invention includes an electrical connector, wherein the electrical contacts and/or cable are partially or fully enclosed by both the first overmold and the second overmold. This execution is particularly useful because as the sleeves which contain the contacts are fixed in the tool for the second overmold, the tool repositions the contacts to their intended position, and the higher tolerances of the elastomer or elastomer-like material can be compensated in the second overmold, the result is insulation sleeves around the contacts, which are partly made of the material from the first overmold, and partly made of the material of the second overmold, which is very useful for the connection of additional parts of the assembly.

Another embodiment of the invention includes an electrical connector, wherein the contacts are partially directly enclosed by the second overmold. In some cases, the electrical contacts should be secured by the hard material of the second overmold, while a no-longer visible core or the first elastomer-like material performs the sealing functions. This is particularly useful for flexible contacts as the contact interfaces maintain their floating condition even if the base of the electrical contact is fixed in a rigid manner.

A further embodiment includes an electrical connector wherein undercuts between the first overmold and the second overmold mechanically prevent their separation. A marked advantage of the current invention is the ability to produce geometry that is normally either not possible to produce in the exterior of an electrical connector, or only possible by the use of several housing parts. Although in many cases unnecessary, undercuts and mechanical interlocks can be integrated into the geometry between the first and second overmolds, so that a force applied to one of the two overmolds must not only break any chemical bonds between the two overmolds, mechanical breaks of the overmolds would also be required. That is, ignoring chemical bonding and other properties that would keep the two overmolds joined, the shape of the first overmold cannot be moved outside of the shape of the second overmold without passing through the shape of the second overmold. In other words, the smallest outer silhouette of the first overmold does not fit through any profile of an opening into the internal volume of the second overmold.

Another execution of the invention encompasses an electrical connector wherein a notch, circumferential or continuous over a profile, in either the first overmold or second overmold, allows an injection tool to contain the elastic core body such that it cannot be deformed by an injection pressure of the second overmold during the overmolding process. A difficulty in overmolding soft materials, is ensuring that the material of the second overmold does not displace the softer substrate material through its flows and injection pressure. By means of interlocks between the softer material and the tool, the positioning of the contacts and their surrounding geometry can be maintained. In an alternate execution, a notch is placed between the geometry of the first and second overmold so that if the softer material of the first overmold is displaced, the uneven distributions of the two overmolded materials is at the bottom of the groove and not readily apparent to the customer.

Another execution of the design comprises an electrical connector wherein the contacts are directly contained by an overmolding tool in the overmolding of the first and the second overmolding process. As mentioned, by placing interlocks in the geometry of the first overmold and the tool of the second overmold, the geometry of the end product can be more easily controlled, this includes the contacts themselves being received in receptacles in the tool of the second overmold so that their position can be better defined in the end product.

An embodiment includes an electrical connector wherein the elastic core body has a round or other convex shaped continuous profile in order to facilitate the sealing between the elastic core body and the second overmold. This characteristic is especially important in the case of a thermoset rubber first overmold because a chemical bond between the second overmold would only be possible if the second overmold were also to be constructed using a thermoset rubber and a bonding agent. In practice, this configuration is too expensive, and the tolerances of the end product would be too high. Therefore, assuming that the second overmold must be sealed against the first overmold by the preload of its mold shrinkage, that is, as the injection material cools its geometry becomes smaller due to thermal contraction, creating a preload against the substrate material, in this case, the first overmold. If the geometry of the underlying material is convex, the contracting material of the second overmold presses against the soft material of the first overmold and a sealing action can be achieved. If however, a region of the outer sealing surface of the first overmold is concave, this concave region would fill with the hot material of the second overmold during the overmolding process, and as the convex local shape of the second overmolding contracted inside of the concave region of the first overmold, the material of the second overmold would pull away from the material of them first overmold as it cooled and contracted, and therefore a sealing action could not be formed and a moisture-proof condition would not be achieved. This convex path of the sealing surface can be three-dimensional; however it must be continuous around or across the possible pathways between the two volumes or regions which are to be sealed from each other, be they two connection interfaces or a connection interface and the end of a wire or cable.

Another embodiment comprises an electrical connector wherein the second overmold provides a mounting support for a rotatable protective cover, with or without a locking device or biased spring. As the soft inner overmold is too pliable to hold a spring biased cover or other moveable geometry such as thermal expansion compensators or micro-switches. The higher strength properties of the outer overmold can be used to mount these devices or include these functionalities. This demonstrates another advantage of the invention in that the material properties of the two overmolds can be used for the appropriate functionalities without increased costs that would be associated with installing additional parts or would not be possible using a single material.

Another embodiment of the design includes an electrical connector wherein the second overmold provides a mounting support for a locking device such as a rotatable clevis, a bayonet ring, a threaded collar or other types of locking devices through the attachment of additional parts. As the soft inner overmold is too pliable to hold a locking element, the higher strength properties of the outer overmold can be used to mount moveable locking devices such as a clevis or bayonet ring, or mounting geometry such as clips, screw holes or other in-molded, assembled or embedded metal parts for other additional functionalities. This demonstrates another advantage of the invention in that the material properties of the two overmolds can be used for the appropriate functionalities without increased costs that would be associated with installing additional parts or would not be possible using a single material.

A further execution of the invention consists of an electrical connector wherein additional overmolds are applied to the second overmold. As known from the state of the art, soft overmolds are often applied to hard overmolds to add sealing geometry, add soft tactile regions and grips to hard substrate parts, or to add multi-colored regions to an integrated part. An assembly according to the invention, comprising a soft first overmold and a hard second overmold, could be placed into a further overmolding tool in order to add additional functionalities or cosmetic geometry, such as seals, bending protections, grips or other additional geometries. This is not limited to additional soft geometries, as the overmolding of non-bondable hard materials could also be used to create non-removable moving parts to the outside of an assembly, or in order to create non-removable rivets of other connecting parts.

A further embodiment includes an electrical connector wherein a cable pull-relief is enclosed in the elastic core body and/or the second overmold. An important feature of rubber materials is that they are non-compressible. That is, the volume of the material is not altered by mechanical loading. Therefore, a cable or wire pull-relief such as a twisted wire, a clip or a screwed part can be encased in the first rubber overmolding and after the additional pressure and compressive force of the shrinkage of the second overmold is applied around the first overmold, the rubber material of the first overmold is pre-loaded against the cable pull-relief, and a non-movable condition is achieved between the pull-relief and the hard material of the second overmold.

Another execution of the invention encompasses an electrical connector wherein the mounting geometry for a rotatable cover and/or locking geometry such as a rotatable clevis a bayonet ring, a threaded collar or other types of locking devices is integrated with the second overmold.

That is, the movable parts are placed into the tool of the second overmold, and in the overmolded condition, the moving parts such as a rotatable cover and/or locking geometry such as a rotatable clevis a bayonet ring, a threaded collar or other types of locking device is fixated or blocked into a non-removable condition such that the function of the movable part is maintained however in some cases, no additional connection parts are required to maintain the non-losable condition of function of the moving parts.

Another embodiment of the invention includes an electrical connector wherein the first overmold is sealed against the overmolded contact(s). That is, no moisture can pass by the interfaces or contacting surface between the first overmold and the substrate contacts. This can be achieved by continuous surfaces under a preloading pressure, chemical bonding, vulcanization bonds, pre-treatment of the contacts by glues or the deposition of bonding molecules through flame or atmospheric deposition.

A further embodiment includes an electrical connector wherein the second overmold is sealed against the first overmold and/or contact(s). That is, no moisture can pass by the interfaces or contacting surface between the first overmold and the second overmold. This can be achieved by continuous surfaces under a preloading pressure, chemical bonding, vulcanization bonds, pre-treatment of the first overmold by glues or the deposition of bonding molecules through flame or atmospheric deposition or by the selection of bonding compatible materials for both overmolds

### BRIEF DESCRIPTION OF THE DRAWINGS

While the invention is amenable to various modifications and alternative forms, specifics thereof are shown by way of example in the drawings and described in detail herein. It should be understood, however, that the intention is not to limit the invention to the particular embodiments described.

FIGS. 36a through 36b show an embodiment including a printed circuit board and two connection interfaces from the side in cross-section.

FIG. 37 shows an embodiment whereby a profiled notch between the first and second overmold in positioned inside of a connection interface.

FIG. 38 shows a cross-section of an embodiment whereby one side of the contacts is enclosed in the first overmold and the other side of the contacts is enclosed in the second overmold.

FIGS. 39a through 39e show the production steps of an assembly according to an embodiment of the invention with two connection interfaces with the same contact pattern.

FIGS. 40a through 40e show the production steps of an assembly according to an embodiment of the invention with two connection interfaces whereby the contact patterns of the interfaces are different and are connected by means of a printed circuit board.

FIGS. 41a through 41e show the production steps of an assembly according to an embodiment of the invention with one connection interface and a cable outlet including a bending protection and a cable pull-relief.

FIGS. 42a and 42b show the assembly from FIG. 41e in cross-section.

### DETAILED DESCRIPTION OF PREFERRED EMBODIMENTS

In FIG. 36a a cross-section of an embodiment of the invention is shown from the side. This variant of the invention is equipped with two connection interfaces (58) so that a connector can be inserted into both sides of the embodiment of the invention. This is useful if the assembly is to be used as an adapter or if the assembly serves as a sacrificial electrical connector. That is, one of the connection interfaces (58) is expected to fail over the lifetime of the main product. In this case, the displayed variant of the invention is a socket for the connection of semi-tractor trailers to a towing vehicle. More precisely, the connection interface (58) on the right is to be connected to the wiring harness of the towing vehicle, and it is only to be disconnected in case of a replacement of the assembly. The connection interface (58) on the left is equipped with a biased protective cover (55), whereby this connection interface (58) will be connected to the trailer electronics and will therefore be connected every time a trailer is coupled, which equates to many thousands of times. Depending on the condition of the trailers and the environmental conditions of the region in which the connections are to be made, a corrosive or wear failure of the electrical contacts (50) is to be expected, and the entire assembly according to the invention can be easily replaced without damaging or altering the wiring harness of the towing vehicle.

It can be seen in this figure, that the contact patterns of the two connection interfaces (58) have a different arrangement. These patterns are determined by regulations or are often predefined due to backwards compatibility requirements. In order to enable the connection of contact signals without the use of a junction box or other wired enclosure, a printed circuit board (57) is used whereby the electrical contacts (50) according to each connection interface (58) are embedded in printed circuit board (57) and electrical pathways connect the corresponding electrical contacts (50) as known to the prior art.

A sub assembly of the electrical contacts (50), press fit or otherwise fixed in the printed circuit board (57) has been placed into the injection tool of the first overmold (51) and overmolded in a soft material such as a thermoplastic elastomer (TPE) of 70 Shore A or a thermosetting rubber in an equivalent or comparable hardness, with or without the use of a bonding agent to assist in the formation of chemical bonds during the vulcanization process. This subassembly, comprising the electrical contacts (50), the printed circuit board (57) and the first overmold (51) is designated as the core body (49).

The core body (49) is then placed in another injection tool, and overmolded in the second overmold (52), in this case, a hard plastic material such as PBT GF30, a polybutylene terephthalate with 30% by weight of glass fibres. This second overmold (52) incorporates all mechanically functional features, such as the locking elements of the connection interfaces (58), the bearing elements for the rotational protective cover (55), and the installation geometry of the assembly such as screw holes of snaps. Note that the shape of the second overmold (52) would normally not allow for the shape of the core body (49) to be installed as every opening into the internal volume of the second overmold (52) is smaller than the smallest silhouette of the core body (49).

FIG. 36b shows a detail of the view from FIG. 36a in which geometry of the electrical contacts (50) as well as the printed circuit board (57), overmolded in the first overmold (51) and subsequently overmolded in the second overmold (52) can be seen more clearly. Notice the notch (54) between the first overmold (51) and the second overmold (52), which in this case, was occupied by the geometry of the injection tool during the second overmold (52). Through the placement of this mold geometry and the resulting notch (54), the flows of the second overmold (52) can be directed away from regions which would be visible in the end product. A notch (54) could also be placed completely within the bounds of the material of the first overmold (51) such that the interlocking tool geometry would support the geometry of the soft first overmold (51) in order to withstand the injection pressures and flows of the second overmold (52) without being moved in the injection tool or flashed over by the injection material flowing onto surfaces for which it is not intended.

FIG. 37 shows a view of the right connection interface (58) from FIG. 36a tilted and from the opening of the socket receptacle. The electrical contacts (50) are sealed by the material of the first overmold (51) and the notch (54) is shaped in a profile according to the requirements of the connector to the wiring harness of the vehicle. In this case, the notch (54) also provides for a cosmetic effect, as any irregularities in the boundary line between the first overmold (51) and the second overmold (52) would take place at the bottom of the notch (54), and would therefore not be readily visible, especially if the two overmolds were executed in the same color.

FIG. 38 shows a cross-sectional view of an embodiment of the invention in which the contact patterns of the two connection interfaces (58) have the same arrangement, therefore the use of a printed circuit board (57) is not required, and the electrical contacts (50) can be used for both connection interfaces (58) as a single entity, that is one side of the electrical contacts (50) is used for one connection interface (58), and the other end of the electrical contacts (50) is used for the other connection interface (58). Note that while the sealing function of the individual electrical contacts (50) is ensured by the soft material of the first overmold (51), the positioning and fixation of the electrical contacts (50) is ensured by the second overmold (52) in that a portion of the electrical contacts (50) is directly encased by the hard material of the second overmold (52). This is of course detrimental to the use of multiple contacts because through the positioning of the contacts in the hard material of the second overmold (52), they can no longer adjust to the position of the other side of the contact pair, therefore this variant of the invention is of greater advantage when used in combination with a flexible electrical contact (50) as known from the state of the art.

FIGS. 39a through 39e show the production steps of an assembly according to an embodiment of the invention with two connection interfaces (58) with the same contact pattern.

In FIG. 39a, the individual electrical contacts (50) have been placed in the injection tool of the first overmold (51).

FIG. 39b shows the assembly from FIG. 39a in the overmolded state with the soft material of the first overmold (51) encasing the electrical contacts (50). Notice the continuous convex sealing surface (61) which as previously described, ensures that the second overmold (52) compresses against, instead of pulls away from, the geometry of the sealing surface after the overmolding process as the material cools, ensuring the buildup of a preloading compressive force between the two overmolds and allowing chemical bonding to take place if applicable. This assembly comprises the core body (49) and is in turn placed in the overmolding tool of the second overmold (52).

FIG. 39c shows the assembly from FIG. 39b in the overmolded state with the hard material of the second overmold (52) encasing the core body (49). Note the undercuts (60) prevent the removal of the core body (49) geometrically, so that the integrity of the assembly is not reliant on chemical bonding alone. The connection interfaces (58) are hermetically sealed from each other and no moisture can travel between them through the geometry of the assembly. As the geometry of the second overmold (52) cools, the shrinkage and resulting contact pressure on the core body (49) increases, thereby increasing the sealing effects of the first overmold (51), highlighting an advantage of the invention, and illustrating why the geometric layout of the invention is important, but also how the order of the manufacturing operations is equally important to achieve the maximum sealing function possible. This assembly can be placed into a further injection tool in order to produce an inner seal.

FIG. 39d shows the assembly from FIG. 39c in the overmolded state. The additional overmold (56) is in this case a soft internal seal for the sealing of the interfacing connector in the mated condition. This additional overmolding could of course serve another function such as creating a movable locking geometry using non-bondable materials, producing a connection geometry between a clevis or other metal parts and the existing substructure, or be in a similar or dissimilar material of any hardness or property set.

In FIG. 39e, an end cap (59) has been ultrasonically welded to the second overmold (52) in order to provide a blocking and aligning function for the electrical contacts (50). This illustrates the importance of the characteristic by which the electrical contacts (50) are partially enclosed by the first overmold (51) and partially enclosed by the second overmold (52). As the hard material of the second overmold (52) can be connected to adjoining parts using a multitude of methods such as ultrasonic or thermal welding, gluing, riveting or snapping connections, the soft rubber or rubber-like material of the first overmold (51) is difficult to connect to additional housing parts. Therefore, because the base of the contact must be enclosed in the first overmold (51) in order to achieve a sealing function, and a further geometric extension of the first overmold (51) allows for its positioning and definition in the injection tool of the second overmold (52), the further geometry of the sleeves or enclosures of the electrical contacts (50) can be produced in the more versatile hard material of the second overmold (52) in order to facilitate the connection of the end cap (59) or other additional parts.

FIGS. 40a through 40e show the production steps of an assembly according to an embodiment of the invention with two connection interfaces (58) of differing contact pattern.

In FIG. 40a, the electrical contacts (50) of each connection interface (58) have been inserted in a printed circuit board (57) and placed in the injection tool of the first overmold (51).

FIG. 40b shows the assembly from FIG. 40a in the overmolded state with the soft material of the first overmold (51) encasing the electrical contacts (50) and the printed circuit board (57). Notice the continuous convex sealing surface (61) which as previously described, ensures that the second overmold (52) compresses against, instead of pulls away from, the geometry of the sealing surface after the overmolding process as the material cools, ensuring the buildup of a preloading compressive force between the two overmolds and allowing chemical bonding to take place if applicable. This assembly comprises the core body (49) and is in turn placed in the overmolding tool of the second overmold (52).

FIG. 40c shows the assembly from FIG. 40b in the overmolded state with the hard material of the second overmold (52) encasing the core body (49). Note the undercuts (60) prevent the removal of the core body (49) geometrically, so that the integrity of the assembly is not reliant on chemical bonding alone. The connection interfaces (58) are hermetically sealed from each other and no moisture can travel between them through the geometry of the assembly. As the geometry of the second overmold (52) cools, the shrinkage and resulting contact pressure on the core body (49) increases, thereby increasing the sealing effects of the first overmold (51), highlighting an advantage of the invention, and illustrating why the geometric layout of the invention is important, but how the order of the manufacturing operations is equally important to achieve the maximum sealing function possible. This assembly can be placed into a further injection tool in order to produce an inner seal. Note that the electrical contacts (50) are optionally not directly enclosed by the second overmold (52), and that a notch (54) separates the boundaries of the two overmolds.

FIG. 40d shows the assembly from FIG. 40c in the overmolded state. The additional overmold (56) is in this case a soft internal seal for the sealing of the interfacing connector in the mated condition. This additional overmolding could of course serve another function such as creating a movable locking geometry using non-bondable materials, producing a connection geometry between a clevis or other metal parts and the existing substructure, or be in a similar or dissimilar material of any hardness or property set.

In FIG. 40e, an end cap (59) has been ultrasonically welded to the second overmold (52) in order to provide a blocking and aligning function for the electrical contacts (50). This illustrates the importance of the characteristic by which the electrical contacts (50) are partially enclosed by the first overmold (51) and partially enclosed by the second overmold (52). As the hard material of the second overmold (52) can be connected to adjoining parts using a multitude of methods such as ultrasonic or thermal welding, gluing, riveting or snapping connections, the soft rubber or rubber-like material of the first overmold (51) is difficult to connect to additional housing parts. Therefore, because the base of the contact must be enclosed in the first overmold (51) in order to achieve a sealing function, and a further geometric extension of the first overmold (51) allows for its positioning and definition in the injection tool of the second overmold (52), the further geometry of the sleeves or enclosures of the electrical contacts (50) can be produced in the more versatile hard material of the second overmold (52) in order to facilitate the connection of the end cap (59) or other additional parts.

FIGS. 41a through 41e show the production steps of an assembly according to an embodiment of the invention with a single connection interface (58) and a cable (53).

In FIG. 41a, the electrical contacts (50) have been crimped onto the ends of the wires and they have been placed into the injection tool for the first overmold (51). A pull-relief (62) has been applied to the cable (53), and the cable (53) has been clamped into the injection tool.

FIG. 41b shows the assembly from FIG. 41a in the overmolded state with the soft material of the first overmold (51) encasing the electrical contacts (50), the cable (53) and the pull-relief (62). The continuous convex sealing surface (61) is present, but in this case, it is not important as all of the critical sealing locations and paths have been sealed by the first overmold (51), which is typical of variants including a cable (53) and a connection interface (58) only. This assembly comprises the core body (49) and is in turn placed in the overmolding tool of the second overmold (52).

FIG. 41c shows the assembly from FIG. 41b in the overmolded state with the hard material of the second overmold (52) encasing the core body (49). The pull-relief (62) has been encased in the hard material of the second overmold (52), however as previously described, it would be possible to enclose the pull-relief (62) in the first overmold (51) if it were made of a non-compressible material.

FIG. 41d shows the assembly from FIG. 41c in the overmolded state. The additional overmold (56) is in this case a soft external seal for the sealing of the interfacing connector in the mated condition, which is integrated as a single part with a bending protection for the cable (53).

FIG. 41e shows the assembly from FIG. 41d tilted and from the front, before the welding process of the end cap (59). Notice that the welding geometry at the front of the contact chambers or sleeves is made of the hard-plastic material of the second overmold (52).

FIG. 41f shows the assembly from FIG. 41e from the same perspective, whereby the end cap (59) has been assembled in a permanent manner. This illustrates the importance of the characteristic by which the electrical contacts (50) are partially enclosed by the first overmold (51) and partially enclosed by the second overmold (52). As the hard material of the second overmold (52) can be connected to adjoining parts using a multitude of methods such as ultrasonic or thermal welding, gluing, riveting or snapping connections, the soft rubber or rubber-like material of the first overmold (51) is difficult to connect to additional housing parts. Therefore, because the base of the contact must be enclosed in the first overmold (51) in order to achieve a sealing function, and a further geometric extension of the first overmold (51) allows for its positioning and definition in the injection tool of the second overmold (52), the further geometry of the sleeves or enclosures of the electrical contacts (50) can be produced in the more versatile hard material of the second overmold (52) in order to facilitate the connection of the end cap (59) or other additional parts.

FIG. 42a shows the assembly from FIG. 41f from the side in cross-section. It can be seen that the pull-relief (62) is encased directly in the hard material of the second overmold (52) and that the third additional overmold (56) comprises an integrated bending protection, which limits the bending radius of the cable (53), and an integrated seal for the connection interface (58).

FIG. 42b shows a tilted detail view of the assembly in FIG. 42a. The electrical contacts (50) are encased in the first overmold (51) over the crimping section of the electrical contact (50), whereby a cylindrical outer surface is overmolded in order to provide a continuous convex sealing surface (61) between the first overmold (51) and the electrical contact (50). In the case of contacts with unsealed seams in which moisture can seep past this sealing location, chemical bonding of the substrate electrical contacts (50) and the first overmold (51) in the region between the continuous convex sealing surface (61) and the crimping region is critical. Since chemical bonding of hard materials to metal is nearly impossible due to breakdowns of any chemical bonds during the contraction and expansion at different rates through thermal cycling, this highlights another advantage of the invention in that the soft material of the first overmold (51) allows the end product in effect to be a chemical bonding of a hard material to a metal substrate, by means of the first overmold (51) as a step in between the metal substrate electrical contacts (50) and the hard material of the second overmold (52), creating an end product that would normally not be manufacturable. That is, hard plastic cannot be bonded to metal effectively due to the lack of a vulcanization process, rubber on the other hand can be bonded to metal substrates very effectively. Then as a second step, the hard plastic second overmold (52) is either chemically bonded to the first overmold (51) or mechanically encased about the first overmold (51) by means of a shrinkage compressive pre-loading and mechanical undercuts (60) both of which would not be possible to create without the manufacturing step of the second overmold (52).

It can be seen that the electrical contacts (50) are partially enclosed in the first overmold (51) which provides for sealing functions and the cylindrical inner diameter of the chamber allows for the positioning of the first overmold (51) in the injection tool of the second overmold (52), as well as for providing a flashover surface which is hidden and is not responsible for and functionalities in case the injection material of the second overmold (52) is not completely contained. As mentioned, the hard-plastic of the second overmold (52) provides mechanical stability to the contact sleeves and allows for a wide range of connection or joining processes for additional parts which would not be possible with an elastomer material.

Another aspect of the present invention relates to an electrical connector which comprises two or more connection interfaces, wherein the rigid housing of the connector consists of two or more parts, and the housing parts are partially or fully enclosed in a single continuous overmold such that the connection interfaces are hermetically sealed from each other in order to create a sealing condition and geometric structure that would not be producible with processes known to the state of the art.

### PRIOR ART

U.S. Pat. No. 3,182,278 A shows an electrical connector whereby an array of electrical contacts is encased in a rubber insulation part. This insulation part is installed in a multi-part housing made of hard materials.

In JP 5480278 B2, a set of electrical contacts are overmolded in hard plastic, and then assembled with another hard housing part in order to produce a set of variable geometries which would not normally be manufacturable.

U.S. Pat. No. 3,487,353 A shows an electrical connector for underwater use, whereby the interior volume of an assembled rubber housing is filled with a hard resin in order to fix the electrical contacts in place.

In U.S. Pat. No. 3,945,708 A, a set of electrical contacts are installed in a hard-plastic housing, and then overmolded in a second process whereby the overmolding material is prevented from entering the volume reserved for the electrical contacts by the housing parts. This invention is specific to a hard overmold, however soft low-pressure overmolds of this type are well known to the state of the art.

EP 1 998 411 A2 shows a set of electrical contacts, each enclosed in an elastic sleeve, which are then overmolded in a hard-plastic overmold in order to remain flexible and slightly movable in the end product.

In U.S. Pat. No. 8,136,279 B1, a sealing profile is on-molded to a hard-plastic housing part in order to produce a sealing geometry. This type of seal is well known to the state of the art and is also used in combination with hard-plastic overmolds for the fixation of electrical contacts.

### DESCRIPTION OF THE INVENTION

The invention generally relates to an electrical connector which comprises two or more connection interfaces, wherein the rigid housing of the connector consists of two or more parts, and the housing parts are partially or fully enclosed in a single continuous overmold such that the connection interfaces are hermetically sealed from each other in order to create a sealing condition and geometric structure that would not be producible with processes known to the state of the art.

An embodiment of the invention consists of an electrical connector comprising two or more connection interfaces and a rigid housing, wherein the rigid housing of the connector consists of two or more parts, and the parts of the rigid housing are partially or fully enclosed in a single continuous overmold such that an open path cannot be traced from the inside of one connection interface, through the inner region of the rigid housing, to the inside of another connection interface of the assembly. The sealing function of an electrical connector according to this invention is superior to assembled sealings because a chemical bonding of the sealing geometry as an overmold is possible, whereby the mechanical functions of the assembly are executed in a rigid assembly which is not dependent on the presence of the sealing geometry. Therefore, the material selections of both groups of the assembly can be made independently from each other. That is, the best materials for the electromechanical functions can be chosen without regard for sealing materials, and the sealing materials can be selected without regard for the electromechanical functions.

A further embodiment consists of an electrical connector wherein electrical contacts of one of more connection interfaces are connected by means of a printed circuit board. The invention is particularly advantageous in this case, because it allows for the overmolding and enclosure in hard materials of a printed circuit board which is geometrically too large to be installed through either connector interface. Specifically, the printed circuit board must have the surface area of the combined patterns of the electrical contacts of both connection interfaces in order to fixate both sets of electrical contacts, and if these connectors are both large and/or of a different shape, such as a round connector and rectangular connector, then the subassembly of the printed circuit board with electrical contacts is too large to pass through either of the connection interfaces and would therefore need to be mounted into both connection interfaces from behind, which would require the use of either three housings or two large and complicated housings, which would typically not be demoldable as an injection part, or would result in high costs due to the resulting sealing of an internal volume and the additional costs for fasteners and/or a casting or internal overmold.

A further execution of the invention consists of an electrical connector wherein the region between the different connection interfaces has no unoccupied internal volume after the overmolding geometry is added to the assembly, such that the overmolded region of the electrical contacts and/or the printed circuit board have no exposure to air. Therefore, an ingression of condensed water through evaporated atoms entering the empty spaces in the housing can be prevented.

Another execution of the invention encompasses an electrical connector wherein one or more of the connection interfaces are connected to a rotatable protective cover. This embodiment is often required for automotive connectors for the electrical connection of towing vehicles and trailers.

A further execution of the invention consists of an electrical connector wherein the continuous overmold incorporates an integrated seal. This is particularly advantageous if one or more of the connection interfaces contains an internal seal for the sealing of an engaged connector as the continuous overmold and the internal seal are generally next to each other and the integration of the two parts and their functions does not incur additional tooling costs.

A further embodiment includes an electrical connector wherein the parts of the rigid housing are mechanically joined to each other, either by integrated snapping geometry, screws, pins or other connection means, independent of the overmolding process. As described, this function allows electromechanical functions to be completely independent of the material selection for the sealing functions.

Another execution of the design comprises an electrical connector wherein the printed circuit board is mechanically fixed to one or more of the parts of the rigid housing, independent of the overmolding process. This feature is advantageous in order to lock the location of the subassembly of the printed circuit board with electrical contacts in place independently of the connection between the two or more housing parts.

Another embodiment of the invention consists of an electrical connector wherein the contacts of one or more of the connection interfaces are directly enclosed by the injection tool in order to define the finished shape of the continuous overmold and/or contain the injection material during the overmolding process. This feature is required if the interface between the contacts and the continuous overmold is not covered by one of rigid housings in order to contain the injection material of the continuous overmold.

Another embodiment of the design includes an electrical connector wherein the overmolding material is an elastomer or thermoplastic material. Testing has shown that the vulcanization process and the geometric condition of an outer overmold on an internal substrate part are of great importance in order to produce the strongest possible chemical bonding between the overmold and the substrate part. This is a critical feature for the invention, because if the snapping geometry of the housings is arranged in such a way, that all traceable paths at part or overmold interfaces between the outside of the assembly to the inside of the connection interfaces, as well as all traceable paths at part or overmold interfaces between the two or more connection interfaces contain an external overmold on an internal substrate part, be that substrate part one of the rigid housings or the electrical contacts or the printed circuit board.

A further execution of the invention consists of an electrical connector wherein the overmolding material is chemically bonded to either the electrical contacts of one or more connection interface and/or one or more of the parts of the rigid housing. This is achieved either by the use of bonding agents, a vulcanization process or chemically compatible materials between the rigid housings and the overmold. External overmolds on an internal substrate are critical to the boning process, that is, by means of the geometry of the invention, geometry which would normally require internal overmolds according to the state of the art, that is the inner diameter of the finished geometry in the substrate material and the outer diameter of the finished geometry in the overmolding material, whereby the overmolding material would pull away from the substrate during the cooling process after injection. The continuous overmold is shaped in such a way that a sealing surface designed as an outer overmold on an internal continuous and convex substrate part lies between every internal region of the integrated connection interfaces and from the outside of the assembly to every internal region of the integrated connection interfaces.

Another execution of the invention encompasses an electrical connector wherein the continuous overmolding is of a low-pressure hot melt material. This is particularly advantageous in the case of electrical contacts which cannot be completely sealed by being received and enclosed in the overmolding tool, as the high-pressure injection material would be forced past the contacts.

A further embodiment includes an electrical connector wherein the electrical contacts of one or more connection interface are connected by means of wiring. Such would be the case if the electrical loading of the contacts is too high for a printed circuit board or if the patterns of the electrical contacts do not allow for the superposition of the two connection interfaces on a single printed circuit board.

Another embodiment of the invention includes an electrical connector wherein the electrical contacts of one or more connection interface are connected by means of rigid, flexible, stamped and formed manifold parts or bent semi-flexible wire parts. This design may be advantageous in the case of a product with very high production quantities or high electrical requirements that would be impeded by crimping connections on wiring or press-fitting in to a printed circuit board.

### BRIEF DESCRIPTION OF THE DRAWINGS

While the invention is amenable to various modifications and alternative forms, specifics thereof are shown by way of example in the drawings and described in detail herein. It should be understood, however, that the intention is not to limit the invention to the particular embodiments described.

FIG. 43 shows an embodiment with three connection interfaces and a rotatable protective cover tilted and from above.

FIG. 44a shows an embodiment with two connection interfaces and a rotatable protective cover tilted from the side.

FIG. 44b shows the embodiment from FIG. 44a from the side in cross-section with the cover and flat spring removed.

FIG. 45a shows an embodiment with two connection interfaces whereby the components are not yet assembled.

FIG. 45b shows the embodiment from FIG. 45a in the assembled condition, before the continuous overmold.

FIG. 45c shows the assembly from FIG. 45b in cross-section.

FIG. 46a shows a detail view of an embodiment with three connection interfaces in the assembled condition, before the continuous overmold has been applied.

FIG. 46b shows the assembly from FIG. 46a in cross-section.

FIG. 47a shows an embodiment with an ejection system in cross-section.

FIG. 47b shows an embodiment according to ISO 12098:2004-02 in cross-section.

FIG. 48a shows an embodiment from the front with the cover and spring removed.

FIG. 48b shows the assembly from FIG. 48a in cross-section.

FIG. 48c shows an embodiment from the back with a single connection interface to the wiring harness.

FIG. 48d shows the assembly from FIG. 48c in cross-section.

FIG. 48e shows an embodiment from the back with two connection interfaces to the wiring harness.

FIG. 48f shows the assembly from FIG. 48e in cross-section.

### DETAILED DESCRIPTION OF PREFERRED EMBODIMENTS

FIG. 43 shows an embodiment of the current invention tilted from the top, one connection interface (63) on the left side of the figure is equipped with a rotatable protective cover (70) with a spring bias to the cover-closed position by means of a flat spring. This connection interface (63) is intended as the electrical connection to a semi-tractor trailer and is designed for harsh environments and a high number of connection cycles. The assembly is equipped with two more connection interfaces (63) to the right side, they are intended as connections to the wiring harness of the towing vehicle and are only to be disconnected in case of replacement of the depicted assembly. It is therefore of high importance, that the wiring harness side connectors which interface with the two connection interfaces (63) to the right, are not corroded by the ingress of water into the sealed connection volume. This characteristic is the main advantage of the invention, in that a chemical bonding of the continuous overmold (65), the rigid housings (64), the electrical contacts (66) and/or the printed circuit board (67) can be achieved without a degradation or constraint on the materials of the rigid housings (64). That is, the rigid housings (64) are fixed with each other by means of connecting parts and/or snapping connections and are therefore not dependent on the continuous overmold (65) for their fixation to each other. This has the advantage that the material selection of the continuous overmold (65) can be made independently of the material selection of the rigid housings (64), and therefore soft or otherwise unusable materials such as vulcanized rubber can be used to the seal the assembly.

FIG. 44a shows an embodiment of the invention similar to the variant shown in FIG. 43, whereby the embodiment comprises only one connection interface (63) to the wiring harness of the towing vehicle. It can be seen that when the rotatable protective cover (70) is closed and if a sealed mating connector were to be inserted to the connection interface (63) on the right side of the assembly, no moisture could enter the internal volume of the connection regions because the outer surfaces are closed and unbroken by the rigid housings (64) and the continuous overmold (65).

FIG. 44b shows the assembly in FIG. 44a from the side and in cross-section with the cover and cover spring removed. For the effectiveness of the present invention, it is assumed that the connection interface (63) which is closed by the rotatable protective cover (70) can be exposed to moisture due to harsh environmental conditions. It can been seen that there are no internal empty volumes in the overmolded region and that an open path cannot be traced from the inside of one connection interface (63), through the inner region of the rigid housing (64), to the inside of another connection interface (63) of the assembly. That is, there are no pathways which can allow capillary action of moisture to travel between the inner volumes of the connection interfaces (63) or from the outside to any of the connection interfaces (63). This characteristic is important with respect to the manufacturing process in that even if the geometry could be produced by other means, only a chemically bonded geometry has no clearances between the regions of different materials such as between assembled parts or between overmoldings which do not have a chemical bond between the substrate and the overmolding material. Testing shows that chemical bonds in overmoldings are best formed using external overmolds on an internal substrate, that is, the inner geometry of the finished assembly must be the substrate material and the outer geometry of the finished assembly must be the overmolding material, whereby the overmolding material would pull away from the substrate during the cooling process after injection if it were on the inner side of the substrate thereby degrading or failing to create the chemical bond. The substrate surfaces of the continuous overmold are shaped in such a way that a sealing surface designed as an outer overmold on an internal continuous and convex substrate part lies between every internal region of the integrated connection interfaces (63) and from the outside of the assembly to every internal region of the integrated connection interfaces (63). That is, an external overmold lies along every possible path by which moisture could be transported.

The integrated seal (68) is executed as an internal seal for the coupled condition of the connection system for the left connection interface (63). The integrated seal (68) is important to the ingenuity and usefulness of the present invention because the on-molding of this seal is often required by customer demands in order to ensure the non-losable condition of this part. Therefore, as the internal seal must be on-molded in any case, the additional costs associated with the use of the continuous overmold (65) according to the presented invention is minimized, however the increased sealing properties of the end product are greatly increased due to the ability to employ bonded vulcanized rubber as a sealing material.

FIG. 45a shows an embodiment of the invention before assembly. The sub-assembly comprising the printed circuit board (67) and the electrical contacts (66) for all of the connection interfaces (63) is prepared, and the two rigid housings (64) are positioned on the appropriate side for assembly.

FIG. 45b shows the embodiment in FIG. 45a in the assembled condition. Snap connections secure the two rigid housings (64) to each other, and positioning geometry secures the printed circuit board (67) from both sides so that its position is fixed in relation to the rigid housings (64).

This is of great advantage as the material selection of the continuous overmold (65) can now be made completely independently for the mechanical strength properties of the assembly. That is, the continuous overmold (65) is not responsible for the mechanical fixation of the electrical contacts (66) or any other load bearing part and can therefore be selected based on its sealing qualities and environmental resistance alone. Particularly, thermosetting rubbers can be chemically bonded to almost any substrate material, however their mechanical properties, as well as achievable manufacturing tolerances are generally not adequate for the application of automotive connectors or other precision applications. Since the assembly shown in FIG. 45b is already mechanically sound and complete, any material may be used for the manufacture of the continuous overmold (65) which results in much wider selection of available materials as well as a much higher sealing effect being achievable in the end product.

FIG. 45c shows the assembly in FIG. 45b in cross-section. Note that all internal volumes are connected by flow ports (69) so that the material of the continuous overmold (65) can reach all components and pathways for the transfer of moisture. It can be seen that the snapping geometry does not break the continuous outer diameters and surfaces so that the internal volumes of the assembly can be protected from the outer environment through chemical bonding of the substrate material to the continuous overmold (65).

FIG. 46a is a detail view of an embodiment of the invention with three connection interfaces (63) wherein the rigid housings (64) are snapped together, thus fixating the printed circuit board (67) and the electrical contacts (66), however the continuous overmold (65) has not yet been applied. Various flow ports (69) are visible as are continuous convex sealing surfaces (71) for the chemical bonding of the continuous overmold (65) to the substrate parts and in order to facilitate sealing action by means of the compressive force through the shrinkage of the overmolding material. Note that the continuous convex sealing surfaces (71) are not interrupted by the windows in the rigid housings (64) for the snapping geometry.

FIG. 46b shows the assembly in FIG. 46a in cross-section. The snapping geometry is visible as are the continuous convex sealing surfaces (71) after each connection interface (63) as are the flow ports (69) in the lower rigid housing (64) for the injection of an internal integrated seal (68).

FIG. 47a shows an embodiment of the invention in cross-section whereby other functional parts have been installed on the assembly such as a spring-loaded ejection system and end cap for the contacts which have been ultrasonically welded in place. This highlights an advantage of the invention in that the continuous overmold (65) is faced on both sides by the more versatile material of the rigid housings (64) in that more connection methods for additional parts can be used with the hard-plastic of the rigid housings (64) than with the soft and bonding-resistant materials of the continuous overmold (65). The material of the continuous overmold (65) is confined by the overmolding tool, the electrical contacts (66) and the rigid housings (64) during the injection process so that volumes that are required for additional functionalities are maintained as can be seen by the installation volume for the central of the ejection system which protrudes through the printed circuit board (67) and well into the volume of the continuous overmold (65).

FIG. 47b shows an embodiment of the invention in cross-section whereby an end cap been installed for the contacts which has been ultrasonically welded in place. Notice that as in FIG. 47a, all of the continuous convex sealing surfaces (71) have been overmolded creating a hermetic seal on all pathways of moisture conduction from one connection interface (63) to the other.

FIG. 48a shows an embodiment of the invention from the front whereby the visible connection interface (63) is the connector to the semi-tractor trailer according to ISO 12098:2004-02.

FIG. 48b shows the embodiment and viewpoint of FIG. 48a with a cross-section just before the printed circuit board (67) such that the printed circuit board (67) is visible, as is the required housing shape in order to create the geometry for the connection interface (63) in FIG. 48a. This figure shows the ingenuity and usefulness of the invention in that without the present invention, the rigid housings (64) would both need to be large enough to accommodate the printed circuit board (67) and would in turn create closed volumes in the sealed housing in which condensation could occur, as well as requiring the sealing and connection parts to be included in the assembly in order to replace the continuous overmold (65) which contains no empty volumes which could collect moisture or contaminants. With the current invention, the printed circuit board (67) may extend past the silhouette of the connection interfaces (63) as it will be encased protected and sealed in the continuous overmold (65).

FIG. 48c shows an embodiment of the invention from the back whereby the visible connection interface (63) is a single connector to the wiring harness of the towing vehicle.

FIG. 48d shows the embodiment and viewpoint of FIG. 48c with a cross-section just before the printed circuit board (67) such that the printed circuit board (67) is visible, as is the required housing shape in order to create the geometry for the connection interface (63) in FIG. 48d. This figure shows the ingenuity and usefulness of the invention in that without the present invention, the rigid housings (64) would both need to be large enough to accommodate the printed circuit board (67) and would in turn create closed volumes in the sealed housing in which condensation could occur, as well as requiring the sealing and connection parts to be included in the assembly in order to replace the continuous overmold (65) which contains no empty volumes which could collect moisture or contaminants. With the current invention, the printed circuit board (67) may extend past the silhouette of the connection interfaces (63) as it will be encased protected and sealed in the continuous overmold (65).

FIG. 48e shows an embodiment of the invention from the back whereby the visible connection interfaces (63) are two connectors to the wiring harness of the towing vehicle

FIG. 48f shows the embodiment and viewpoint of FIG. 48e with a cross-section just before the printed circuit board (67) such that the printed circuit board (67) is visible, as is the required housing shape in order to create the geometry for the connection interface (63) in FIG. 48e. This figure shows the ingenuity and usefulness of the invention in that without the present invention, the rigid housings (64) would both need to be large enough to accommodate the printed circuit board (67) and would in turn create closed volumes in the sealed housing in which condensation could occur, as well as requiring the sealing and connection parts to be included in the assembly in order to replace the continuous overmold (65) which contains no empty volumes which could collect moisture or contaminants. With the current invention, the printed circuit board (67) may extend past the silhouette of the connection interfaces (63) as it will be encased protected and sealed in the continuous overmold (65).

Another aspect of the present invention relates to an electrical connector which comprises a socket housing, a rotatable protective cover and a non-linear buckling spring whose force is biased in a cover closing direction over a line of action through the two bearing points of the nonlinear buckling spring wherein a flexible elastic element acts as a compensator against thermal expansions and contractions of the spring-loading system.

### PRIOR ART

U.S. Pat. No. 3,419,297 A shows a method for joining metal and plastic components whereby a rivet-like structure compensates for differing thermal expansions of the stacked members.

U.S. Pat. No. 3,989,471 A shows a housing for a catalytic converter whereby a mesh structure between different laminates of the housing structure allow for varying rates of thermal expansion in the housing.

U.S. Pat. No. 3,675,376 A comprises a compensation beam for thermal expansions by which two materials of differing coefficients of thermal expansion are connected over a thrust bearing and a linkage in order to maintain the same length of the beam at different temperatures.

Similarly, U.S. Pat. No. 3,412,551 A shows three concentrically placed cylinders, connected at opposing ends, whereby the differing coefficients of thermal expansion balance each other out in order to maintain the same length of the structure.

In U.S. Pat. No. 2,597,270 A, a fluid filled chamber maintains the tension in a cable by allowing fluid to pass through a set of chambers in order to relive tensions that are too high due to thermal contraction, and a powerful spring refills the chamber during warmer temperatures.

### DESCRIPTION OF THE INVENTION

The invention generally relates to an electrical connector which comprises a socket housing, a rotatable protective cover and a non-linear buckling spring whose force is biased in a cover-closing direction over a line of action through the two bearing points of the non-linear buckling spring wherein a flexible elastic element acts as a compensator against thermal expansions and contractions of the spring-loading system. The invention greatly simplifies the state of the art, whenever compressive-forced springs are concerned, where the invention is applicable to.

An embodiment of the design comprises an electrical connector comprising a socket housing, a rotatable protective cover and a non-linear buckling spring whose force is biased in a cover closing direction over a line of action through the two bearing points of the non-linear buckling spring, wherein a flexible elastic element either as an integral part of the non-linear buckling spring, or as a deflectable or compressible part of the rotatable protective cover or socket housing, or as a separate part, acts as a spring, providing a force in the direction parallel to the axial force of the non-linear buckling spring onto the non-linear buckling spring. The spring force of the buckling spring is much higher in the cover-closed, spring not-buckled position than in the cover-open position in which the spring is loaded in bending. In any cover position other than the cover-closed position, the spring is loaded in bending, and exhibits a spring force similar to other springs used in the application of cover springs for automotive trailer-tow connectors. However, in the spring not-buckled condition, the spring force applied by the spring is tens of times higher than that of a standard coil spring of the same size. This spring force is however geometrically defined in that the range of compression of the spring is very small, and the structural parts of the connector are in fact the parts which deflect under this load. Small clearance tolerances between parts such as the protective cover about its bearing pin, the bending of the housing, and compression of the elastic seals allows for a pre-loading force to be created in the parts of the assembly in the cover-closed position. The spring force of the buckling spring is so high, that the combined deflection of the parts is typically approximately 1 mm, even if the housing parts and cover are made of glass-reinforced plastic, as is common practice.

The temperature range of automotive electrical connectors is very wide, typically −40° C. to 100° C., and therefore the thermal expansion of the system must be taken into account and compensated. The thermal expansion of plastic is higher than that of steel, and because the compression in the spring is very small compared to the deflection of the parts, increased temperatures lead to a reduction in the pre-loading force of the protective cover in the closed condition because the size of the plastic assembly increases in comparison to relative size of the spring at higher temperatures.

The flexible elastic element is either compressed or bent, typically until a blocking position is reached and higher compressive and bending forces can be diverted to the housing parts. The blocking positions also protect the material of the flexible elastic element for being overloaded into the plastic range of deformation, that is, the flexible elastic element should return to its original shape after the loading is removed. In most cases and under most temperatures, the flexible elastic element will be compressed or bent to its blocking position, only in the case of very high temperatures would the insulation parts expand to a range in which the flexible elastic element would be required to compensate for the differences in the coefficients of thermal expansion of the materials, and the buckling spring would be pushed forward or its length increased by the flexible elastic element. In the case of a compensation by the flexible elastic element, the loading of the housing parts and subsequent closing force on the cover would be much lower than when the parts were under load by the buckling force of the spring, however the cover would remain closed due to the force provided by the bending or compression of the flexible elastic element. If the temperature compensation device were not present, the cover may be pulled open or be in a state of no preload in the cover-closed condition.

A further embodiment of the invention features an electrical connector wherein the flexible elastic element is a lever or other form of deflectable geometry, integrated with or fixed to the socket housing. This variant is very economical, because the deflectable geometry can be integrated into the geometry of existing parts such as the protective cover or the housing without incurring additional costs.

Another embodiment of the invention is an electrical connector wherein the flexible elastic element is a flat spring loaded in bending, compression, or a combination of both and fixed to either the socket housing or the rotatable protective cover. By using metal parts, either separate or integrated with existing parts, the forces created by the flexible elastic element can be higher over a larger range of temperatures.

Another embodiment of the invention comprises an electrical connector wherein the flexible elastic element is an open transverse profile integrated with the non-linear buckling spring. This embodiment is particularly useful because of its compact size, high deflection range and high spring force, this geometry is integrated with an existing part and is therefore economical in its manufacture.

Another embodiment of the present invention is an electrical connector wherein the flexible elastic element is a deformable geometry integrated or fixed to the rotatable protective cover. Very high deflection forces can be created in the cover as there is generally more space for the flexible elastic element, and the space occupied by the rotation of the protective cover is claimed in the higher assembly, so that increasing the size of the flexible elastic element mechanism does not detract from the usability of the product.

Another advantageous embodiment of the invention consists of an electrical connector, wherein the flexible elastic element is an elastomer surface, element, overmold, or part, fixed or attached to the socket housing the rotatable protective cover, or the non-linear buckling spring, which deforms under the spring force of the non-linear buckling spring. As the housing and cover both generally have elastomer parts which perform sealing functions, this type of flexible elastic element can also be integrated with existing parts of the assembly.

A further embodiment of the present invention is an electrical connector wherein the flexible elastic element is a compression or torsional spring, fixed, attached or integrated with the socket housing, the rotatable protective cover, or the non-linear buckling spring, which is deflected or compressed by the axial spring force of the nonlinear buckling spring. These variants of the invention can produce a force over a much wider range of motion, however, are not a first choice because of the higher costs associated with additional parts.

### BRIEF DESCRIPTION OF THE DRAWINGS

While the invention is amenable to various modifications and alternative forms, specifics thereof are shown by way of example in the drawings and described in detail herein. It should be understood, however, that the intention is not to limit the invention to the particular embodiments described.

FIG. 49 shows an embodiment tilted and from the side in the cover-closed condition.

FIG. 50 shows an embodiment in cross-section from the side in the cover-closed condition.

FIG. 51 shows the embodiment tilted and from above in the cover-closed condition.

FIG. 52a shows an embodiment tilted and from the side in the cover-open condition.

FIG. 52b shows the embodiment from FIG. 51a at the same angle in cross-section.

FIG. 53a shows the embodiment of the buckling spring with an integrated flexible elastic element tilted and from the side.

FIG. 53b shows the embodiment of the buckling spring with an integrated flexible elastic element from the side.

### DETAILED DESCRIPTION OF PREFERRED EMBODIMENTS

FIG. 49 shows an embodiment of the invention from the side with the rotatable protective cover (73) in the closed position and the non-linear buckling spring (74) in the non-buckled condition. The flexible elastic element (76) is in the non-deflected condition however it is to be understood that under load, this lever-like geometry would be bent to the right until it collides with the two blocking surfaces (77), whereby the increased force would be transferred to the socket housing (72) thus preventing a further deflection of the flexible elastic element (76) and protecting it from a plastic deformation.

FIG. 50 shows the invention from the side in cross-section, whereby the rotatable protective cover (73) is in the closed position and the non-linear buckling spring (74) in the non-buckled condition. The flexible elastic element (76) is in the non-deflected condition, however it is to be understood that under load, this snap-hook type of geometry would be bent to the right until it collides with the two blocking surfaces (77). The interaction between the non-linear buckling spring (74) and the connections to the surrounding geometry at the bearing points (75), either with the rotatable protective cover (73) flexible elastic element (76) which is in this case integrated with the socket housing (72) is a half-joint connection which cannot transfer moments, only a linear force which is transmitted on a line which passes through both bearing points (75) of the non-linear buckling spring (74). At higher temperatures, the distance between the two bearing points (75) increases in relation to the increase in the distance between the ends of the spring, illustrating the necessity of the invention at high temperatures. Likewise, the compressional force which builds in the non-linear buckling spring (74) in the closed position is limited by the strength of the housing and the reduced distance between the bearing points (75) at cold temperatures, in that if the distance between the bearing points (75) is too small at low temperatures, the non-linear buckling spring (74) may not return from the bent position to the non-buckled position when the rotatable protective cover (73) returns to its closed position. This demonstrates another function of the invention, as the force required to bend the flexible elastic element (76) is less than the increasing spring force as the non-linear buckling spring (74) as it is returning to its straight non-buckled condition, the deflection of the flexible elastic element (76) ensures that the non-linear buckling spring (74) is able to return to its non-buckled condition as the rotatable protective cover (73) closes at low temperatures.

FIG. 51 shows the embodiment from FIGS. 49 and 50 tilted and from above. This shows one variant of the blocking surfaces (77) which are integrated into the mounting flange of the socket housing (72) such that the force of the non-linear buckling spring (74) can be transferred to the mounting plate of the electrical socket, however any geometry which limits the movement of the flexible elastic element (76) would be useable as a blocking surface (77).

FIG. 52a shows the same viewing angle and embodiment as FIG. 49, however the rotatable protective cover (73) is in the open condition and the non-linear buckling spring (74) is in the bent and buckled condition. The compressive spring force can only be transmitted in a line between the bearing points (75), as the half-joint end conditions do not allow the transference of bending moments. The spring force is much lower in the bent condition, and it is in fact desirable for the flexible elastic element (76) to separate from the blocking surface (77) in this condition in order to enhance the closing characteristics of the device at low temperatures.

FIG. 52b shows the embodiment and viewpoint from FIG. 52a in cross-section. The half-joint connections at the bearing points (75) allow rotation of the non-linear buckling spring (74) with respect to the rest of the geometry of the assembly and can therefore not transfer torques or bending moments between parts. Note that the blocking surfaces (77) are at an angle to the back of the flexible elastic element (76) in order to allow the end of the lever-like geometry to bend to the side in a tilted rotational deformation.

FIG. 53a shows an angled side view of a non-linear buckling spring (74) whereby the flexible elastic element (76) is integrated with the non-linear buckling spring (74) as an open transverse profile, that is, a flexible geometry that closes back upon itself in order to produce two blocking surfaces (77). As the compressive forces build up along the length of the spring, the distance between the blocking surfaces (77) decreases until they contact each other, after which the forces can continue to increase until a buckling can occur, in turn allowing the cover of the electrical connector to open.

FIG. 53b shows the non-linear buckling spring (74) from FIG. 53a from the side in order to illustrate the function of the flexible elastic element (76) and show that the blocking surfaces (77) are in line with the structure of the spring in order to allow a buckling of the spring geometry.

The spring structure could contain interlocks in the blocking position if slippage at the blocking surfaces (77) occurs.

Reference numbers

| | | | |
|---|---|---|---|
| 1 | housing | 2 | cover |
| 3 | cam-controlled locking | 4 | cam surface |
| | mechanism | | |
| 5 | driving follower | 6 | locking spring |
| 7 | locking lever | 8 | plug |
| 9 | pressure angle | 10 | rotational cover axis |
| 11 | cover spring | 12 | cover-open low dwell |
| 13 | high dwell | 14 | rise |
| 15 | blocking surface | 16 | rotational lever axis |
| 17 | cover seal | 18 | follower pin |
| 19 | fall | 20 | transmission force |
| 21 | cover block | 22 | cover-closed low dwell |
| 23 | protective cover | 24 | cover seal |
| 25 | socket housing | 26 | elastic element |
| 27 | cover pin | 28 | rotational bearing sleeve |
| 29 | cover block | 30 | integrated elastic part |
| 31 | transient blocking surface | 32 | sliding function selector |
| 33 | rotary function selector | 34 | installed function selector |
| 35 | selector snap | 36 | installation snap |
| 37 | selector block | 38 | housing |
| 39 | rotatable cover | 40 | moveable locking device |
| 41 | anti-theft device | 42 | blocking part |
| 43 | interlocking geometry | 44 | blocking surface |
| 45 | threaded insert | 46 | hinge |
| 47 | hasp | 48 | external lock |
| 49 | core body | 50 | electrical contact |
| 51 | first overmold | 52 | second overmold |
| 53 | cable | 54 | notch |
| 55 | cover | 56 | additional overmold |
| 57 | printed circuit board | 58 | connection interface |
| 59 | end cap | 60 | undercut |
| 61 | continuous convex sealing surface | 62 | pull-relief |
| 63 | connection interface | 64 | rigid housing |
| 65 | continuous overmold | 66 | electrical contacts |
| 67 | printed circuit board | 68 | integrated seal |
| 69 | flow port | 70 | rotatable protective cover |
| 71 | continuous convex sealing surface | 72 | socket housing |
| 73 | rotatable protective cover | 74 | non-linear buckling spring |
| 75 | bearing point | 76 | flexible elastic element |
| 77 | blocking surface | | |

1. An electrical connector comprising a stationary socket housing, a rotatable locking part and/or cover, and a cam-controlled locking mechanism, wherein
the cam-controlled locking mechanism comprises a cam surface, a driving follower and a locking spring, and
the locking spring exerts a force, over the driving follower, over the cam surface, which in turn acts as a rotational moment on the rotatable locking part and/or cover, during a part of, or over all of, the movement of the rotatable part and/or cover between a closed position and an open position.

2. An electrical connector according to claim 1, wherein the closing force of the cam-controlled locking mechanism acts over a rotatable locking part such as a clevis, separate from the rotatable part and/or cover, in order to disengage the closing force of the cam from the rotatable part and/or cover and/or in order to cause the closing force of the cam-controlled locking mechanism to act on a temporarily engaged connector which is mated with the connector which is equipped with the cam-controlled locking mechanism.

3. An electrical connector according to claim 1, wherein the cam surface (4) is integrated or fixed to the rotatable part and/or cover.

4. An electrical connector according to claim 1, wherein the cam surface is integrated or fixed to the stationary socket housing.

5. An electrical connector according to claim 1, wherein the movement of the driving follower is limited by a blocking surface, such that the driving follower does not act on the cam surface over a range of its movement, and the force of the locking spring is not transferred to the cam surface.

6. An electrical connector according to claim 1, wherein the driving follower and the locking spring are integrated as a single part.

7. An electrical connector according to claim 6, wherein the single part is
a stamped and formed part or an integrated part, and/or
made of a flexible material such as metal, plastic or elastomer.

8. An electrical connector according to claim 1, wherein the closing force of the cam-controlled locking mechanism is higher in the rotatable part and/or cover closed position and/or in the plug inserted position than in other positions of the cam-controlled locking mechanism.

9. An electrical connector according to claim 1, wherein the line of action of the normal-force between the cam surface and the driving follower crosses over the rotational axis of the rotatable part and/or cover during the movement of the cam-controlled locking mechanism, such that the cam-controlled locking mechanism acts to close the rotatable part and/or cover over one portion of its movement, and to open the rotatable part and/or cover over another portion of its movement.

10. An electrical connector according to claim 1, wherein the pressure angle and/or moment arm about the rotational axis of the cam, of the normal-force between the cam surface and the driving follower is higher in the locked position than in other positions of the movement of the cam-controlled locking mechanism.

11. An electrical connector according to claim 1, wherein the force of the cam-controlled locking mechanism acts to open the rotatable part and/or cover against a cover spring which is biased to close the rotatable part and/or cover, thereby keeping the rotatable part and/or cover in a stable or instable open position.

12. An electrical connector according to claim 2, wherein the separate rotatable locking part acts upon the cover over a point or edge, said geometry being integrated with the cover or the separate rotatable locking part.

13. An electrical connector according to claim 1, wherein the driving follower is in the form of a cylindrical or tapered roller, a ball, a wedge, a flat follower, a blade, or a stamped and formed profile.

14. An electrical connector according to claim 1, wherein the rotatable part and/or cover is loaded by a cover spring.

15. An electrical connector according to claim 14, wherein the cover spring is a tension spring, a compression spring, a helical leg spring, a buckling spring, a flat spring, or an elastomer spring.

16-81. (canceled)
